(19) United States
(12) Patent Application Publication
(10) Pub. No.: US 2025/0285450 A1
(43) Pub. Date: Sep. 11, 2025

(54) LOCAL TRANSFORM PROPAGATION IN ENVIRONMENT RECONSTRUCTION SYSTEMS AND APPLICATIONS

(71) Applicant: Nvidia Corporation, Santa Clara, CA (US)

(72) Inventors: Derik Schroeter, Newark, CA (US); Mengxi Wu, San Jose, CA (US); Tian Liu, Shanghai (CN)

(21) Appl. No.: 18/609,296

(22) Filed: Mar. 19, 2024

(30) Foreign Application Priority Data
Mar. 6, 2024 (WO) PCT/CN2024/080335

(51) Int. Cl. G06V 20/56; G06V 10/74

(52) U.S. Cl. CPC G06V 20/588; G06V 10/761

(57) ABSTRACT

Approaches presented herein provide for the matching and alignment of features in different instances of sensor data corresponding to an environment. At least one embodiment provides for accurate identification of matching lane dividers between two or more tracks obtained from sensor-equipped vehicles or machines. An initial transform can be determined using a seed area for tracks of data, where the seed area can be determined using landmarks, lane boundaries, or other such objects identified from the sensor data. The initial transform can be used to determine lane divider matches in the track data. If successfully evaluated, these lane divider matches from the seed areas can be propagated out in one or more tracking directions along a roadway to determine lane divider matches along entire stretches of roadway, including roads that pass through intersections or other relatively complex regions.

### CROSS-REFERENCE TO RELATED APPLICATIONS

This application claims priority to PCT Application Serial No. PCT/CN2024/080335 filed Mar. 6, 2024, and entitled “LOCAL TRANSFORM PROPAGATION IN ENVIRONMENT RECONSTRUCTION SYSTEMS AND APPLICATIONS,” which is hereby incorporated herein in its entirety and for all purposes.

### BACKGROUND

There are various operations—such as may relate to autonomous or semi-autonomous navigation, as well as robotic simulation—where it can be desirable to generate or reconstruct a realistic digital and/or virtual environment that complies with real-world rules and constraints. As an example, maps—such as high definition (HD) maps, standard definition (SD) maps, navigation maps, etc.—are widely relied upon for semi-autonomous and autonomous operations. Autonomous and semi-autonomous vehicles and machines may rely on these maps, as well as real-time sensor data, for navigation, localization, path or route planning, and/or other operations. In many instances, accurate map data depends in part upon sensor data captured by vehicles driving along various roadways or thoroughfares. In order to ensure accuracy of the information, multiple passes or tracks of data are captured for each section of roadway, which can help to ensure that relevant features or objects are represented in the sensor data, and not obstructed by another vehicle or object, and can also help to identify permanent versus temporary objects in a region. Unfortunately, sensor data often comes with some amount of error or imprecision which must be accounted for. Further, while features such as traffic signals can have their positions determined in three dimensions, providing for at least some certainty in absolute position, features such as road boundaries, dividers, or markers tend to run along a given path over a significant distance, and it can be difficult to determine where any given portion or segment of those features sits along that path, making matching of features such as lane dividers even more difficult.

### BRIEF DESCRIPTION OF THE DRAWINGS

Various embodiments in accordance with the present disclosure will be described with reference to the drawings, in which:

FIG. 1A illustrates example data produced at stages of an environment reconstruction process, according to at least one embodiment;

FIGS. 1B and 1C illustrate a capture and display of sensor data for an environment, according to at least one embodiment;

FIGS. 2A-2H illustrates example landmark graphs that can be generated, according to at least one embodiment;

FIG. 3A illustrates a process for selecting a seed area corresponding to a turn in a pair of tracks of data, according to at least one embodiment;

FIG. 3B illustrates example regions that can be used as seed areas, according to at least one embodiment;

FIGS. 3C and 3D illustrate closer views regions that can be used as seed areas, according to at least one embodiment;

FIGS. 4A and 4B illustrate portions of an example process for identifying lane divider pairs, according to at least one embodiment;

FIGS. 5A and 5B illustrate tracks of data at stages of a matching process, according to at least one embodiment;

FIG. 6A illustrates an example process for propagating lane divider matches along a stretch of roadway, according to at least one embodiment;

FIG. 6B illustrates an example set of window regions for propagating lane divider matches, according to at least one embodiment;

FIG. 6C illustrates point and line distance determinations that can be used during lane divider matching, according to at least one embodiment;

FIGS. 6D and 6E illustrate example pose graphs that can be used for lane divider matching, according to at least one embodiment;

FIG. 7A illustrates an example environment reconstruction system, according to at least one embodiment;

FIG. 7B illustrates an example map generation system, according to at least one embodiment;

FIG. 7C illustrates components of a distributed system that can be used to match and align landmarks for an environment, according to at least one embodiment;

FIG. 8 illustrates an example data center system, according to at least one embodiment;

FIG. 9 is a block diagram illustrating a computer system, according to at least one embodiment;

FIG. 10 is a block diagram illustrating a computer system, according to at least one embodiment;

FIG. 11 illustrates a computer system, according to at least one embodiment;

FIG. 12 illustrates a computer system, according to at least one embodiment;

FIG. 13 illustrates exemplary integrated circuits and associated graphics processors, according to at least one embodiment;

FIGS. 14A, 14B illustrate exemplary integrated circuits and associated graphics processors, according to at least one embodiment;

FIG. 15 illustrates a computer system, according to at least one embodiment;

FIG. 16A illustrates a parallel processor, according to at least one embodiment;

FIG. 16B illustrates a partition unit, according to at least one embodiment;

FIG. 17 illustrates at least portions of a graphics processor, according to one or more embodiments.

FIG. 18A illustrates an example of an autonomous vehicle, according to at least one embodiment;

FIG. 18B illustrates an example of camera locations and fields of view for the autonomous vehicle of FIG. 18A, according to at least one embodiment;

FIG. 18C is a block diagram illustrating an example system architecture for the autonomous vehicle of FIG. 18A, according to at least one embodiment; and

FIG. 18D is a diagram illustrating a system for communication between cloud-based server(s) and the autonomous vehicle of FIG. 18A, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, generative AI, cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), systems for performing generative AI operations (e.g., using one or more language models), systems for performing light transport simulation, systems for performing collaborative content creation for 3D assets, systems implemented at least partially using cloud computing resources, and/or other types of systems.

Approaches in accordance with various illustrative embodiments provide for the matching of map data elements or objects contained in different datasets representing similar regions or locations. In particular, various embodiments provide for the identifying of elements—such as matching lane dividers or road boundaries—within segments or tracks of map- or region-based data. This may include sensor data acquired from sensor-equipped vehicles traveling along a roadway, where features in the sensor data correspond to different objects or elements within a capture or detection range of the corresponding sensor(s), as well as prior map or evaluated track data, among other such options. In at least one embodiment, one or more seed area candidates may be identified from evaluated track data that can be used as initial estimates for establishing rigid transforms for use in different road segments. One way to identify such a seed area may be to select an area with a high correspondence, number, or density of identified landmark matches, or other such features. If there is not a sufficient density of landmarks in a region, other elements or information can be used for matching, as may include road boundary or geo-positional data. In at least one embodiment, binning may be performed along a section of roadway, and a road segment with a correspondence at, or above, a given threshold may be selected for use as a seed area or seed area candidate. In another example approach, a seed area may be identified using road boundaries. Identified road boundaries may be useful in areas where there are few landmarks, such as long stretches of highway.

In at least one embodiment, one or more seed area candidates can be identified and then evaluated to select a seed area to be used for lane divider matching for a given region or section of roadway. For example, a selected seed area can be used to determine a local transform which can then be applied to identified lane dividers (or other such features). First, an initial transform may be estimated based on the landmark matches, and applied to the lane dividers. From there, a second transform may be estimated and additional lane divider matches determined. The process may be iterated with increasingly smaller thresholds, over two or more iterations, until a final transform is identified. The final transform may then for the lane dividers of the current tracks, and can also be used as a seed to evaluate longer stretches of road in a forward and/or backward direction, with the final transform for any road segment being able to be used as an initial seed for an adjacent segment, where the initial estimate comes from a prior tracking window. In this manner, stretches of road may be evaluated using estimates that may be initially propagated from high correspondence areas with richer sensor information.

Variations of this and other such functionality can be used as well within the scope of the various embodiments as would be apparent to one of ordinary skill in the art in light of the teachings and suggestions contained herein.

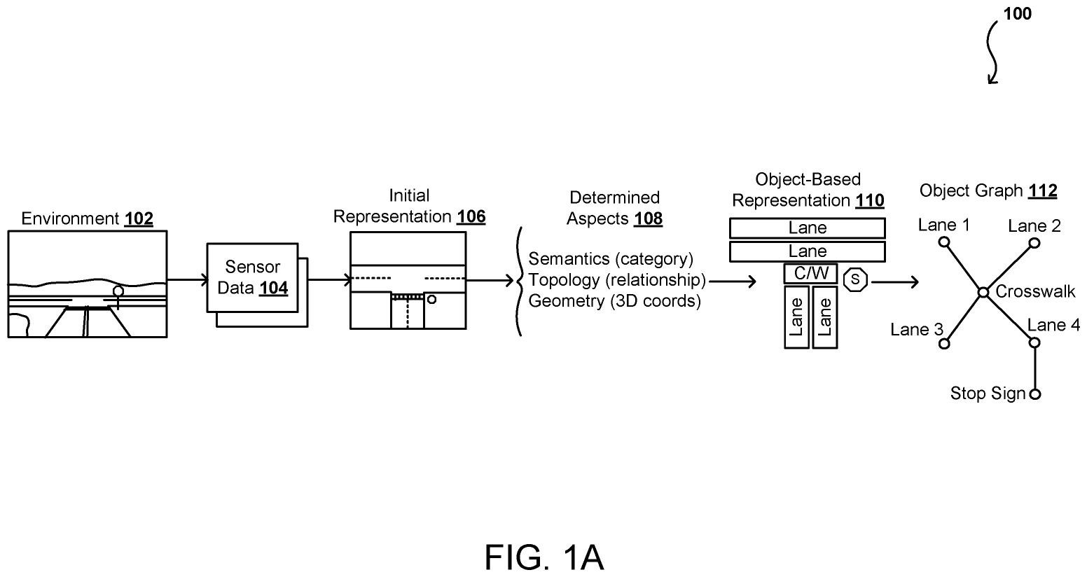

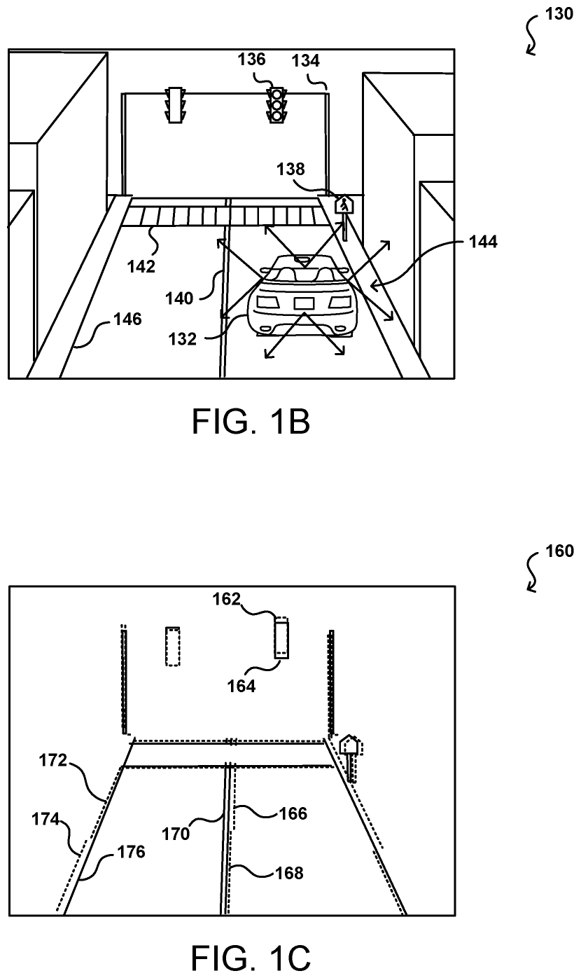

FIG. 1A illustrates an example data processing flow that can be implemented in an environment representation and/or reconstruction system in accordance with at least one embodiment. In this example, sensor data 104 (or other raw data captured or representative of an environment) is obtained with respect to a specific environment 102. The environment can be any appropriate physical environment, such as an indoor or outdoor environment that may include any number of different types of objects or elements. The sensor data can include data captured or obtained using any of a number of different types of sensors, as may include cameras, LIDAR systems, radars, sonic sensors, distance sensors, and the like. Additional data may be obtained that relates to the environment 102 as well in various embodiments, as may relate to basic map data, contextual data, motion data, or other such data, which may also be obtained for virtual, augmented, or enhanced environments. In this example, the sensor data 104 (and any other available and useful data) can be used to generate an initial representation 106 of the environment 102. In at least one embodiment, this may include a point cloud representation of the environment 102 generated by analyzing and aggregating the sensor data 104 that may have been captured by multiple sensors in order to generate a single, n-dimensional (e.g., 2D, 3D, or 4D) representation of the environment. Other initial representations can be generated as well, as may depend at least in part upon the type of sensor data provided. If image data is provided, the image data may be analyzed to attempt to determine feature and depth information, which can be combined from multiple images from different viewpoints to attempt to generate at least a 3D representation of the environment 102, or at least objects and shapes within that environment.

This initial representation 106 of the environment 102 can be analyzed to attempt to determine specific aspects 108 of the environment. For example, a point cloud can be analyzed to attempt to determine the categories (or types) of objects represented in the environment, as may relate to roadways, traffic signs, sidewalks, buildings, and the like. The representation can also be analyzed to attempt to determine the locations of these objects in the environment, as may be defined using a set of 3D coordinates relative to a determined origin location. The initial representation 106 can also be analyzed to attempt to determine various relationships between these objects, such as where a crosswalk crosses specific lanes or where a stop sign is associated with a specific lane and indicates an expected behavior. Once these determined aspects 108 are obtained, these aspects can be used to generate an object-based representation 110 of the environment 102. Various other types of representations can be generated as well within the scope of various embodiments. As illustrated, the object-based representation 110 will not be a comprehensive description of the environment 102 in this example, but will instead focus on the types of objects or features of the environment that are potentially relevant to a particular task. For autonomous driving, for example, the object-based representation may include objects such as road lanes, crosswalks, intersections, and the like, but may not include objects that may not be directly relevant to driving, as may include buildings, billboards, mailboxes, and other such objects, except to the extent those objects may be relevant to a specific operation or task. In this example, the object-based representation 110 also does not include vehicles, pedestrians, or other movable objects that will only be in specific locations in the environment 102 at specific times, but any or all of these and other such objects could be included in the representation as well within the scope of various embodiments.

From this object-based representation, an object graph 112 can be generated that provides a different representation of the environment 110. An advantage of the object graph 112 is that it is relatively lightweight, and can be used to compactly describe aspects of the environment 102 that are important for a particular task or operation. For example, such an object graph 112 could be provided to a map generator in order to generate an HD map (or other such map or representation) that can be provided to an autonomous vehicle to make navigation decisions. Such an object graph 112 can also be provided as input to an environment generator that can generate a realistic 3D virtual environment that can be used for tasks such as robotic simulation or digital world recreation. A large number of object graphs can be stored to represent a number of different environments, which can require significantly less memory or storage capacity than sensor data, such as a large number of high resolution images. Such object graphs can also be analyzed quickly to allow for real-time operations, such as autonomous navigation or control.

As part of such a map generation process, sensor data may be captured from a large number of vehicles using a variety of different sensors, or types of sensors. Each of these sensors may have different amounts of imprecision or error. Further, the accuracy of the sensor data can be impacted by things such as environmental conditions, obstructions, object motion, vehicle motion, and the like. Further still, there will be some imprecision in the determined location of the vehicle due to imprecision in location determined by a GPS system, for example, where the strength of the GPS signal may vary by location or condition, in addition to the inherent accuracy limitations of the system itself. Based in part on these and other such factors, the sensor data obtained from various vehicles, or even different instances of the same vehicle, will have some differences in location data for various objects or landmarks in a region.

In at least one embodiment, tracks of sensor data can be obtained from various vehicles during operation. “Tracks” as used herein refer to low bandwidth, feature-based data streams collected by sensor-equipped vehicles operating in a region, such as by driving along roads in that region. Tracks may comprise information relating to ego-motion of the respective ego-vehicle and geo-positional data (e.g., GPS data for the ego-vehicle), as well as data corresponding to local landmarks (e.g., signs, signals, or poles), lane dividers, parking spaces, radar features, and the like. A set of tracks may be received or obtained that correspond to a given region, or sub-region. In order to obtain an accurate representation of the landmarks, lane dividers, and other objects or aspects of the region, an attempt can be made to align these tracks, such as with respect to a prior map of the region and/or with respect to each other in a common frame of reference. Alignment can involve accurately identifying correspondences between features present in multiple tracks. These feature or landmark correspondences can be used with other information, such as ego-motion, geo-position, and other constraints to align and register these tracks together in a common coordinate frame. In at least one embodiment, an optimization-based approach to alignment can be used, which may iterate over the data from the various tracks. Once proper alignment is obtained then the aligned track data can be used for purposes such as map creation and auto labelling.

FIG. 1B illustrates an example view 130 of a vehicle 132 navigating through a region of an environment. The vehicle can include a number of sensors (e.g., LiDAR, radar, camera, distance, and the like) that are able to capture data about landmarks in the region that are within a view 144 or capture range of at least one sensor. This may include 3D point data for features associated with various objects near the vehicle. The captured sensor data can be analyzed (along with other relevant information) to attempt to identify landmarks in the sensor data. The identification can be performed using any appropriate algorithm or machine learning model, for example, and can include a bounding box or other representation to be used for analysis. In the example of FIG. 1B, landmarks may be identified such as may correspond to a traffic pole 134, a traffic light 136, or a traffic sign 138, which can be three-dimensional (3D) in nature. Other objects or features may be identified as well, such as crosswalks 142 or lane markers 140, but those will generally be substantially 2D in nature and can be treated differently than landmarks as discussed elsewhere herein.

In order to ensure to capture data for all relevant objects or elements, as well as to provide additional measurements or positional determinations to help account for error or imprecision in the sensor data, multiple vehicles (or passes of the same vehicle) can occur through this region to attempt to capture multiple instances of sensor data for each such object or element. A vehicle may travel in either direction in this example, and for a road with additional lanes could travel in any of the lanes in the appropriate direction. Even when traveling in the same lane, different vehicles or passes along that route will not follow the exact same trajectory, even if remaining in the same lane. As a result, sensor data from different tracks will show objects, such as landmarks and lane dividers, in different positions, as illustrated in the example image view 160 of FIG. 1C. As mentioned, some of this will be due to the differences in the locations of the vehicles or sensors for each pass. As illustrated, there can also be differences due to error or inaccuracies in the captured sensor data. These errors will not all be in the same direction or of the same measure.

For example, the difference in position between a first representation 162 and a second representation 164 of a traffic light is illustrated to show differences in height, which is not illustrated by other landmarks, such that this is likely due to error in the sensor data. If the sensor data were accurate and offsets were only due to sensor or vehicle position, then landmark matching and alignment could be relatively straightforward. When each landmark may have imprecision in any random direction in any given track, however, the alignment and matching becomes more difficult. Further, the ability of any landmark to have an unknown amount of imprecision in any given direction can make it difficult to determine an appropriate frame of reference to use consistently for the sensor data for all relevant tracks.

Further still, as illustrated in FIG. 1C there may be one or more elements—such as a lane divider 170 or lane boundary 176—that may run across multiple segments of a stretch of roadway. There may be a different offset or amount of error for each individual segment 166, 168 of a lane divider, and that error can be in any given direction (e.g., along and/or orthogonal to the track or roadway direction). Similar differences can be observed between individual segments 172, 174 for a road boundary 176. As opposed to a traffic signal, for example, a lane segment does not have a clear fixed position in a coordinate frame or reference system, as segments may be very similar along the run or path of a divider or boundary, and it can be difficult to be sure where along a divider or boundary a given segment sits. For example, without more information, a first segment 166 might appear somewhat indistinguishable from another segment 168, and even if those segments can be distinguished it can be difficult to determine exactly where to place each segment, as well as an extent to which the segments might overlap.

In at least one embodiment, local alignment tracking—such as may be useful for 2D objects or elements such as lane dividers—can be performed based at least in part upon one or more determined seed area candidates. A seed area candidate can correspond to an area or region that contains a sufficient and/or at least a minimum number or density of confirmed landmark matches, which can then be used to perform additional tasks such as lane divider matching. Seed areas candidates can be evaluated, and selected seed areas used to attempt to establish a local alignment between two or more tracks of data, such as two tracks in a pair of data tracks being compared, over a relatively small area. The comparison may be based on factors such as, for example, consistent landmark matches and lane divider matches. Once determined, such alignment can be propagated or “tracked” along a track overlap region as discussed in more detail later herein.

In an example approach, an initial step can be to attempt to identify one or more suitable seed area candidates. A seed area candidate can be determined to be “suitable” if it has at least a minimum probability of leading to useful local alignments, as may be based on a density of landmark matches or other such factor, but this does not in fact imply any alignment. These seed area candidates can be evaluated if and when needed, as part of a local alignment-tracking process. This evaluation can be performed to attempt to establish the local alignment and eventually start the local alignment-tracking. Some seed areas may evaluated before any alignment tracking commences, in at least some embodiments, in order to select the seed area candidate(s) with the highest probability of leading to accurate local alignment.

One approach to landmark matching and alignment, and in particular pairwise feature-based track matching, involves finding corresponding features between one or two tracks of data with one or more track overlaps. Identified correspondences can be used for various tasks or operations, such as to formulate and solve a non-linear 3D pose graph optimization problem. Features in this context can include 3D landmarks such as signs, signals, poles, and waitlines, as well as 3D lane-dividers. Landmarks are features with well-defined 3D positions whereas lane-dividers only provide lateral constraints. In at least one embodiment, each feature can be associated with a single pose, and features can be expressed by means of relative coordinates with respect to their associated poses, such that feature correspondences imply constraints between these associated poses. Additional constraints can come from ego-motion, which constrain subsequent poses within a track, and geo-location (e.g., GPS) measurements, which constrain poses with respect to a global/common reference-frame. Track overlaps can refer to two ranges of poses from one or two tracks that are assumed to locally overlap, such that the tracks are assumed to go along the same road in the same or opposite direction. Track overlaps can be used as additional inputs to a feature matching and alignment process in at least one embodiment.

It is generally assumed that the prior global poses for tracks were determined by fusing ego-motion with GPS-measurements. How well two tracks initially align using these prior approaches can then depend heavily on the accuracy of GPS-measurements, which in turn depends on fixed and variable environmental factors as well as on the type of GPS. As a result, the translation between two tracks is somewhat arbitrary subject to some maximum displacement, but is commonly larger than the distance between nearby landmarks. Similarly, the local rotation between two tracks is assumed to be bounded by some maximum rotation, which, however, cannot be assumed to be arbitrarily small. In addition, 3D landmarks lack strong descriptive properties, in particular for poles and waitlines, which are primarily vertical and horizontal line-segments, respectively. The size and/or extents of landmarks can vary significantly. Likewise, orientations for signs and signals are not reliably estimated, and can vary significantly, in particular when the trajectories go around turns in opposite directions.

Various prior approaches used variants of an iterative closest points (ICP) or similar approach that assumes an underlying rigid transform between sets of corresponding features. Such an assumption often does not hold in the context of landmark matching. Approaches in accordance with various embodiments do not make such an assumption, which allows these approaches to be highly robust to ambiguities and more invariant to factors such as translation and rotation between tracks. In at least one embodiment, correspondence or “matching” is solved for track pairs with known overlaps. A landmark graph can be created for each track, or at least a subset of received tracks for a region, where the nodes of the graph correspond to individual landmarks. The edges of the graph then each connect two landmarks in the region. In at least one embodiment, each landmark of a graph will have an edge connected to every other landmark of the graph, or at least landmarks that satisfy a given connection criterion—such as having at least a minimum level of confidence or being within a maximum or threshold distance of each other. Pairs of tracks can be compared to attempt to locate correspondences between landmark edges, such as by using the edge geometry and landmark properties. A given landmark edge match, or correspondence, implies two landmark matches or correspondences. In at least one embodiment, however, multiple matching landmark edges adjacent to a given landmark are analyzed or inspected. A landmark or correspondence between tracks is determined to be established if a majority, or minimum number or percentage, of the adjacent matching landmark edges imply the same landmark match.

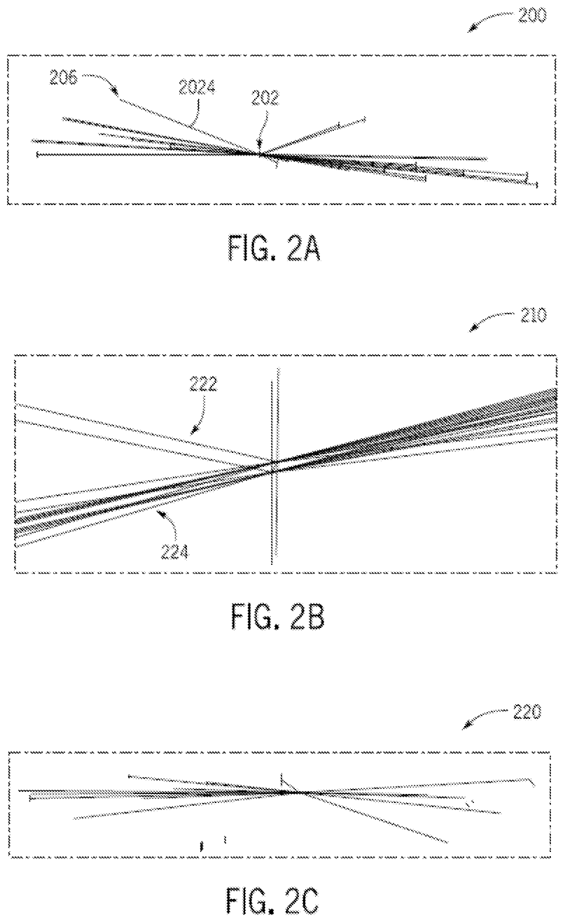

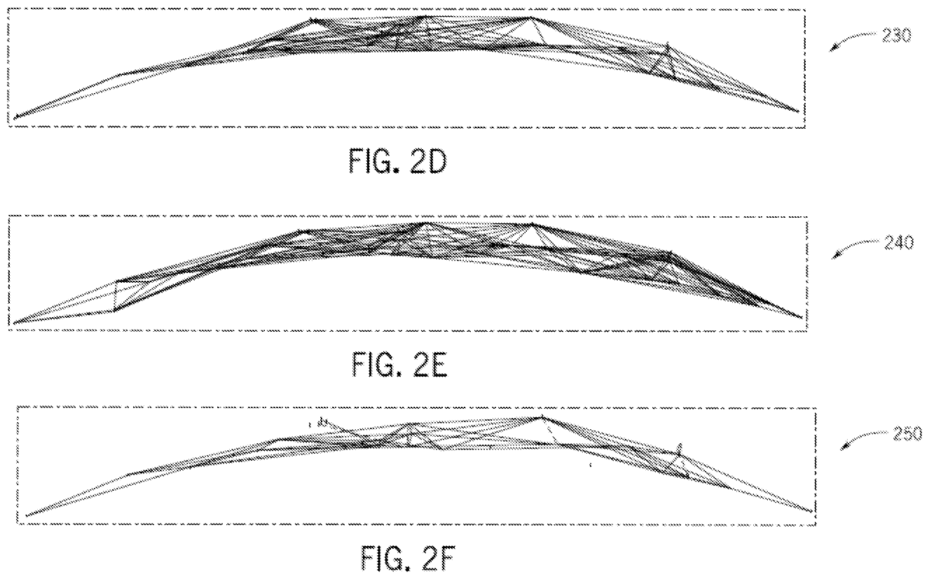

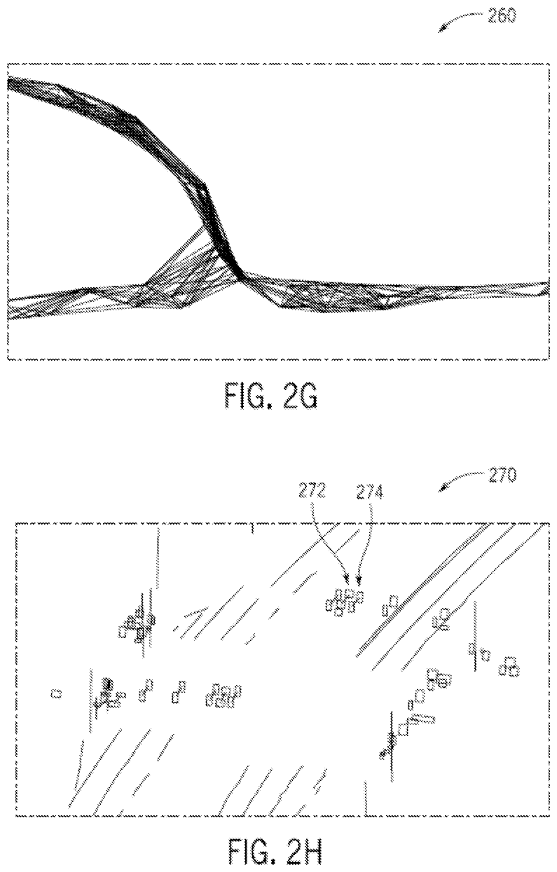

FIG. 2A illustrates an example landmark graph 200 that can be generated in accordance with at least one embodiment. This graph is not a complete landmark graph, but only shows landmark edges 204 from a single landmark 202 to other landmarks 206 of this track for a given region. When analyzing data for a given track, a process in accordance with at least one embodiment can attempt to find matches or correspondences. This can involve forming landmark-pair-segments (LPSs) separately for the landmarks in each track. These LPSs can then be matched pairwise between two or more tracks, with identified LPS matches being used to determine a set of landmark matches. Such an approach can compute the geometric criteria using three-dimensional (3D) or two-dimensional (2D) points where a dimension such as altitude is ignored due to its lower accuracy.

Given the landmarks from the track overlap range of a single track, landmark pair segments (LPSs) can be formed from pairs of landmarks. Pairs are used—rather than triplets or quadruplets, for example—in at least one embodiment to limit the implied combinatorial explosion. If locally there are 30 landmarks then this implies 435 pairs, 4,060 triplets, and 27,405 quadruplets. Further, matching of pairs can be much simpler and faster than matching triplets or quadruplets. Still, even with pairs there can be quadratic growth with respect to the resulting number of possible pairs. To make this process scale linearly with the number of landmarks, an approach in accordance with at least one embodiment will use only a number N of the closest landmarks to form LPSs. The value N may be determined experimentally or set by a user or application, among other such options. In one example implementation, N is set to 30, but the appropriate number can vary based upon various factors, such as region size, landmark density, resource capacity, and the like. In addition, LPSs may be subject to minimum length and maximum length criteria. LPSs can also be created separately for individual tracks. As mentioned, FIG. 2A illustrates a landmark graph 200 for a single track of data, which can be compared to graphs for other tracks.

FIGS. 2B and 2C illustrate zoomed-in views 210, 220, and FIG. 2C illustrates a top-down, zoomed out view of a set of LPS matches that can be determined in accordance with at least one embodiment. The LPSs 232, 234 adjacent to the poles are illustrated in black and gray, respectively, for a given overlapping track pair. As mentioned, there can be an attempt to match two unordered sets scales quadratically with the number of elements in these sets. To this end, similar to LPS creation discussed above, only the N (e.g., 30) closest landmark pair segments (LPSs) are considered for matching. It should be understood, however, that the number of landmarks and the number of landmark pair segments can differ as well in various embodiments. An applicable distance threshold can be selected or determined that is comparably large, as tracks can have relatively large initial displacements, along with possible rotation. The distance can be measured between LPS centers. For the purpose of pairwise LPS matching, the landmarks of two LPSs can first be ordered such that the dot-product of the LPS orientations is larger than zero, such that the LPS direction vectors point roughly in the same direction. LPS matches that satisfy the matching criteria can be used for subsequent landmark-matching.

As another example, FIG. 2D illustrates a landmark graph 230 for landmarks of a first track, and FIG. 2E illustrates a landmark graph 240 for landmarks of a second track. These graphs can be compared using landmark pairs, such as those within a given distance range of each other, to attempt to find matching landmark pairs, and matching landmark pair segments. FIG. 2F illustrates a landmark graph 250 that represents only the matching landmark pair segments between the two tracks. This graph can be compared to other, similar graphs, and aligned to a common frame of reference as discussed elsewhere herein.

LPS matching can consider various matching criteria. In at least one embodiment, this can include a relative length difference check. Given LPS-lengths L₁ and L₂, the relative length-difference ΔL is below ΔL_{threshold}, as may be given by:

$$Δ L = \frac{\vert {L}_{1} - {L}_{2} \vert}{max ( {L}_{1} , {L}_{2} )} < Δ {L}_{threshold}$$

Another example criterion is an angle difference check. Given the normalized LPS direction vectors v₁ and v₂, (in a common 2D frame of reference), the angle-difference Δα must be below Δα_{threshold}, or in practice, cos (Δα) must be above cos (Δα_{threshold}), as may be given by:

$$cos ( Δα ) = {v}_{1} \cdot {v}_{2} > cos ( {Δα}_{threshold} )$$

The threshold used can be relatively large to account for the possible rotation between the tracks, as well as orientation-differences caused by inaccurate landmark-positions. The corresponding landmarks should match as per prior ordering in at least one embodiment.

In this example, the LPSs are to pass a parallelogram check with respect to the vectors between the start points and the end points, respectively. Given LPS-points (p_{1,1}, p_{1,2}) and (p_{2,1}, p_{2,2}), where p_{1,i} corresponds to p_{2,i} as per prior ordering, the start vectors and end vectors can be given by:

$${v}_{start} = {p}_{2 , 1} - {p}_{1 , 1} \qquad {v}_{e n d} = {p}_{2 , 2} - {p}_{1 , 2}$$

Here, the test asserts that:

$$\begin{matrix}\vert {v}_{start} - {v}_{e n d} \vert < Δ {StartEnd}_{threshold} \\ cos ( {v}_{start} \cdot {v}_{e n d} ) > cos ( {Δγ}_{threshold} )\end{matrix}$$

Matching between landmarks can consider landmark-type information, such as specific sign-type, and geometric measurements like width, height, and normal, as applicable. The geometric matching criteria can be formulated as a relative length difference check and angle difference check, both are the same as used above, though with different thresholds, as may be given by:

$$\begin{matrix}Δ L = \frac{\vert {L}_{1} - {L}_{2} \vert}{max ( {L}_{1} , {L}_{2} )} > Δ {L}_{threshold} \\ cos ( Δα ) = {v}_{1} \cdot {v}_{2} > cos ( {Δα}_{threshold} )\end{matrix}$$

A variety of checks can be applied, subject to the matching-parameters for specific landmark-types. This can include, for example, checks for poles, such as where pole types must match, pole lengths satisfy relative length difference checks, and pole directions satisfy angle difference checks. with pole-directions. For signs, checks can include checking that sign types match, sign colors match, relatively length different checks are satisfied separately for width/height and height-above-ground, and/or that sign normals satisfy angle difference checks, among other such options. For signals, these can include relative length difference checks separately for width/height and height-above-ground, as well as angle difference checks with signal-normals. For waitlines, these can include relative length difference checks with the wait line lengths, as well as angle difference checks with wait line directions.

Taking such an approach, each LPS match can effectively imply two potential landmark matches, and multiple LPS-matches can imply the same landmark matches. To determine landmark matches that are consistent with all (or at least most) of their adjacent LPS matches and the implied adjacent landmark matches, the landmark matching information implied by LPS matches can first be organized for all landmarks from both tracks. This can include, for each landmark, collecting all adjacent LPS matches (i.e., LPS matches that include the landmark), and grouping the adjacent LPS matches according to the landmark match implied for the given landmark. Landmark matches that do not pass a general sanity check (or other such) can be discarded. For each remaining landmark match, the list of implied adjacent landmark matches can be stored, and sorted in decreasing order by number of implied adjacent landmark matches.

In at least one embodiment, all landmark matches that are kept in the matching information must pass certain sanity checks. For example, the landmark matches must be supported by at least two adjacent LPS-matches, and must not imply the same poses (which would not form a valid or useful constraint) or the same landmarks. This can happen if the two tracks are the same, and the respective track overlap ranges comprise some of the exact same poses. For opposite direction tracks, landmarks cannot match if they are from different sides (left/right) of the trajectory. For same direction tracks, poles cannot match if they are from different sides (left/right) of the trajectory, while such a criterion may be unable to be enforced for other landmark-types (e.g., signs or signals) as they often hang over the middle of the road, and, thus, can be between same direction tracks. FIG. 2G illustrates a top-down, zoomed out view 260 of a set of LPS matches that can be determined in accordance with at least one embodiment.

Such matching information can be used to generate a landmark match graph, where nodes present landmark-matches, and edges come from LPS-matches. Such a graph can contain some number of incorrect landmark matches, as may be implied by incorrect LPS matches. Between the correct landmark matches, however, the graph should be consistent. In at least one embodiment, an example process can be used to determine the correct landmark matches, and followed by a consistency check with respect to implied adjacent landmark-matches. In such a process, a landmark match can be establishes for each landmark L1 in track 1 if certain criteria are met. This can include that, for the first landmark match in the list, the number of adjacent landmark matches must be above a determined threshold, and there must be a unique maximum, in that the number of adjacent landmark matches must be larger than the second largest, if it exists. More specifically, the ratio between second and first largest must be below a determined threshold. For the matching landmark L2 from track 2, it must refer to L1 as the best landmark-match. There must also be a unique maximum, in that the number of adjacent landmark matches must be larger than the second largest, if it exists. More specifically, the ratio between second and first largest must be below a determined threshold. It should be noted that the number of adjacent landmark-matches for L2 is the same as for L1 due to the symmetry of LPS matches.

Afterwards, a consistency check can be performed based on the assumption that the majority of landmark matches established above are correct. For each landmark-match, the number of adjacent landmark matches are counted that are considered to be correct according to the above criteria. A landmark match can be discarded if the ratio of the number of correct and overall landmark matches falls below a determined threshold. This ratio is one if all landmark matches are considered to be correct, and zero if all are considered to be wrong. FIG. 2H illustrates a set 270 of landmark matches between two tracks at an intersection. In this example, traffic signs 272 are illustrated in black, and traffic signals 274 are illustrated in gray.

As mentioned, the alignment of landmarks between different tracks of data can allow these tracks to be aligned and/or registered with each other and/or with respect to prior map data for a region. Once so aligned, the track data can be provided for use in various purposes, such as for map creation, auto-labeling, or other such purposes. This aligned data can be used in a process such as that described with respect to FIG. 1A to generate or update a map representation of a region. While discussed using sensors on a vehicle driving on a roadway, to be used to generate high quality map data for navigating vehicles, the sensor data can be captured and used to generate maps or representations of other environments as well, such as factories or warehouses in which robots will operate. In such an example, one or more robots can make one or more passes through at least a portion of the warehouse while capturing sensor data, and the sensor data for each of those passes can correspond to a track of data. In order to correlate the data and improve the accuracy, the data can be aligned to a common frame of reference using matching landmarks, as discussed and suggested herein. Using multiple tracks can also help to ensure that landmarks are captured that may not be represented in all tracks, and that temporary objects are not be interpreted as landmarks even though they may appear in one or more (but not all or a majority of the) tracks.

As mentioned, once reliable landmark matches are identified, with a corresponding reliable transform, for a region, the landmark matches and/or transform can be used to determine whether at least a portion of the region can be used as a seed area for matching other types of objects or elements, such as lane markers or other 2D objects. A seed area candidate can correspond to an area or region that contains at least a minimum threshold number or density of confirmed landmark matches, in order to have enough data points to be able to rely on the matching and generated transform for that region. Seed areas candidates can be evaluated, and selected seed areas used determine local alignment between two or more tracks of data. The comparison may be based on factors such as consistent landmark matches. Once determined, such alignment can be propagated along a track overlap region. Seed area candidates can be evaluated as part of a local alignment-tracking process.

In at least one embodiment, a seed area can be used to determine an initial alignment. To this end, a seed area detection process can attempt to locate and/or identify regions where a local landmark match density along the track forms one or more local maxima. In at least one embodiment, this can be performed by first computing a local landmark match density function, as may be based on a spatial discretization (binning) along the track. A smoothing of this landmark match density function can be performed to remove noise or minor variances that may result in false maxima. After smoothing, any local maxima can be located and non-maximum suppression can be performed. For each local maximum, a determination can be made as to whether the areas around the local maxima may contain a region of interest, such as a sharp turn or an intersection.

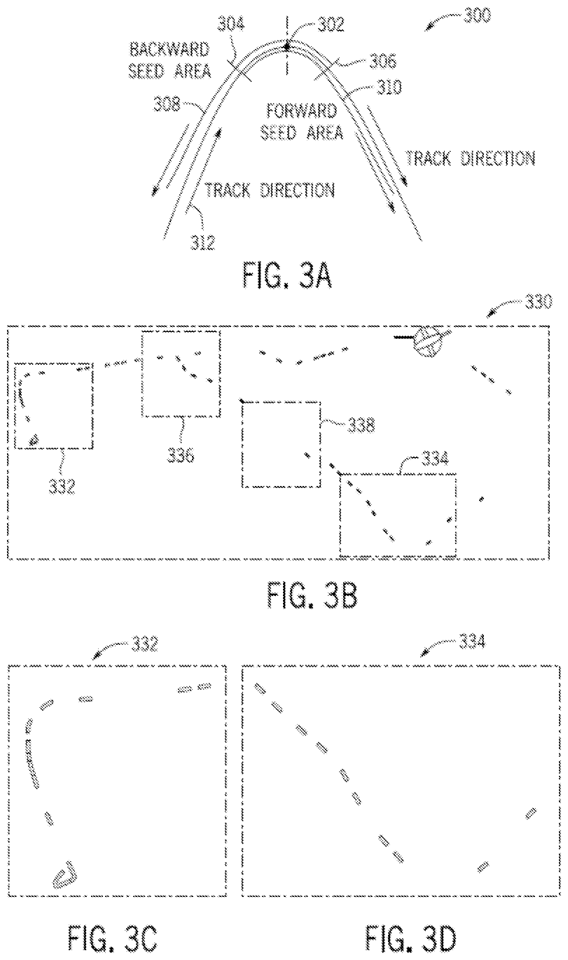

An area or region around a local maximum can be determined to correspond to a “sharp” turn if the roadway is determined to include a turn or curve having at least a minimum angular variance over a maximum distance, or satisfying at least an angle to distance ratio, among other such options. If an area is determined to correspond to such a sharp turn, the 2D curvature function over a local neighborhood can be computed, with an example plot 300 of such a function being illustrated in FIG. 3A. In at least one embodiment, as least some amount of smoothing of the function can be performed before analysis to reduce the presence of false maxima and/or minima due to noise, error, or imprecision. A global maximum 302 of the function for the turn can be identified that corresponds to a “center point” of the turn. The gradient of the 2D curvature function to the left and to the right of the center point can be computed. The global maxima in each interval can be determined, with each maximum being used to identify a boundary of the turn, such as a left boundary 304 and a right boundary 306 of the turn (with terms such as “left” and “right” being used for explanation and not a requirement on implementation or scope). Two overlapping seed area candidates 308, 310 can then be formed or identified, wherein one seed area candidate 308 can be used for backward tracking, and the other seed area candidate 310 can be used for forward tracking, with respect to the track direction 312 as indicated.

In other instances, a seed area may be determined to instead correspond to an intersection. In at least one embodiment, a given pose can have an indicator as to whether or not the pose is considered to be in an intersection (or other such feature likely to include a density of landmarks, such as a roundabout or offramp). The indicator can be determined in at least one embodiment as a feature of poses. If at least one pose is determined to be within an intersection, then the full range of the intersection can be determined, as may include features such as the center point as well as the left and right limits. Two overlapping seed areas (e.g., a left-of-center point and a right-of-center point seed area) can be formed, similar to that described above with respect to a sharp turn. Various other unique area types or region types can be identified using such a process as well within the scope of various embodiments.

FIGS. 3B-3D illustrate example views of an overlap between two tracks, along with detected seed areas. FIG. 3B illustrates an overview 330 of a region containing a track overlap. The region is illustrated to include sub-regions 332, 334 that could be identified as having a sharp turn, as well as a sub-region 336 that could be identified as including an intersection. FIGS. 3C and 3D illustrate zoomed-in views of two of these sub-regions 332, 334 that are indicated to correspond to a sharp turn. Various seed area determination approaches can be used for these, and other types of, areas as discussed above. It can be noted that seed area detection according to at least one embodiment does not necessarily involve any specific evaluation. However, the thickness of the lines in the figures indicates the subsequent evaluation state, with thick black not being evaluated, think black corresponding to a failed evaluation, and intermediate thickness corresponding to a successful evaluation. Also illustrated is an example region 338 that does not include a sharp turn or intersection, and appears to be potentially sparse in matchable objects, and thus may benefit from yet a different approach as discussed in more detail elsewhere herein.

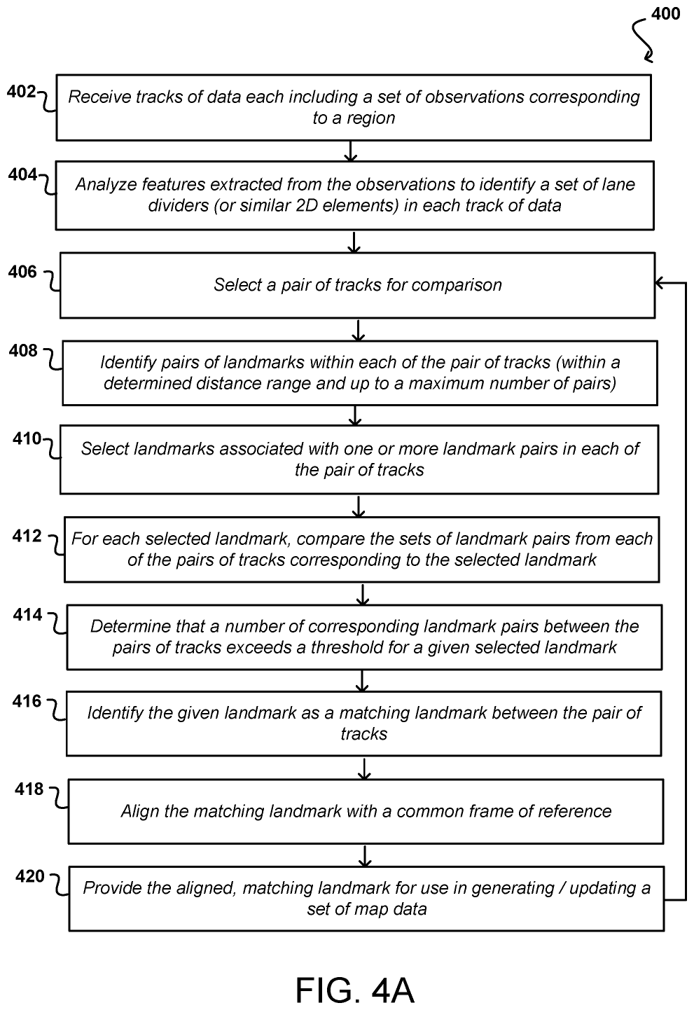

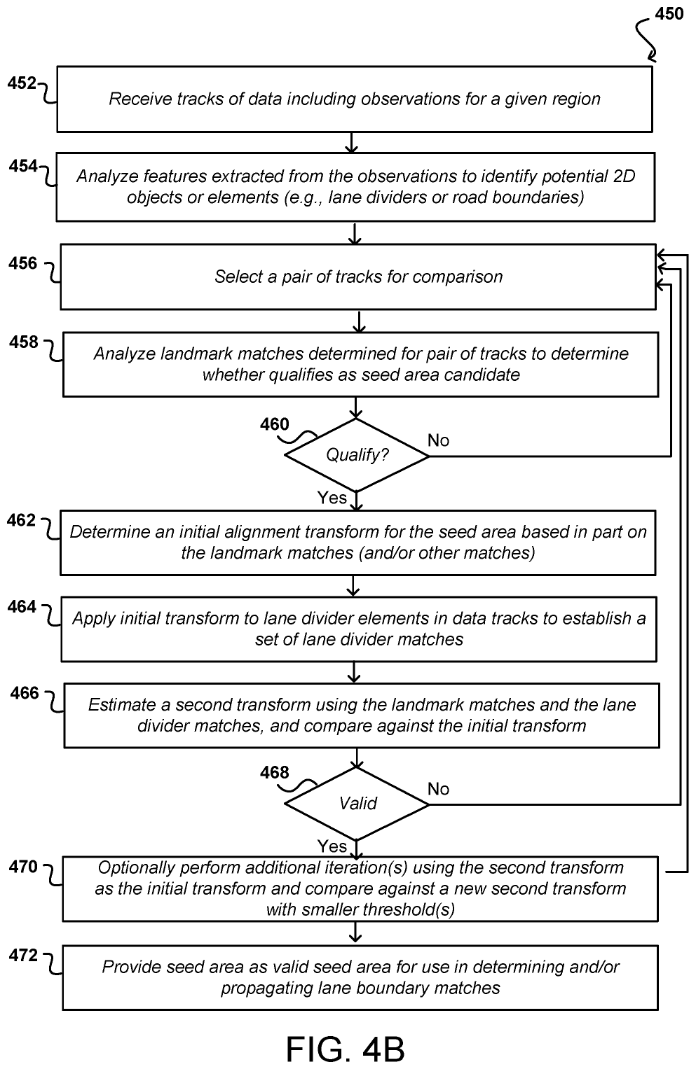

FIGS. 4A and 4B illustrate example portions of a process to perform lane divider matching using seed areas determined from landmark matches, in accordance with at least one embodiment. It should be understood that for this and other processes presented herein that there may be additional, fewer, or alternative steps performed or similar or alternative orders, or at least partially in parallel, within the scope of the various embodiments unless otherwise specifically stated. Further, although this and other examples herein will be discussed with respect to driving or navigation domains and environments, there can be other types of domains, environments, and representations used and/or generated as well within the scope of various embodiments. FIG. 4A illustrates a first portion 400 of such an example process that can be performed to match and align landmarks (or other features) in captured sensor data, in accordance with at least one embodiment. In this example process, tracks (or other streams or sets) of data can be received 402 that each include a set of observations corresponding to a region. These observations can include features, 3D points, or other aspects captured using one or more sensors, or generated using data from the one or more sensors. This may include point cloud data or other such observations. Features (or other data or aspects) extracted from these observations can be analyzed 404 to identify a set of landmarks in each track of data. This can include determining aspects such as size, shape, location, boundary, characteristics, labels, and the like.

There may be many tracks of data for a region that are at least partially overlapping, and pair-wise comparisons among the tracks can be performed. A pair of tracks can be selected 406 for each such comparison, and pairs of landmarks can be identified 408 within each of those tracks. For a given landmark, the landmark pairs can include up to a maximum number of other landmarks within a given distance range from the landmark, such as at least a minimum distance away but no more than a maximum distance away. Once these landmark pairs are identified, landmarks can be selected 410 that are associated with one or more (or multiple) identified landmark pairs in each of the pair of tracks. For each of these selected landmarks, the sets of landmark pairs from the pair of tracks that correspond to that selected landmark can be compared 412, and it may be determined 414 that a number of corresponding landmark pairs for a given selected object meets or exceeds a specified correspondence threshold. The given landmark can then be identified 416 as a matching or corresponding landmark between the pair of tracks. The matching landmark can be aligned 418 to a common frame of reference for the region, and data for the aligned, matching landmark can be provided 420 for use in generating or updating a set of map data, auto-labelling data, or performing another such task or operation.

Taking such an approach, matches or edges are only considered that have an unambiguous correspondence. The matching between landmarks of a pair of tracks should match in both directions. As mentioned, in order to maintain high performance and reduce compute requirements, landmark pairs may only be considered that are within a given distance range, and only up to a maximum number of pairs per landmark. Such a process can attempt to identify implied matches, such as by analyzing adjacent edges, and not take matches directly out of a given landmark graph. Once landmarks are determined to correspond to each other, a line can be drawn to establish the transform needed to transform the tracks onto a same coordinate plane or other frame of reference. In at least one embodiment, a process can attempt to aggregate over all adjacent edges for a given landmark.

FIG. 4B illustrates an example process 450 that can be performed to match lane dividers (and similar types of objects or elements) in at least two tracks of data, based at least in part upon determined landmark matches, according to at least one embodiment. In this example process, tracks of data are received 452 that each include a set of observations corresponding to a given region. Features extracted from these observations can be analyzed 454 to identify potential elements, such as a set of lane dividers or other similar 2D elements, in the various tracks of data. In this example process, pairs of tracks for a similar region can be compared, and a first pair of tracks can be selected 456 for comparison. A set of landmark matches for the tracks can be determined for the two tracks, using a process such as that discussed with respect to FIG. 4A, and the landmark matches for the two tracks can be analyzed 458 to determine whether the area corresponding to those landmark matches can be used as a seed area, or satisfies the criteria for a seed area candidate. This can include, for example, determining whether the number or density of landmark matches in the area satisfy a minimum threshold, such that there are enough data points to provide a reliable initial transform. If it is determined 460 that there are insufficient landmark matches for the area to qualify as a seed area candidate, then the process can continue with another pair of tracks for the same general area or a nearby area, which may be able to serve as a seed area for lane divider matching.

If the landmark matches for the two tracks are determined to satisfy one or more seed selection criteria to quality as a seed area candidate, then the area can be selected as a seed area for the respective lane dividers, and an initial alignment or transform can be determined 462 based at least in part upon the landmark matches. This initial transform can correspond to a first attempt to locally align landmarks and lane dividers between the tracks being evaluated, such as two tracks of an evaluated track pair. An initial transform can be estimated from the landmark matches using, for example, closed form linear minimum least squares with only point-to-point constraints. In such an approach, objects such as poles, signs, and signals can be used instead of objects such as waitlines. Once determined, this initial transform can be applied 464 to the lane divider elements in the tracks to establish a set of lane divider matches between the tracks. In at least one embodiment, the matches are established, at least in part, by performing a nearest neighbor search, as may include constraints on orientation, lane divider type, and/or orthogonal distance, among other such options. If it is determined that there are a sufficient number of landmark matches, for example, then a second transform can be 466 estimated using the landmark matches and the lane divider matches. This second transform may be estimated using, for example, point-to-point and point-to-line constraints via closed form linear minimum least squares. The initial transform and the second transform can be compared, and the seed evaluation can be determined to have been unsuccessful if the second transform is determined to be a valid transform, such as where a difference in translation and rotation between the initial transform and the second transform is at, or above, one or more specified thresholds. That is to say, if it is determined 468 that the second transform based on landmarks and lane dividers is too different from the initial transform based only on the landmarks, then the second transform is likely incorrect (as the initial transform should be more reliable) and the seed area can be rejected and another pair of tracks selected. If it is determined 468 that the initial transform and the second transform are sufficiently similar such that the second transform and seed area are valid, in that the translation and rotation differences do not exceed allowable difference thresholds, then a determination can be made as to whether another iteration of evaluation should be performed. If it is determined that another iteration should be performed to obtain tighter or smaller thresholds, then the second transform can be set as a new initial transform for the next iteration, and the process can continue by performing 470 one or more additional iterations to compute a new second transform and compare against the new initial transform for this iteration using a smaller or tighter threshold. Such an approach can at least provide a sanity check to ensure that the solution is stable. A seed area evaluation can be determined to have been successful if the above steps and checks were all successful. If the comparison of the new initial and second transforms is successful, in that they are sufficiently similar, and it is determined that there are no further iterations to be performed, then it can be determined that the selected seed area is a valid and/or reliable seed area, and the “final” second transform can be selected 472 as reliable for this area.

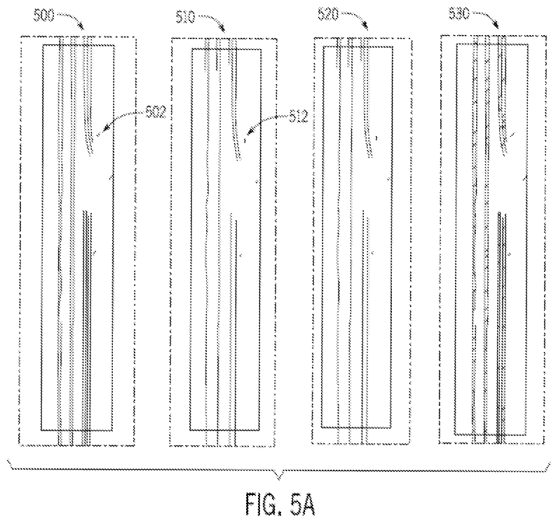

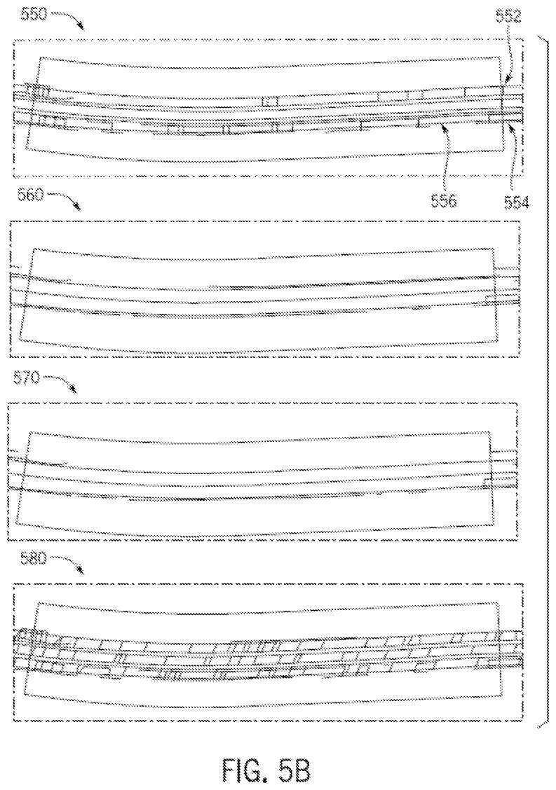

Example states from such a process are illustrated in the sequence of images of FIG. 5A. The data is plotted in a top-down view using lane divider or lane marker data from two data tracks. A first image 500 illustrates a seed area with the original poses as obtained from the captured sensor data, or original data tracks. A second image 510 illustrates the seed area with the poses after computing the initial transform from landmark matches. As illustrated, instances of individual landmarks 502 that were illustrated with a slight offset in the first image 500 between the two tracks are illustrated as instances of the same landmark 512 that correspond to substantially the same location after the transform is applied in the second image. The third image 520 illustrates poses after finding lane divider-matches and computing a second transform. As illustrated, there are only slight differences resulting from the second transform with respect to the first transform, indicating that the second transform is likely valid and able to be used for lane divider matching. The fourth image 530 illustrates the original poses again to better illustrate the final lane divider matches from this portion of the process.

In at least one embodiment, there might be long stretches of roadway, such as in relatively sparse rural settings, where there are very few landmarks available for matching. In such areas, seed area candidates can be identified using other types of objects, such as road boundaries. Such a process might be used when a minimum density or number of landmark matches for a given area falls below a minimum threshold or fails another such criterion. FIG. 5B illustrates example images showing stages in such a process. In such regions, seed area candidates can be created and evaluated by first determining whether the overlap area has been fully covered. If not, road boundary matches can be computed within the uncovered area. This can be performed by, in at least one embodiment, separating the road boundaries to left boundaries 552 and right boundaries 554 as illustrated in the top image 550. The separation can be determined based on, for example, the y-coordinate of the boundary line in the frame of the vehicle. Left boundary to left boundary matching, and right boundary to right boundary matching, can be performed via a nearest neighbor search, such as with constraints on orientation and orthogonal distance. A large distance threshold can be applied since there is not much ambiguity after the left and right separation. In at least one embodiment, road width difference checking can be applied as a post-filtering process to reject matches where the road width difference exceeds a maximum size threshold or other such criterion.

Road boundary matches can be sorted by a factor such as sample index, and then the process can iterate through these road boundary matches. For each road boundary match, a local window 556 can be formed with the specified window size, and a road boundary seed area can be created, if certain criteria are satisfied. This can include, for example, whether the number of feature matches (e.g., road boundary matches and landmark-matches) within the window is above the threshold. This may also include, for example, that the road boundary matches are from both sides of the road. These road boundary seed areas can then be evaluated. Seed area evaluation can be performed similar to the evaluation discussed above, with a few minor differences. For example, the initial transform can be computed from road boundary matches, as well as any existing landmark matches. A road width difference can be computed between the two tracks in the seed area if the road-widths are available. The evaluation can return a failure result if the road width difference is larger than a corresponding width threshold (which may vary based on the generally location of the road or other such factors). In at least one embodiment, second transform can be calculated as discussed above (and as applied illustrated in image 520), and a maximum angle threshold can be applied with respect to at least the rotation part of the initial transform, and a minimum condition number threshold can be applied to the second transform to reject the seed area where the forward direction is poorly constrained.

As mentioned, the first top-down image 550 of FIG. 5B illustrates an example, road boundary seed area with the original poses contained in the seed data, with a limited number of matches. The second image 560 illustrates those poses after computing an initial transform from based at least in part on road boundary matches, where road boundaries are shown to be better aligned. The third image 570 illustrates those poses after finding lane divider matches and computing a second transform. As illustrated, there are only minor variations indicating that the second transform is likely valid. The fourth image 580 illustrates the original poses again to better show the lane divider matches according to the second transform.

If a seed area candidate is evaluated successfully, a local alignment process can be performed to attempt to propagate or “track” the alignment along the track overlap, while also establishing lane divider matches. As mentioned, a successfully-evaluated seed area can correspond to a local area with a transform that aligns two or more tracks in that area. Processed stretches can labeled through use of, for example, a coverage-per-pose vector to avoid duplicated evaluation of already-visited track overlap portions. Such a coverage vector can be used, for example, to determine whether tracking should be started from a given seed area. Special seed areas with predefined tracking directions, such as seed areas around turns and intersections, can be evaluated up front and marked as processed. A motivation for such an upfront evaluation is that these types of areas have been observed to be difficult for tracking, so it can be beneficial to avoid attempting to track through these areas. Example tracking directions can include “forward,” “backward,” or “both”.

An alignment tracking loop can be used in at least one embodiment. A goal of such a loop can be to process the whole track overlap, such as by first finding a seed area (evaluated or otherwise) that was not yet considered for tracking. A coverage-per-pose vector can be used to determine whether tracking from the given seed area is useful, such as may be dependent on whether the neighboring areas were already processed. If the seed area has prior tracking directions, this may be compared against a given tracking directions constraint. If it is determined that the tracking from the given seed area is not useful, such as where the neighboring areas were already processed, then the process can continue with another seed area being considered. Otherwise, the tracking directions can be adjusted as appropriate and the process can proceed. If the seed area has not been evaluated at this point, then the seed area can be evaluated. If the seed area evaluation fails then a different seed area can be considered for evaluation. If the seed area evaluation succeeds then the successfully-evaluated seed area can be used to propagate and/or track the alignment along the track overlap to locate lane divider matches. Further, the coverage per pose vector can be used to determine the tracking extent, such as whether the tracking should stop at some area which has already been processed.

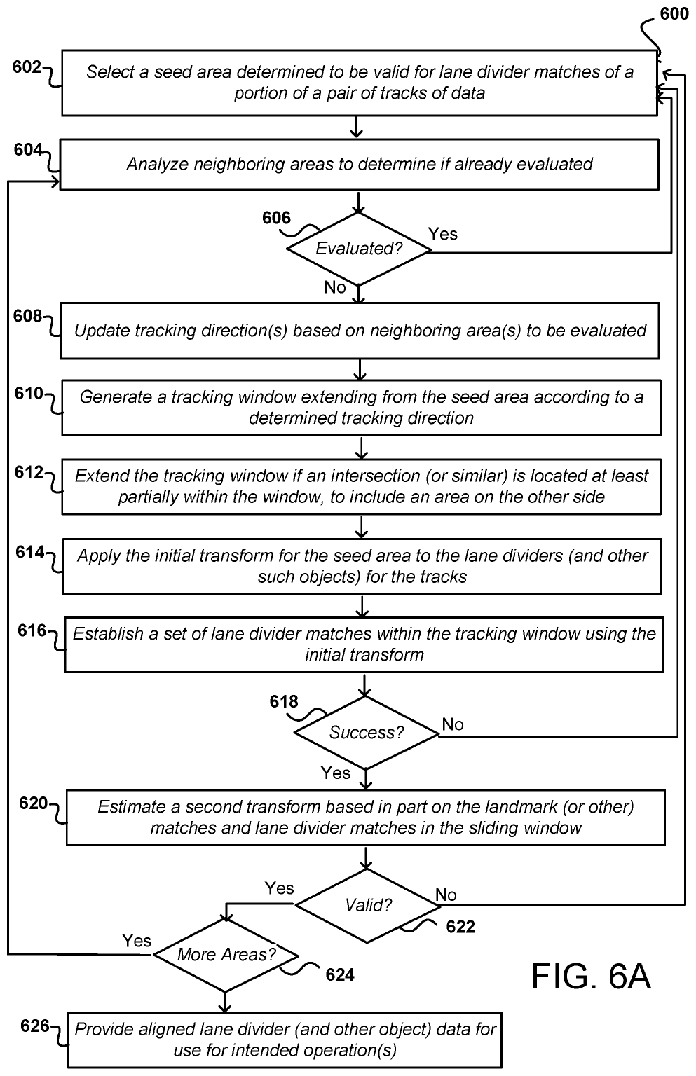

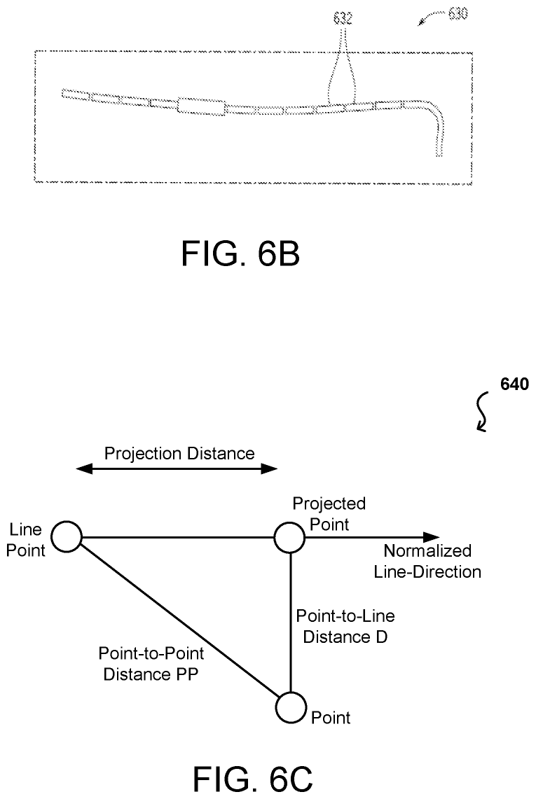

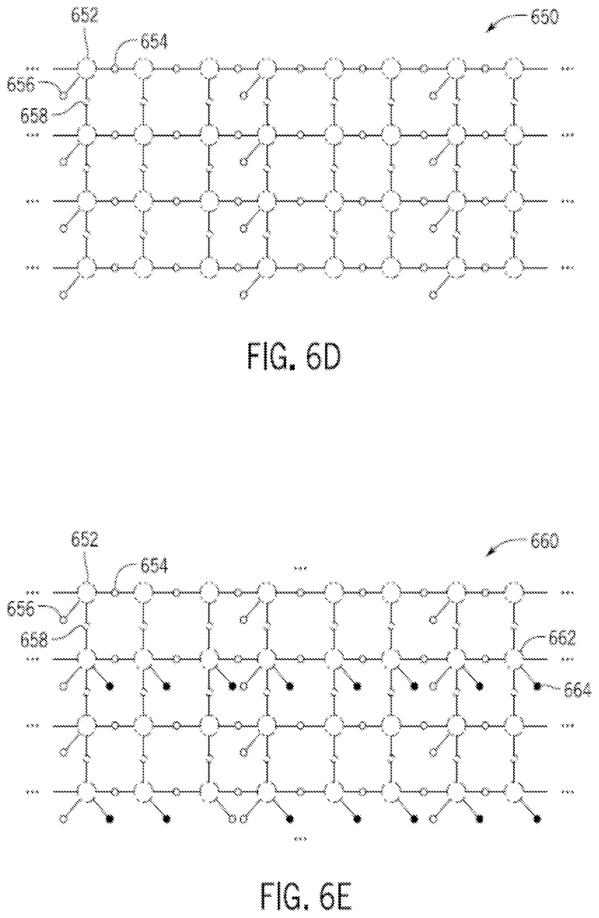

Local alignment tracking can be performed at such a point in the process. Alignment tracking can be performed that is similar to that discussed with respect to seed area evaluation, except that the initial transform can come from the seed area or the previous tracking window. FIG. 6A illustrates an example process 600 that can be performed to align lane markers, according to at least one embodiment. In this example process 600, an evaluated-to-be-valid seed area can be selected 602, where the seed area was evaluated successfully using a process such as that discussed with respect to FIG. 4B. One or more neighboring areas can be analyzed 604 to determine whether these neighboring areas have already been successfully evaluated. If it is determined 606 that the neighboring areas have already been evaluated, then another seed area can be selected (unless all areas have been processed successfully for the available tracks). If it is determined 606 that at least one neighboring area (with at least some amount of overlap in at least one embodiment) has not been successfully evaluated or processed, then one or more tracking directions can be determined and/or updated 608. At least tracking window can be generated 610 that extends from the seed area in a determined tracking direction. The tracking window can be created subject to a maximum length, and the process can stop if the start pose for the tracking window is past the end as provided. The pose in the tracking window can be evaluated to determine whether a complex region such as an intersection is located in the tracking window, and if so, the tracking window can be extended 612 or adjusted such that the window covers at least a minimum areas on both sides of the intersection along the tracking direction. The initial transform for the seed area can be applied 614, whether that transform came from evaluating landmark matches, lane divider matches, or other such objects, elements, or features. Lane divider matches can be established 616 within the tracking window, such as by using a nearest neighbor search, with constraints on orientation, lane-divider-type, and/or orthogonal distance, among other such options. If it is determined 618 that the matching is not successful, such as there a fraction or percentage of lane dividers contained in a lane divider match is small, such as under a minimum threshold, then the seed area and transform can be rejected, and another seed area selected. Other criteria can be used to reject the seed area and transform as well, such as where the tracking window covers an intersection and lane divider matches were not established on both sides of the intersection.

If it is determined 618 that the matching is successful based on the initial transform, then a second transform can be estimated 620 using, for example, landmark matches and lane divider matches. This may be performed using point-to-point and point-to-line constraints via closed form linear minimum least squares. If no landmark matches are present in the current tracking window, then a single point-to-point constraint can be derived from the lane divider matches. Otherwise, the estimation may be unconstrained in the forward direction, which could introduce arbitrary forward drift. The initial transform and the second transform can be compared to determine if the second transform is valid with respect to the first transform, such as where it satisfies rotation and translation criteria or thresholds, and tracking may stop at this point if it is determined 622 that the difference in translation and rotation between the initial transform and the second transform is above one or more applicable thresholds, or otherwise fails at least one tracking criterion, such that the second transform should not be considered to be a valid transform for this area. Unless tracking has stopped, if it is determined 622 that the second transform is valid then, if it is determined 624 that there are more areas of roadway to evaluate then the process can continue by adjusting or extending of the tracking window, but with much smaller thresholds used to evaluate the difference in translation and rotation between the initial and second transforms. As discussed previously, such an operation can provide a final sanity check to ensure that the solution is stable. The process can continue until all sections or portions of a roadway have been evaluated, at which point if it is determined 624 there are no more areas to evaluate then the aligned lane divider data can be provided 626 for use for one or more operations. FIG. 6B illustrates an example view 630 for a seed area with associated tracking windows 632.

In an example instance where there are an insufficient number of landmarks and a lack of road boundaries along a given stretch of roadway, any of the above processes may fail to establish any landmark matches and/or lane divider matches. This can occur more frequently along highways and country roads, where there are few landmarks and road-boundaries are often only detected on one side of the road, if at all. In such an instance, another process can be performed to attempt to establish lane divider matches in these relatively rare cases. In at least one embodiment, an approach can be used that involves inspecting the accuracy of a location determination system, such as a GPS or GNSS system, and if the system is determined to be reasonably accurate then attempt to establish lane divider matches directly using the poses from a single track pose correction process. It can be important to note that there is no tracking aspect in this example process, with sliding windows instead being evaluated separately. Afterwards, additional consistency checks between these separate sliding windows can be performed to increase the likelihood that the resulting lane divider matches are indeed correct.

In at least one embodiment, single sliding windows can be processed by first analyzing the horizontal GPS accuracies associated with the poses in the window, as well as the GPS frequency across the window. Processing for this window can stop if any of a number of tests fail, such as where there are to be no filtered-out and/or invalid GPS data points, which is assumed to be an indicator of locally unreliable GPS data. Further, the maximum horizontal GPS accuracy in the window must be less than a specified threshold, such as less than approximately 1 meter. For reference, current horizontal GPS accuracies are consistently well below 0.5 meters in some German highway stretches. The GPS frequency across the window must also be less than a specified threshold, such as less than 1 Hz. Such tests can be used to guarantee that there are enough GPS measurements to draw meaningful conclusions. For reference, current GPS frequency is about 0.25 Hz in some German highway stretches, based on some approximate estimates. The process can also attempt to find lane divider matches with a search radius of around 0.5 meters, for example, or up to 1 meter in at least one embodiment. The lane divider matching process can be similar to the process discussed above, except here there is no seed area, and no initial transform, as the poses are simply the initial poses from a single track pose correction. For reference, the distances between lane dividers are about 0.3 meters in some German highway stretches, although there are some outlier-tracks. One or more consistency checks can be performed between sliding windows. For example, there should be a minimum number (e.g., 3) of successfully-evaluated consecutive windows. Further, for all pairs of consecutive windows, the delta transform between their final local 2D alignment transforms should fulfill the same sanity check that is performed as part of the matching, though with a different, designated set of parameters.

Multi-track registration can be performed as well in at least one embodiment. Multi-track registration can be expressed as a 3D pose graph, where nodes present 6D track poses and edges imply constraints between pairs of these poses. Generally, the different constraints from GPS measurements and ego motion, as well as from landmark matches and lane divider matches, will not agree about the implied layout of all poses in a common frame of reference. This 3D pose graph optimization problem can be viewed as a non-linear minimum least squares problem, which can be solved via non-linear optimization. The 6D poses T(t, q) are parameterized as 3D translation t and quaternion q. In the following T, refers to 6D transforms or poses.

A first constraint can correspond to a global position constraint. For such a constraint, GPS measurements can be associated with specific track poses and provide global 3D positions t global measured with respect to a sensor reference frame. Global position constraints can pull the position of track poses towards the corresponding GPS-measurements. The resulting residuals can be weighted by w_{global_position}. This constraint can require the transform T_{sensor_to_car} between the sensor reference frame and the vehicle coordinate frame as provided by calibration.

$${r}_{global\_position} = {w}_{global\_position} \cdot ( translation\_of ( T ( t , q ) \cdot {T}_{sensor\_to \_car} ) - {t}_{g l o b a l} )$$

Another example constraint is a relative pose constraint. Ego motion provides relative 6D transforms T_{ego_motion} between consecutive track poses. Relative pose constraints can pull the relative transforms between consecutive track poses towards the corresponding ego motion transforms. The resulting residuals are weighted by w_{relative_translation} and w_{relative_rotation}, as may be given by:

$${T}_{r e l a t i v e} = {T ( {t}_{2} , {q}_{2} )}^{- 1} \cdot T ( {t}_{1} , {q}_{1} )$$

$${r}_{r e l a t i v {e}_{translation}} = {w}_{r e l a t i v {e}_{translation}} \cdot ( {translation}_{of ( {T}_{relative} )} - {tran slation}_{of ( {T}_{e g {o}_{motion}} )} )$$

$${r}_{r e l a t i v {e}_{rotation}} = {w}_{r e l a t i v {e}_{rotation}} \cdot 2 \cdot {imaginary}_{p {art}_{of ( {q}_{relative} \cdot {q}_{e g {o}_{motion}} )}}$$

Another example constraint is a prior/global pose constraint. Prior 6D poses T_{global} can correspond to the optimized poses from prior tracks that were used to create prior maps. For track adjacency and matching, these tracks can be handled like ordinary new tracks. T_{global} can also come from GPS RTK, as may be given by:

$$ΔT = {T}_{g l obal}^{- 1} \cdot T ( t , q )$$

$${r}_{g l o b a {l}_{translation}} = {w}_{g l o b a {l}_{translation}} \cdot {translation}_{o f ( Δ T )}$$

$${r}_{g l o b a {l}_{rotation}} = {w}_{g l o b a {l}_{rotation}} \cdot 2 \cdot {imaginary}_{p a r {t}_{o f ( q i n Δ T )}}$$

Another example constraint is a point-to-point constraint. Such a constraint can be implied by landmark matches between landmarks with well-defined 3D positions, such as signs and signals. The 3D positions Pᵢ can be given as relative coordinates with respect to their associated poses. Point-to-point constraints can pull the relative transforms between the associated poses such that the corresponding points have minimal distance. The resulting residual can be weighted by W_{sign/signal}, as may be given by:

$${r}_{point\_to \_point} = {w}_{s i g n / s i g n a l} \cdot ( {P}_{1} - {T ( {t}_{1} , {q}_{1} )}^{- 1} \cdot T ( {t}_{2} , {q}_{2} ) \cdot {P}_{2} )$$

Another example constraint is a point-to-line constraint. Such a constraint can be implied by lane divider matches, as well as landmark-matches like poles and waitlines, effectively line features where the positions along the lines are not well-defined. FIG. 6C illustrates an example illustration 640 of a point-to-line constraint in accordance with at least one embodiment. Point-to-line constraints can pull the relative transforms between the associated poses such that the points have minimal distance to their corresponding lines. This means that the points are not constrained in their position along the line. For example, vertical line-segments (e.g., poles) can constrain the relative transforms of the associated poses well with respect to their relative 2D position in the horizontal plane, but not with respect to the height above that plane. Similarly, the relative rotation can be well constrained with respect to the rotation around the vertical axis, such as with respect to yaw, but less so for pitch and roll. On the other hand, horizontal line-segments (e.g. lane dividers) may constrain the relative transforms well with respect to height and lateral motion, but not so well in the direction along the lane-dividers. Without loss of generality, the following assumes that the line is associated with pose 1, with line-point pₗᵢₙₑ and normalized direction vₗᵢₙₑ, and the point p refers to pose 2. v_{PP} is the vector from the line-point pₗᵢₙₑ to the corresponding point p:

$$\begin{matrix}\begin{matrix}{\hat{p}}_{l i n e} = T ( {t}_{1} , {q}_{1} ) \cdot {p}_{l i n e} & {\hat{v}}_{l i n e} = {q}_{1} \cdot {v}_{l i n e} & \hat{p} = T ( {t}_{2} , {q}_{2} ) \cdot p\end{matrix} \\ \begin{matrix}{v}_{P P} = \hat{p} - {\hat{p}}_{l i n e} & {p}_{projected} = {\hat{p}}_{line} + ( {v}_{pp} \cdot {\hat{v}}_{line}^{T} ) \cdot \end{matrix} {\hat{v}}_{line}^{T} \\ {r}_{point\_to \_line} = {w}_{point\_to \_line} \cdot ( \hat{p} - {p}_{p r o j e c t e d} )\end{matrix}$$

There are a number of use cases that can be handled using feature-based multi-track registration. One such use case relates to grid-based map creation with and/or without prior maps. Prior maps almost always exist along the grid-cell boundaries, because neighboring grid-cells have overlapping areas to enable the creation of globally consistent maps. The weights of the prior pose constraints can be set to decrease from the grid-cell-boundary to the inner area, which means that the base-map poses are allowed to be changed towards and inside the inner area. Another use case relates to aligning new tracks with ground truth maps. In this scenario new tracks are registered to ground-truth maps, where the maps and their prior tracks/poses must not be changed. Therefore, the prior pose constraints can be kept fixed during the multi-track registration, which is equivalent to setting the prior map constraints weight to infinity. Another use case relates to aligning new tracks with third party maps. This use case is similar to aligning new tracks to ground truth maps, except that third-party maps usually do not provide the prior optimized poses and prior tracks. To this end, synthetic tracks are generated from the third-party maps, which can then be used as prior tracks in the multi-track-registration. For illustration purposes, FIG. 6D illustrates an example pose graph 650 for multi-track registration without prior poses. Global position constraints can be replaced with global pose constraints, if available, such as from GPS RTK. The large dots 652 represent 6D poses in the track data, while the smaller dots include dots 654 for relative pose constraints from ego-motion, dots 656 for global position constraints from trustworthy GPS-measurements (or other geo-position measurements), and dots 658 for relative point-to-point/line constraints from feature matches. For comparison, FIG. 6E illustrates a pose graph 660 for multi-track registration with prior poses. This graph includes first large dots 652 representing updated 6D poses and large dots 662 representing the prior 6D poses. The graph also includes dots 654 representing relative pose constraints from ego motion, dots 656 representing global position constraints from trustworthy GPS measurements, dots 658 representing relative point-to-point/line constraints from feature matches, and dots 664 representing global pose constraints from a frame transforms layer of a base map.

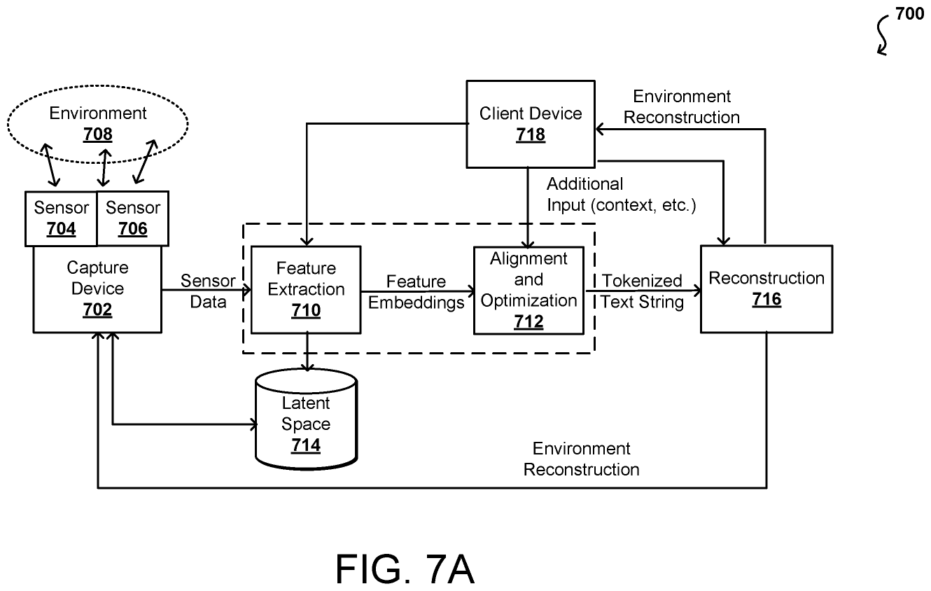

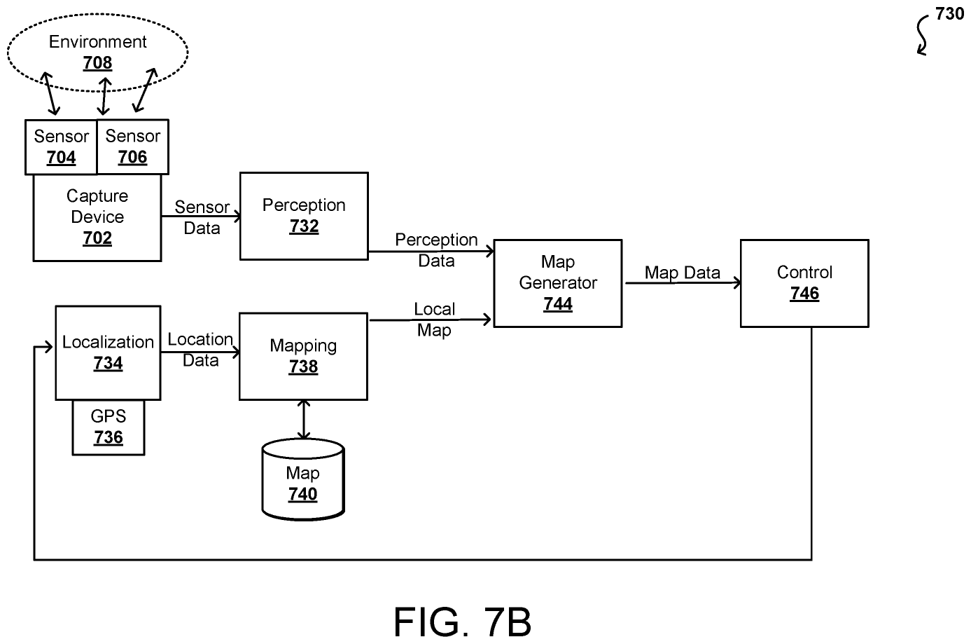

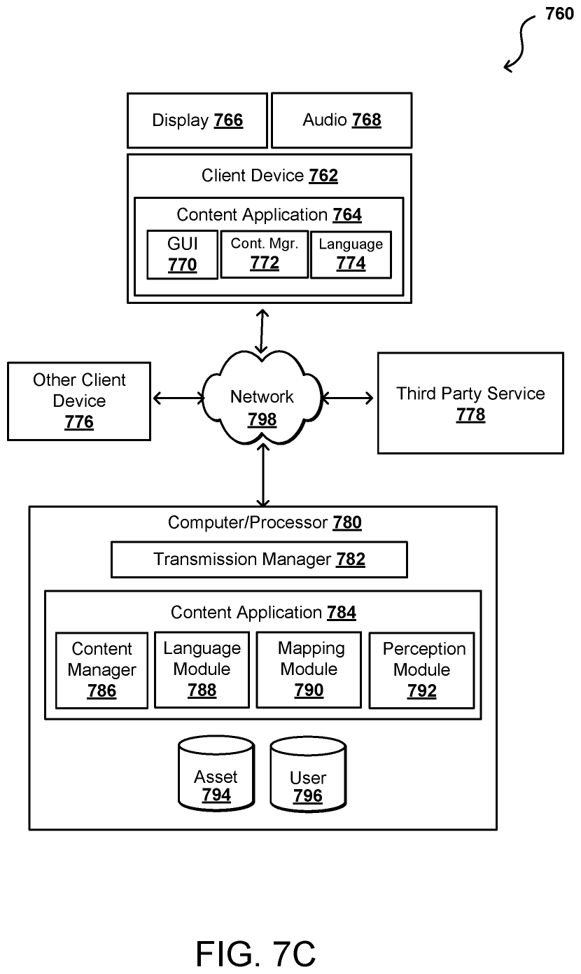

FIG. 7A illustrates an example environment reconstruction pipeline 700 that can be used to generate a representation of an environment in accordance with at least one embodiment. Rather than requiring at least some amount of manual interaction, such an approach can automatically generate a representation from a variety of different types of input data. Such a pipeline 700 can be used to capture, evaluate, and provide representations of objects, such as landmarks and lane dividers in a region containing one or more roadways or traversable thoroughfares as discussed herein. In this example, a capture device 702 can include, or be associated with, one or more sensors 704, 706 that can capture or generate information about an environment 708. The capture device 702 can include any device, system, or component that is able to obtain sensor data from one or more sensors and either process that sensor data or transmit that sensor data for processing, as may include a portable computer, a smart phone, a vehicle with data processing capability, or a robotic assembly, among other such options. The sensors can include any appropriate type of sensor that is able to capture or generate useful information about an environment, including sensors such as cameras, infrared (IR) sensors, ultrasonic sensors, depth sensors, LIDAR systems, radar systems, or other such sensors or data capture elements. The environment 708 can include an environment in which the capture device 702 is located, or that is within a capture distance of one or more sensors 704, 706.

In this example, the capture device 702 can provide the sensor data to be analyzed by a feature extraction module 710. As mentioned, the feature extraction can be performed as part of a machine learning model, such as may be used by at least one alignment and optimization module 712, or by a separate model or algorithm, among other such options. In at least one embodiment, the feature extraction module 710 may include an encoder that can extract features from the various instances of sensor data and encode those features as embeddings or points in a latent space 714. The environment 708 in at least one embodiment can be represented by a set of embeddings or points in latent space, which may then be represented by one or more feature vectors corresponding to those individual embeddings. The latent space 714 may be an n-dimensional latent space, where each environment (or state of an environment) can correspond to a point (or vector) in the n-dimensional latent space. For algorithm-based approaches, the feature data may instead be stored as point cloud data or other such representations as discussed and suggested elsewhere herein.

In this example, at least a relevant portion of the feature data (in an appropriate form), as may correspond to two tracks of sensor data, can be provided as input to an alignment and optimization module 712. Various types of embeddings or representations can be used within the scope of various embodiments. In at least one embodiment, each object (e.g., landmark or lane marker) in the environment can be represented, as discussed previously. Such a representation can specify not only the type of object, but can also represent various features or aspects of that object that can facilitate matching or other such operations.

The alignment and optimization module 712 can use this input to attempt to match and align landmarks or other features of the environment. In this example, the module might receive other input as well that may help to make more accurate matches. For example, the module might receive a prior or partial map or environment representation, which can help with consistency of representations over time, such as where the environment is being reconstructed for a vehicle moving through an environment and comparing the inferences for each time point can help to improve accuracy by reducing noise or removing false positives (or at least flagging inferences that do not make sense based on a prior determination, such as where an object type has changed or suddenly appeared out of nowhere). Various other types of input can be provided as well. For example, a user might use a client device 718, such as a desktop computer or notebook computer, to provide input that can guide the generation of the tokenized text string. For example, the client device 718 might provide contextual information that can help to guide the generation. Contextual information might include, for example, a type of environment, such as indication of an urban or rural setting, which can help the module to apply the appropriate set of rules. The contextual information might indicate the state or country in which the sensor data was captured, as different states or countries often have different traffic or behavior rules, such as which lanes vehicles are allows to turn into at an intersection, which types of traffic signs or signals are used, types of lane markers, etc.

Once matched and aligned features—such as landmarks—are output by the alignment and optimization module 712, that output can be provided to various components for various tasks. In some embodiments, a reconstruction of the environment 708 might be performed by a reconstruction module 716 or system, such as to generate (or update) a high definition map or 3D digital model of the environment 708. In some embodiments, the output might be provided to a control or navigation system for an autonomous vehicle or robot to allow decisions to be made about how to move or interact with respect to objects in the environment. In this example, the initial capture device 702 might be on or part of a vehicle, or may in some embodiments be the vehicle (or robot, etc.) itself. The reconstruction of the environment can be provided back to the capture device for use in performing specific tasks. For example, if the capture device is an autonomous vehicle or driver assistance system, the reconstruction (or in some embodiments the tokenized text string) can be provided back to the capture device—which captured the initial sensor data using associated sensors 704, 706—to perform operations such as to make navigation or operation decisions based in part on the reconstruction.

In at least one embodiment, the reconstruction can be provided to a client device 718 for presentation or analysis, which may be the same client device that instructed the reconstruction. The client device 718 can analyze the reconstructed environment for accuracy and completeness in some embodiments, or can perform various operations or simulations with respect to the environment. The client device 718 may also provide additional information, such as context, to the reconstruction module to use to generate the environment. For example, the client device might instruct the reconstruction module 716 to generate multiple reconstructions of the same environment 708 using the same landmark data, but in different formats or using different criteria. This may include, for a simulation example, versions of the same environment in Europe versus Asia (which can impact the language and style used), and so forth. During model training, the environment reconstruction and/or aligned landmark match data can be compared against appropriate ground truth data in order to determine a loss value and update the parameters for the appropriate model.

In this example, the feature extraction and language generation operations may be part of the same or separate models. For example, a first model (e.g., an encoder) might take the sensor data as input and output a set of embeddings or latent feature vectors as output that can then be provided as input to a generative model (e.g., a generative deep learning model). In another embodiment, a generative model may include feature extraction or analysis capability, and can generate aligned feature match output without any intermediate or other steps to process or analyze the input sensor data. A generative model can be trained to take input from any of various stages of a representation generation pipeline. For example, a language model can take the raw sensor data as input, or can take as input an initial representation (e.g., a point cloud) generated by analyzing that sensor data using a separate module, system, component, model, algorithm, or process. Similarly, the model might take in determined aspects or information as may relate to the semantics, topology, or geometry of an environment, or might take as input an object-based representation generated for the environment, among other such options. In at least some embodiments, the type of input to be used may depend at least in part upon the system in which the generative model to be used, as different systems may already provide specific outputs to be used. In at least one embodiment, a generative model might take the raw sensor data and such an intermediate representation as input, in order to attempt to provide more accurate or consistent representations. In some embodiments, multiple generative models may be used. For example, a first model might be used to determine aspects of an environment that are then to be fed as input to another generative model.

In at least one embodiment, an environment generation and/or reconstruction system can work with various data formats, and can perform reformatting or restricting as appropriate. For example, data might be received in map, object, or graph format and can be converted to a common format or representation for processing. Similarly, such a common format or representation can be used to generate any of these or other such representations of an environment.

In one example, a reconstruction model can be used to generate or correct a representation such as a high definition (HD) map. An HD map generally is a type of map used for tasks such as autonomous driving, which may contain details or information that are not typically included in, or associated with, a conventional map. In an example HD map, individual sections of a roadway are encoded separately. These encodings can differentiate regions corrupting to different lanes in an intersection, for example, as well as potentially options for navigating on those lanes. Such information can be helpful in an intersection where there may not be painted or explicit lane markers for each available lane in each direction. This information helps a navigation system to function more like a human would, having the ability to understand implicit information based on context, but using previous systems these aspects needed to be hard coded and were thus limited in scope and difficult to scale. Each feature in the road can be represented by a node in a graph associated with the HD map. A generative model can take this information, and can make corrections or additions based on its understanding of the relationships and semantics of the environment.

Approaches in accordance with various embodiments can provide for augmentation of perception data with local map information. Such approaches can provide for robust alignment of features in an environment 708. As an example, FIG. 7B illustrates an example environment representation generation or reconstruction system 730 that can be used in accordance with at least one embodiment. It should be understood that reference numbers can be carried over between figures for similar elements, but such usage should not be interpreted as a limitation on scope of the various embodiments. In this example, a capture device 702 can use sensors 704, 706 to capture sensor data (or obtain other such observations) pertaining to an environment 708 using an approach such as that described with respect to FIG. 7A, although other mechanisms or approaches can be used to obtain such data as well within the scope of the various embodiments. Further, additional data can be used to attempt to perceive information about at least a portion of the environment 708 as discussed in more detail elsewhere herein.

In this example, sensor data from the capture device 702 (along with potentially other observations) is provided to a perception module 732. The capture device 702 may perform at least some amount of processing of the sensor data before providing it to the perception module 732, as may include noise reduction, aggregation, correlation, redundant data point removal, and the like. The sensor data may be provided in any appropriate form(s), as may include image data, 3D point cloud data, feature vectors, and so on. An additional benefit to such an approach is that it can provide for enhanced system robustness, being able to identify and account for individual sensor inaccuracies or even failure. For example, a perception module 732 can perform at least some amount of processing of the data from individual sensors, and can determine when the data from one sensor is unreliable and should be modified, weighted by a lower amount, or discarded. In at least one embodiment, a perception module 732 can attempt to correct a value received from an individual sensor, based on data from other sensors or related sources, among other such options.

A perception module 732 in at least one embodiment can perform tasks including those discussed in more detail elsewhere herein, such as to extract features from the sensor data and attempt to identify objects in the environment, as well as to determine relevant information about those objects. Feature extraction or feature inference may be performed by an encoder in at least one embodiment to extract and encode features that may be relatively low-level and may not have a clear sematic meaning attached. The features may be used to generate a relatively universal and/or generic representation of the sensor data. The sensor or perception data can be interpreted and/or correlated in the cross-attention layer(s) of one or more trained models. Such a model can attempt to correlate related features to allow objects to be represented using shapes, such as may be comprised of lines, triangles, or polygons, and can recognize and associate semantic information with the represented objects. In at least one embodiment, a model may analyze a feature vector including appearance information for an object, without any higher-level structure information, and attempt to determine various attributes relating to semantics, relationships, topology, geometry, and the like. An encoder thus may just attempt to represent the sensor data as faithfully and accurately as possible using a subset of points or embeddings, in a way that is friendly to downstream processing. A model (or other such component) receiving these features or embeddings can then attempt to make sense of these encodings using domain-specific knowledge.

Sensor data can be extracted and/or encoded in a number of different ways. For example, there may be one encoder per sensor so that each sensor can output a respective token stream that can be input to a model. A trained model can then fuse the information in the parallel streams with the map data as discussed herein. In other embodiments, sensor data fusion can be performed before generating the token stream. As an example, a point cloud representation of the environment around a vehicle can be generated using data captured by sensors around the vehicle, and this point cloud representation can be analyzed to generate the token stream. Correlation of the sensor data can be performed in such a way as calibration information for the sensors may already be available in many instances, such that position data can be determined with respect to a consistent coordinate system or frame of reference. The model can then analyze the consistent 3D representation to generate a single representation in at least one embodiment. The correlation of the sensor data can also address issues relating to multi-modality, as any of a number of different approaches can be used to interpret and correlate data from different types of sensors. For example, algorithms are available that can correlate appearance features extracted from a camera image with position data obtained from a LiDAR system, etc.

In at least one embodiment, a perception module 732 may attempt to identify only specific objects of interest, or types of objects, in order to reduce environment perception to a more manageable task. For navigation of a vehicle, for example, this may include detection of static and/or dynamic objects relevant to driving, as may include lane boundaries, traffic signals, other vehicles on the roadway, pedestrians within a range of the vehicle, and so forth. The perception module may determine that there are static objects away from the roadway, or what are otherwise unlikely to impact navigation, and may either classify those objects as unimportant or exclude those objects from identification, among other such options. In at least one embodiment, a perception module 732 will attempt to determine at least a relevant position of specific types of objects with respect to the ego vehicle, if not an absolute position with respect to some geographic origin or reference plane, point, or coordinate system. For objects that may be in motion, such as vehicles on the same roadway as the ego vehicle, this may include a position at a specific point in time or a range of positions over a window of time, such as a window having a length corresponding to the capture or refresh rate of the relevant sensor(s) used to determine the position. For objects in motion, the perception module 732 may also attempt to determine a direction and/or rate of motion, such as velocity, acceleration, or deceleration, as may be based in part on position or motion information determined for a prior point or window in time. In at least one embodiment, a perception module 732 can produce an accurate recreation or representation of the environment in which the ego vehicle is operating, in order to allow a vehicle control system 746, process, or module to determine instructions for safely operating the vehicle within that environment to achieve a desired goal, such as to navigate the vehicle safely to a target destination.

As mentioned, in at least some embodiments, a vehicle—such as an autonomous or semi-autonomous vehicle—can operate based on this perception data. In order to provide for a more accurate perception of at least a relevant portion of the environment 708, however, a system in accordance with at least one embodiment can attempt to augment or improve accuracy of this perception data using local map information. In the example environment representation generation or reconstruction system 730 of FIG. 7B, a mapping module 738 can access map data stored to a map repository 740 or other such location. The map repository 740 may be available on the vehicle or accessible over a wireless data connection, for example, where relevant map data can be pre-fetched by the vehicle based on a current and/or anticipated location of the vehicle, such as for a given minimum distance of the vehicle or along a current navigation route. Pre-fetching can be used to attempt to ensure that the relevant map data is available even if the wireless network connection is weak, spotty, or otherwise unreliable or unavailable in a given location or region. The mapping module 738 in this example can work with a localization module 734 to attempt to determine a current geographic location of the vehicle. The localization module 734 can contain, or communicate with, at least one system, sensor, device, component, process, service, or other such mechanism to determine a location of the ego vehicle. This may include, for example, use of a GPS (or GNSS) system 736 that uses satellite-based radio signals to perform geolocation anywhere a sufficiently strong signal is able to be received from at least a minimum number of satellites, such as at least three or four satellites. A benefit of GPS is that it can be highly accurate, does not require an outgoing data transmission from the ego vehicle, and does not require an active network connection, such as an Internet or cellular connection. A GPS system must generally have an unobstructed transmission path from the minimum number of satellites, however, which may not be possible in certain locations, such as cities with tall buildings, tunnels, or mountainous regions. Other geolocation mechanisms can be used as well in other embodiments, such as those that make determinations based at least in part upon signals transmitted from earth or recognizable features in the nearby environment 708, among other such options. A GPS receiver will typically be on the vehicle while other approaches might use components not on the vehicle, although latency and connectivity can then become problematic in certain situations. In at least one embodiment, the localization module 734 can attempt to improve or stabilize the location data from the GPS (or other such system) using other available information, such as the velocity and direction of travel of the vehicle, the locations of nearby objects, signal noise reduction, and so on. In this example, the mapping module 738 can receive geolocation data from the localization module 734, and can determine the current location of the ego vehicle with respect to the stored map data. In at least one embodiment, this can be used to obtain and/or pre-fetch local map data for a current geolocation of the ego vehicle.

At least a selected portion of the perception data from the perception module 732, and the geolocation and/or local map data from the mapping module 738, can be provided as input to a map generator module 744. The map generator can determine features in the perception data 732 and align those with features in prior (or other) tracks of data for the environment, in order to perform feature matching and alignment. The map generator module 744 can then use the aligned feature matches to generate updated map data where appropriate, which can be provided to a vehicle control module 746. The vehicle control module 746 can then make operational decisions for a device or system, such as a vehicle or robotic assembly, indicating how to operate in the environment 708 given the current conditions. Such an approach may be useful in dynamic environments that are constantly changing, such as warehouses, where the map data can be updated dynamically using features in the sensor data (or perception data) that have been matched and aligned with previously-identified features in the environment 708.

Aspects of various approaches presented herein can be lightweight enough to execute in various locations, such as on a device, such as a client device that includes a personal computer or gaming console, in real time. Such processing can be performed on, or for, content that is generated on, or received by, that client device or received from an external source, such as streaming data or other content received over at least one network from a cloud server or third party service, among other such options. In some instances, at least a portion of the processing, generation, compositing, and/or determination of this content may be performed by one of these other devices, systems, or entities, then provided to the client device (or another such recipient) for presentation or another such use.

As an example, FIG. 7C illustrates an example network configuration 760 that can be used to provide, generate, modify, encode, process, fuse, and/or transmit generated data or other such content. In at least one embodiment, a client device 762 can generate or receive data for a session using components of a content application 764 on the client device 762 and data stored locally on that client device. In at least one embodiment, a content application 784 executing on a computer or processor 780 (e.g., a cloud server or control system) may initiate a session associated with at least one client device 762 (e.g., a vehicle or robot), as may use a session manager and user data stored in a user database 796, and can cause content such as map data (e.g., implicit and/or explicit object representations or maps) from an asset repository 794 to be determined by a content manager 786. A content manager 786 may work with at least one trained language module 788 perform tasks such as to extract features from sensor data, identify objects in the environment, or determine matching features in tracks of data, among other such options. The content manager 786 may also work with a perception module 792 to process the raw sensor data for use in feature matching, as well as a mapping module 790 for generating or updating map data based in part upon aligned feature matches. At least a portion of the generated map data (or aligned feature match data, etc.) can be transmitted to the client device 762 using an appropriate transmission manager 782 to send by download, streaming, or another such transmission channel. An encoder may be used to encode and/or compress at least some of this data before transmitting to the client device 762. In at least one embodiment, the client device 762 receiving such content can provide this content to a corresponding content application 764, which may also or alternatively include a graphical user interface 770 and content manager 772 for use in providing, synthesizing, rendering, compositing, modifying, or using content for presentation, navigation, control, (or other purposes) on or by the client device 718. The content application 764 can also include a language module 774 that can perform various tasks, such as may relate to matching and aligning features and/or updating map data. In some embodiments, the computer/processor 780 and client device 762 may be able to communicate directly without needing to transmit data over a network 798, in order to avoid issues with latency and availability, etc. A decoder may also be used to decode data received over the network 798 for presentation via client device 762, such as map content through a display device 766 and audio, such as sounds and music, through at least one audio playback device 768, such as speakers or headphones. In at least one embodiment, at least some of this content may already be stored on, rendered on, or accessible to client device 762 such that transmission over network 798 is not required for at least that portion of content, such as where that content (e.g., map data) may have been previously downloaded or stored locally on a hard drive or optical disk. In at least one embodiment, a transmission mechanism such as data streaming can be used to transfer this content from the computer/processor 780, or user database 796, to client device 762. In at least one embodiment, at least a portion of this content can be obtained, enhanced, and/or streamed from another source, such as a third party service 778 or other client device 776, that may also include a content application for generating, updating, enhancing, or providing map content. In at least one embodiment, portions of this functionality can be performed using multiple computing devices, or multiple processors within one or more computing devices, such as may include a combination of CPUs and GPUs (Graphics Processing Unit).

In at least some of these examples, client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by allowing the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device or may incorporate one or more Virtual Machines (VMs). In at least one embodiment, such a system can be implemented at least partially in a data center or at least partially using cloud computing resources.

### Data Center

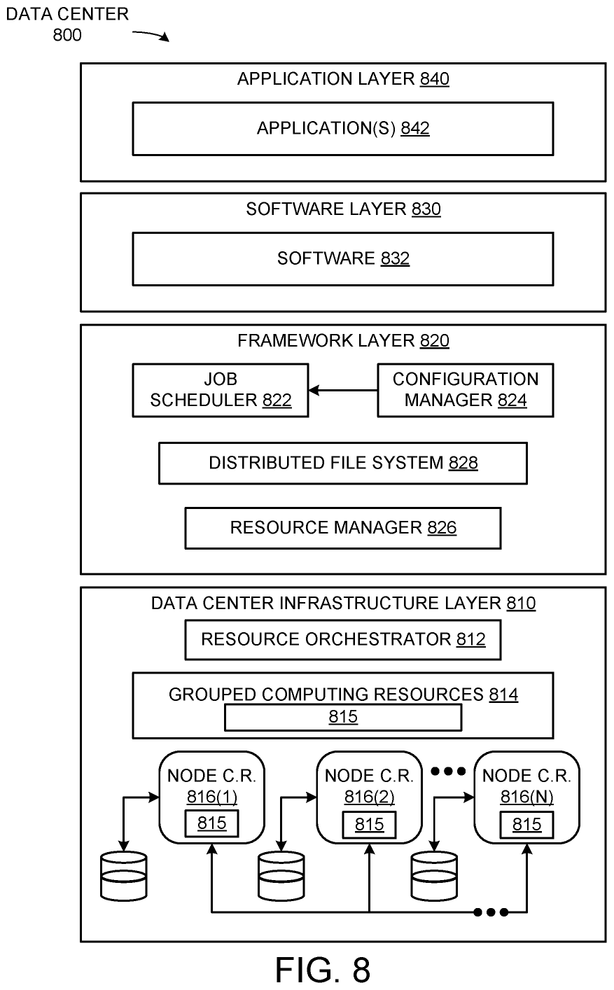

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents a positive integer (which may be a different integer “N” than used in other figures). In at least one embodiment, node C.R.s 816(1)-816(N) may include, but are not limited to, any number of central processing units (“CPUs”) or other processors (including accelerators, field programmable gate arrays (FPGAs), graphics processors, etc.), memory storage devices 818(1)-818(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). In at least one embodiment, separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resources 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. In at least one embodiment, one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 815 are used to perform inferencing and/or training operations associated with one or more embodiments. In at least one embodiment, inference and/or training logic 815 may be used in system FIG. 8 for inferencing or predicting operations based, at least in part, on weight parameters calculated using neural network training operations, neural network functions and/or architectures, or neural network use cases described herein.

Embodiments presented herein can provide for the automated matching of landmarks in tracks of sensor data.

### Computer Systems

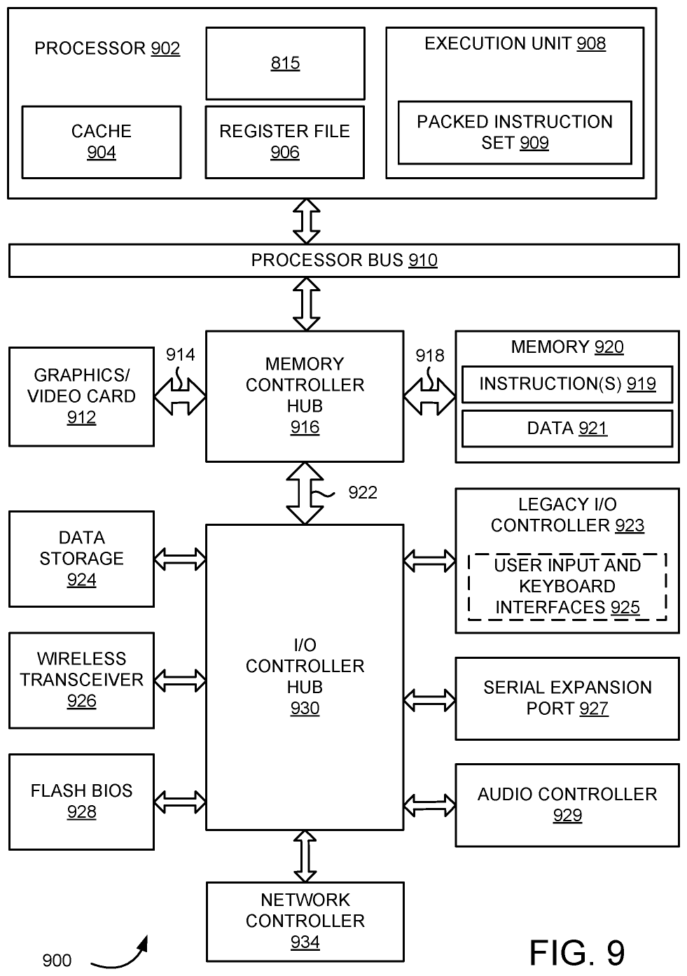

FIG. 9 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment, computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, a register file 906 may store different types of data in various registers including, without limitation, integer registers, floating point registers, status registers, and an instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor, along with associated circuitry to execute instructions, operations used by many multimedia applications may be performed using packed data in processor 902. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be a Dynamic Random Access Memory (“DRAM”) device, a Static Random Access Memory (“SRAM”) device, a flash memory device, or another memory device. In at least one embodiment, memory 920 may store instruction(s) 919 and/or data 921 represented by data signals that may be executed by processor 902.

In at least one embodiment, a system logic chip may be coupled to processor bus 910 and memory 920. In at least one embodiment, a system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data, and textures. In at least one embodiment, MCH 916 may direct data signals between processor 902, memory 920, and other components in computer system 900 and to bridge data signals between processor bus 910, memory 920, and a system I/O interface 922. In at least one embodiment, a system logic chip may provide a graphics port for coupling to a graphics controller. In at least one embodiment, MCH 916 may be coupled to memory 920 through high bandwidth memory path 918 and a graphics/video card 912 may be coupled to MCH 916 through an Accelerated Graphics Port (“AGP”) interconnect 914.

In at least one embodiment, computer system 900 may use system I/O interface 922 as a proprietary hub interface bus to couple MCH 916 to an I/O controller hub (“ICH”) 930. In at least one embodiment, ICH 930 may provide direct connections to some I/O devices via a local I/O bus. In at least one embodiment, a local I/O bus may include, without limitation, a high-speed I/O bus for connecting peripherals to memory 920, a chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as a Universal Serial Bus (“USB”) port, and a network controller 934. In at least one embodiment, data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary SoC. In at least one embodiment, devices illustrated in FIG. 9 may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 815 are used to perform inferencing and/or training operations associated with one or more embodiments. In at least one embodiment, inference and/or training logic 815 may be used in system FIG. 9 for inferencing or predicting operations based, at least in part, on weight parameters calculated using neural network training operations, neural network functions and/or architectures, or neural network use cases described herein.

Embodiments presented herein can provide for the automated matching of landmarks in tracks of sensor data.

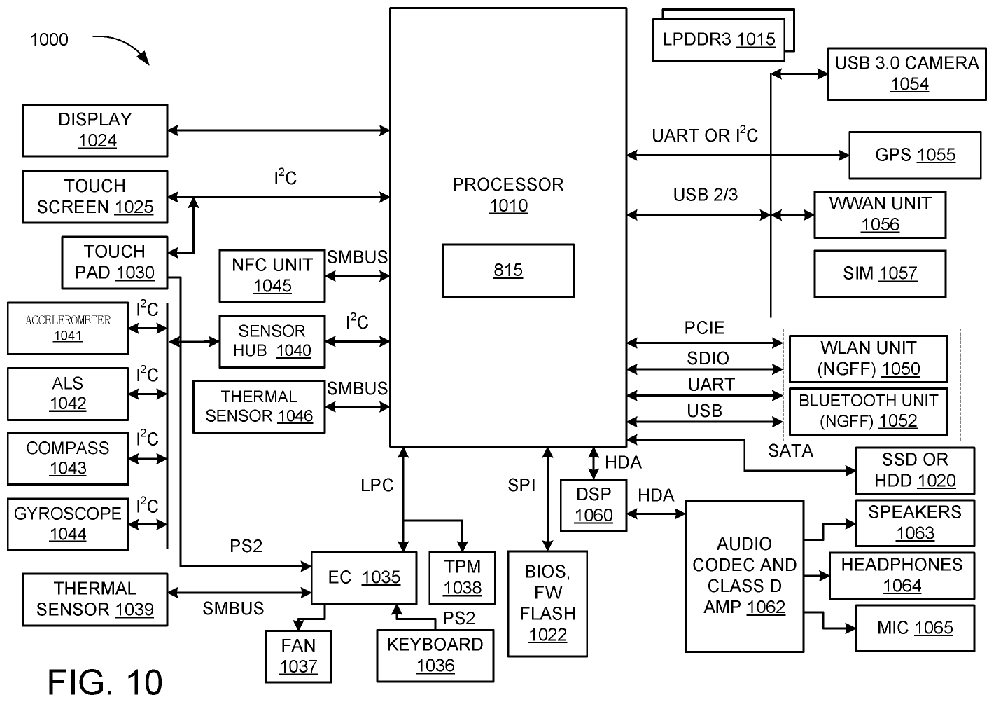

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 is coupled using a bus or interface, such as a I2C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary SoC. In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) unit 1055, a camera (“USB 3.0 camera”) 1054 such as a USB 3.0 camera, and/or a Low Power Double Data Rate (“LPDDR”) memory unit (“LPDDR3”) 1015 implemented in, for example, an LPDDR3 standard. These components may each be implemented in any suitable manner.

In at least one embodiment, other components may be communicatively coupled to processor 1010 through components described herein. In at least one embodiment, an accelerometer 1041, an ambient light sensor (“ALS”) 1042, a compass 1043, and a gyroscope 1044 may be communicatively coupled to sensor hub 1040. In at least one embodiment, a thermal sensor 1039, a fan 1037, a keyboard 1036, and touch pad 1030 may be communicatively coupled to EC 1035. In at least one embodiment, speakers 1063, headphones 1064, and a microphone (“mic”) 1065 may be communicatively coupled to an audio unit (“audio codec and class D amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, a SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 815 are used to perform inferencing and/or training operations associated with one or more embodiments. In at least one embodiment, inference and/or training logic 815 may be used in system FIG. 10 for inferencing or predicting operations based, at least in part, on weight parameters calculated using neural network training operations, neural network functions and/or architectures, or neural network use cases described herein.

Embodiments presented herein can provide for the automated matching of landmarks in tracks of sensor data.

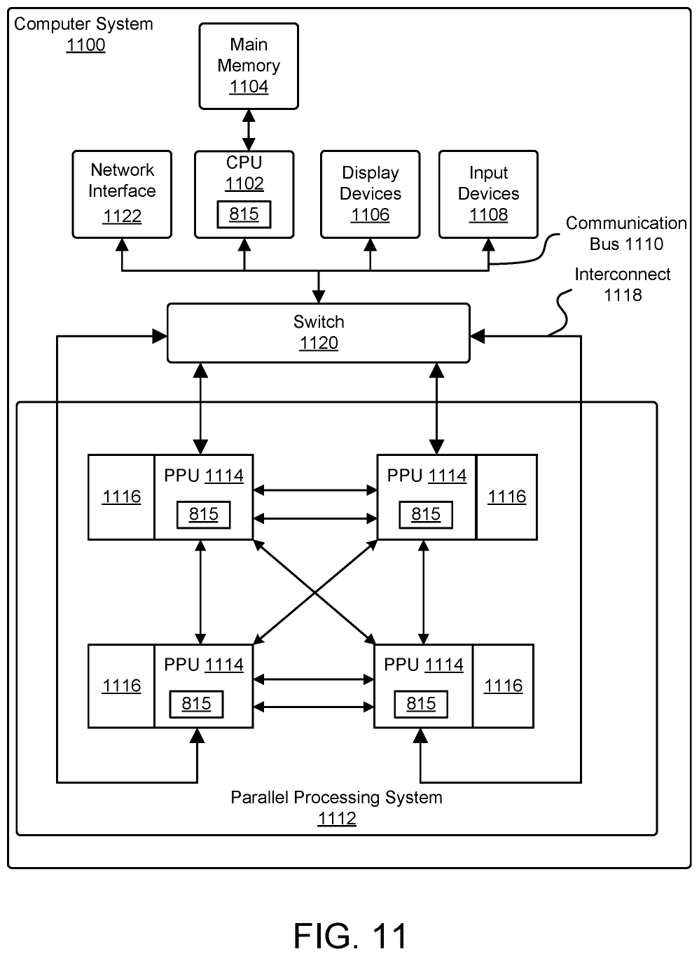

FIG. 11 illustrates a computer system 1100, according to at least one embodiment. In at least one embodiment, computer system 1100 is configured to implement various processes and methods described throughout this disclosure.

In at least one embodiment, computer system 1100 comprises, without limitation, at least one central processing unit (“CPU”) 1102 that is connected to a communication bus 1110 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1100 includes, without limitation, a main memory 1104 and control logic (e.g., implemented as hardware, software, or a combination thereof) and data are stored in main memory 1104, which may take form of random access memory (“RAM”). In at least one embodiment, a network interface subsystem (“network interface”) 1122 provides an interface to other computing devices and networks for receiving data from and transmitting data to other systems with computer system 1100.

In at least one embodiment, computer system 1100, in at least one embodiment, includes, without limitation, input devices 1108, a parallel processing system 1112, and display devices 1106 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 1108 such as keyboard, mouse, touchpad, microphone, etc. In at least one embodiment, each module described herein can be situated on a single semiconductor platform to form a processing system.

Inference and/or training logic 815 are used to perform inferencing and/or training operations associated with one or more embodiments. In at least one embodiment, inference and/or training logic 815 may be used in system FIG. 11 for inferencing or predicting operations based, at least in part, on weight parameters calculated using neural network training operations, neural network functions and/or architectures, or neural network use cases described herein.

Embodiments presented herein can provide for the automated matching of landmarks in tracks of sensor data.

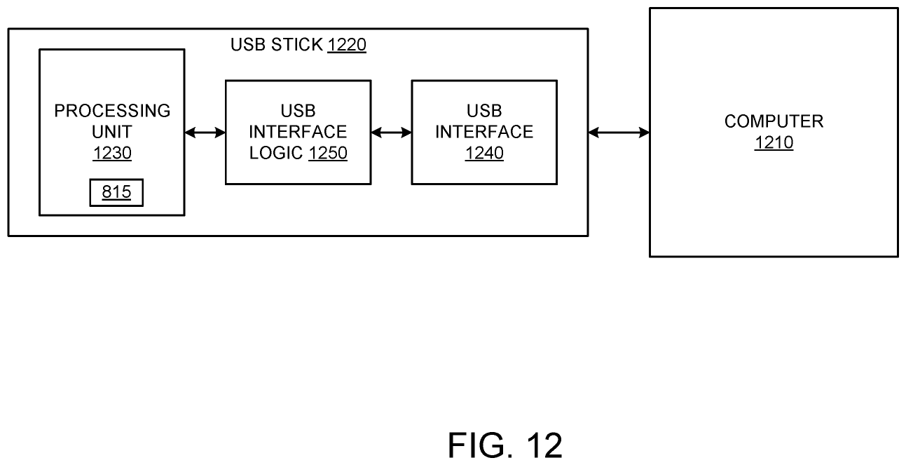

FIG. 12 illustrates a computer system 1200, according to at least one embodiment. In at least one embodiment, computer system 1200 includes, without limitation, a computer 1210 and a USB stick 1220. In at least one embodiment, computer 1210 may include, without limitation, any number and type of processor(s) (not shown) and a memory (not shown). In at least one embodiment, computer 1210 includes, without limitation, a server, a cloud instance, a laptop, and a desktop computer.

In at least one embodiment, USB stick 1220 includes, without limitation, a processing unit 1230, a USB interface 1240, and USB interface logic 1250. In at least one embodiment, processing unit 1230 may be any instruction execution system, apparatus, or device capable of executing instructions. In at least one embodiment, processing unit 1230 may include, without limitation, any number and type of processing cores (not shown). In at least one embodiment, processing unit 1230 comprises an application specific integrated circuit (“ASIC”) that is optimized to perform any amount and type of operations associated with machine learning. For instance, in at least one embodiment, processing unit 1230 is a tensor processing unit (“TPC”) that is optimized to perform machine learning inference operations. In at least one embodiment, processing unit 1230 is a vision processing unit (“VPU”) that is optimized to perform machine vision and machine learning inference operations.

In at least one embodiment, USB interface 1240 may be any type of USB connector or USB socket. For instance, in at least one embodiment, USB interface 1240 is a USB 3.0 Type-C socket for data and power. In at least one embodiment, USB interface 1240 is a USB 3.0 Type-A connector. In at least one embodiment, USB interface logic 1250 may include any amount and type of logic that enables processing unit 1230 to interface with devices (e.g., computer 1210) via USB connector 1240.

Inference and/or training logic 815 are used to perform inferencing and/or training operations associated with one or more embodiments. In at least one embodiment, inference and/or training logic 815 may be used in system FIG. 12 for inferencing or predicting operations based, at least in part, on weight parameters calculated using neural network training operations, neural network functions and/or architectures, or neural network use cases described herein.

Embodiments presented herein can provide for the automated matching of landmarks in tracks of sensor data.

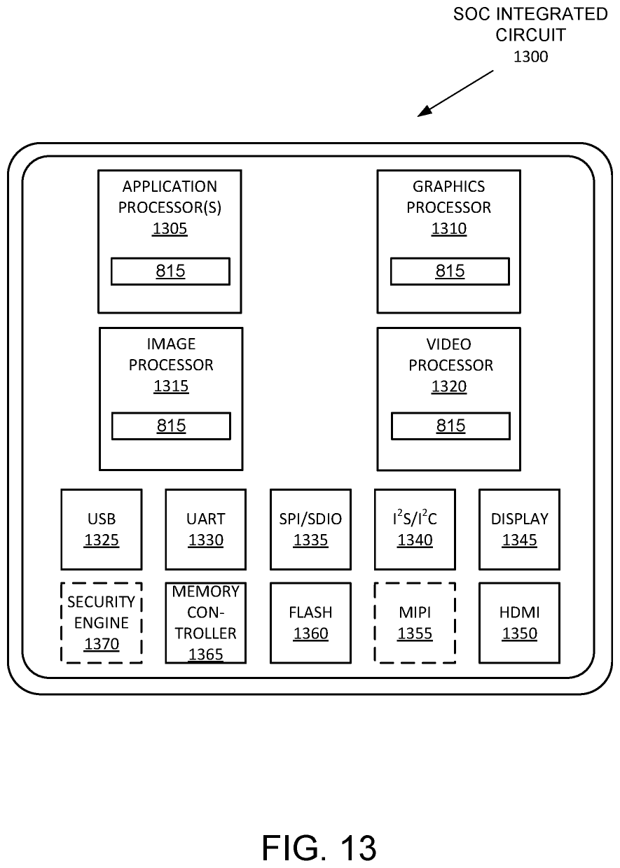

FIG. 13 illustrates exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIG. 13 is a block diagram illustrating an exemplary system-on-a-chip (SOC) integrated circuit 1300 that may be fabricated using one or more IP cores, according to at least one embodiment. In at least one embodiment, SOC integrated circuit 1300 includes one or more application processor(s) 1305 (e.g., CPUs), at least one graphics processor 1310, and may additionally include an image processor 1315 and/or a video processor 1320, any of which may be a modular IP core. In at least one embodiment, SOC integrated circuit 1300 includes peripheral or bus logic including a USB controller 1325, a UART controller 1330, an SPI/SDIO controller 1335, and an I²2S/I²2C controller 1340. In at least one embodiment, SOC integrated circuit 1300 can include a display device 1345 coupled to one or more of a high-definition multimedia interface (HDMI) controller 1350 and a mobile industry processor interface (MIPI) display interface 1355. In at least one embodiment, storage may be provided by a flash memory subsystem 1360 including flash memory and a flash memory controller. In at least one embodiment, a memory interface may be provided via a memory controller 1365 for access to SDRAM or SRAM memory devices. In at least one embodiment, some integrated circuits additionally include an embedded security engine 1370.

Inference and/or training logic 815 are used to perform inferencing and/or training operations associated with one or more embodiments. In at least one embodiment, inference and/or training logic 815 may be used in SOC integrated circuit 1300 for inferencing or predicting operations based, at least in part, on weight parameters calculated using neural network training operations, neural network functions and/or architectures, or neural network use cases described herein.

Embodiments presented herein can provide for the automated matching of landmarks in tracks of sensor data.

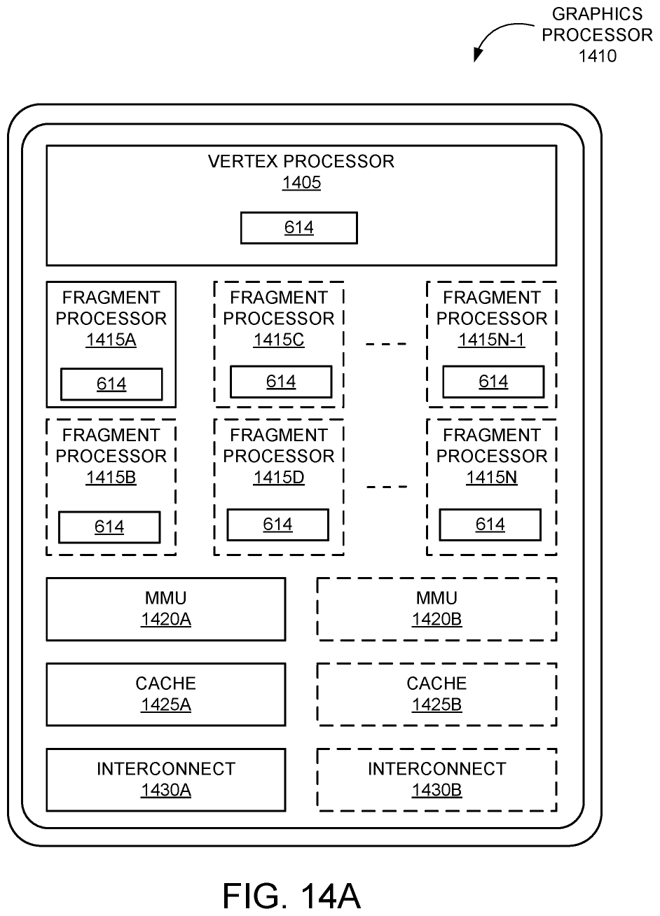

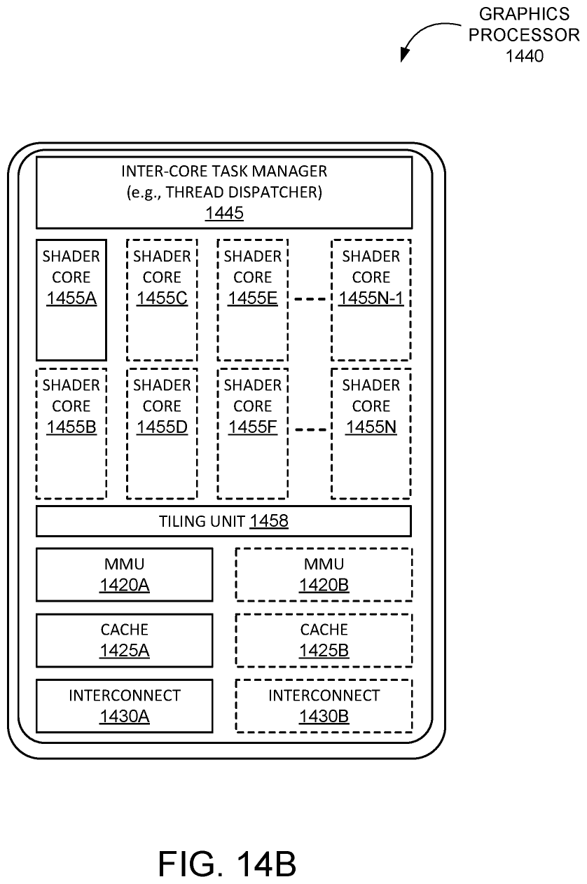

FIGS. 14A-14B illustrate exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIGS. 14A-14B are block diagrams illustrating exemplary graphics processors for use within an SoC, according to embodiments described herein. FIG. 14A illustrates an exemplary graphics processor 1410 of a system on a chip integrated circuit that may be fabricated using one or more IP cores, according to at least one embodiment. FIG. 14B illustrates an additional exemplary graphics processor 1440 of a system on a chip integrated circuit that may be fabricated using one or more IP cores, according to at least one embodiment. In at least one embodiment, graphics processor 1410 of FIG. 14A is a low power graphics processor core. In at least one embodiment, graphics processor 1440 of FIG. 14B is a higher performance graphics processor core. In at least one embodiment, each of graphics processors 1410, 1440 can be variants of computer system 1200 of FIG. 12.

In at least one embodiment, graphics processor 1410 includes a vertex processor 1405 and one or more fragment processor(s) 1415A-1415N (e.g., 1415A, 1415B, 1415C, 1415D, through 1415N-1, and 1415N). In at least one embodiment, graphics processor 1410 can execute different shader programs via separate logic, such that vertex processor 1405 is optimized to execute operations for vertex shader programs, while one or more fragment processor(s) 1415A-1415N execute fragment (e.g., pixel) shading operations for fragment or pixel shader programs. In at least one embodiment, vertex processor 1405 performs a vertex processing stage of a 3D graphics pipeline and generates primitives and vertex data. In at least one embodiment, fragment processor(s) 1415A-1415N use primitive and vertex data generated by vertex processor 1405 to produce a framebuffer that is displayed on a display device. In at least one embodiment, fragment processor(s) 1415A-1415N are optimized to execute fragment shader programs as provided for in an OpenGL API, which may be used to perform similar operations as a pixel shader program as provided for in a Direct 3D API.

In at least one embodiment, graphics processor 1410 additionally includes one or more memory management units (MMUs) 1420A-1420B, cache(s) 1425A-1425B, and circuit interconnect(s) 1430A-1430B. In at least one embodiment, one or more MMU(s) 1420A-1420B provide for virtual to physical address mapping for graphics processor 1410, including for vertex processor 1405 and/or fragment processor(s) 1415A-1415N, which may reference vertex or image/texture data stored in memory, in addition to vertex or image/texture data stored in one or more cache(s) 1425A-1425B. In at least one embodiment, one or more MMU(s) 1420A-1420B may be synchronized with other MMUs within a system, including one or more MMUs associated with one or more application processor(s) 1405, image processors 1415, and/or video processors 1420 of FIG. 14A, such that each processor 1405-1420 can participate in a shared or unified virtual memory system. In at least one embodiment, one or more circuit interconnect(s) 1430A-1430B enable graphics processor 1410 to interface with other IP cores within SoC, either via an internal bus of SoC or via a direct connection.

In at least one embodiment, graphics processor 1440 includes one or more shader core(s) 1455A-1455N (e.g., 1455A, 1455B, 1455C, 1455D, 1455E, 1455F, through 1455N-1, and 1455N) as shown in FIG. 14B, which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 1440 includes an inter-core task manager 1445, which acts as a thread dispatcher to dispatch execution threads to one or more shader cores 1455A-1455N and a tiling unit 1458 to accelerate tiling operations for tile-based rendering, in which rendering operations for a scene are subdivided in image space, for example to exploit local spatial coherence within a scene or to optimize use of internal caches.

Embodiments presented herein can provide for the automated matching of landmarks in tracks of sensor data.

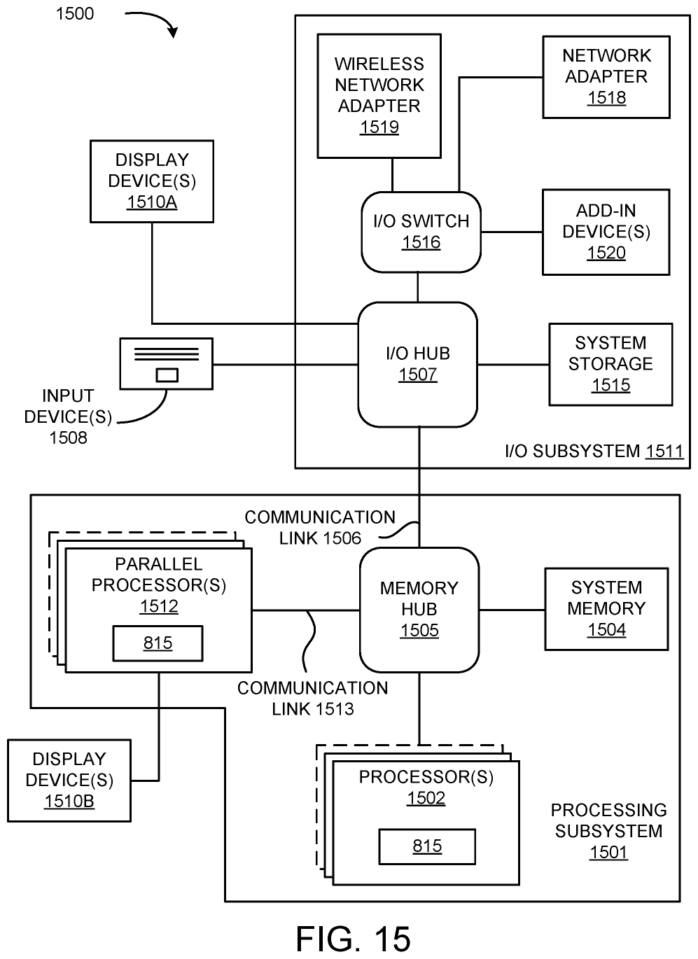

FIG. 15 is a block diagram illustrating a computing system 1500 according to at least one embodiment. In at least one embodiment, computing system 1500 includes a processing subsystem 1501 having one or more processor(s) 1502 and a system memory 1504 communicating via an interconnection path that may include a memory hub 1505. In at least one embodiment, memory hub 1505 may be a separate component within a chipset component or may be integrated within one or more processor(s) 1502. In at least one embodiment, memory hub 1505 couples with an I/O subsystem 1511 via a communication link 1506. In at least one embodiment, I/O subsystem 1511 includes an I/O hub 1507 that can enable computing system 1500 to receive input from one or more input device(s) 1508. In at least one embodiment, I/O hub 1507 can enable a display controller, which may be included in one or more processor(s) 1502, to provide outputs to one or more display device(s) 1510A. In at least one embodiment, one or more display device(s) 1510A coupled with I/O hub 1507 can include a local, internal, or embedded display device.

In at least one embodiment, processing subsystem 1501 includes one or more parallel processor(s) 1512 coupled to memory hub 1505 via a bus or other communication link 1513. In at least one embodiment, communication link 1513 may use one of any number of standards based communication link technologies or protocols, such as but not limited to PCI Express, or may be a vendor-specific communications interface or communications fabric. In at least one embodiment, one or more parallel processor(s) 1512 form a computationally focused parallel or vector processing system that can include a large number of processing cores and/or processing clusters, such as a many-integrated core (MIC) processor. In at least one embodiment, some or all of parallel processor(s) 1512 form a graphics processing subsystem that can output pixels to one of one or more display device(s) 1510A coupled via I/O hub 1507. In at least one embodiment, parallel processor(s) 1512 can also include a display controller and display interface (not shown) to enable a direct connection to one or more display device(s) 1510B. In at least one embodiment, parallel processor(s) 1512 include one or more cores, such as graphics cores 1500 discussed herein.

In at least one embodiment, a system storage unit 1514 can connect to I/O hub 1507 to provide a storage mechanism for computing system 1500. In at least one embodiment, an I/O switch 1516 can be used to provide an interface mechanism to enable connections between I/O hub 1507 and other components, such as a network adapter 1518 and/or a wireless network adapter 1519 that may be integrated into platform, and various other devices that can be added via one or more add-in device(s) 1520. In at least one embodiment, network adapter 1518 can be an Ethernet adapter or another wired network adapter. In at least one embodiment, wireless network adapter 1519 can include one or more of a Wi-Fi, Bluetooth, near field communication (NFC), or other network device that includes one or more wireless radios.

In at least one embodiment, computing system 1500 can include other components not explicitly shown, including USB or other port connections, optical storage drives, video capture devices, and like, may also be connected to I/O hub 1507. In at least one embodiment, communication paths interconnecting various components in FIG. 15 may be implemented using any suitable protocols, such as PCI (Peripheral Component Interconnect) based protocols (e.g., PCI-Express), or other bus or point-to-point communication interfaces and/or protocol(s), such as NV-Link high-speed interconnect, or interconnect protocols.

In at least one embodiment, parallel processor(s) 1512 incorporate circuitry optimized for graphics and video processing, including, for example, video output circuitry, and constitutes a graphics processing unit (GPU), e.g., parallel processor(s) 1512 includes graphics core 1500. In at least one embodiment, parallel processor(s) 1512 incorporate circuitry optimized for general purpose processing. In at least embodiment, components of computing system 1500 may be integrated with one or more other system elements on a single integrated circuit. For example, in at least one embodiment, parallel processor(s) 1512, memory hub 1505, processor(s) 1502, and I/O hub 1507 can be integrated into a system on chip (SoC) integrated circuit. In at least one embodiment, components of computing system 1500 can be integrated into a single package to form a system in package (SIP) configuration. In at least one embodiment, at least a portion of components of computing system 1500 can be integrated into a multi-chip module (MCM), which can be interconnected with other multi-chip modules into a modular computing system.

Inference and/or training logic 815 are used to perform inferencing and/or training operations associated with one or more embodiments. In at least one embodiment, inference and/or training logic 815 may be used in system FIG. 15 for inferencing or predicting operations based, at least in part, on weight parameters calculated using neural network training operations, neural network functions and/or architectures, or neural network use cases described herein.

Embodiments presented herein can provide for the automated matching of landmarks in tracks of sensor data.

### Processors

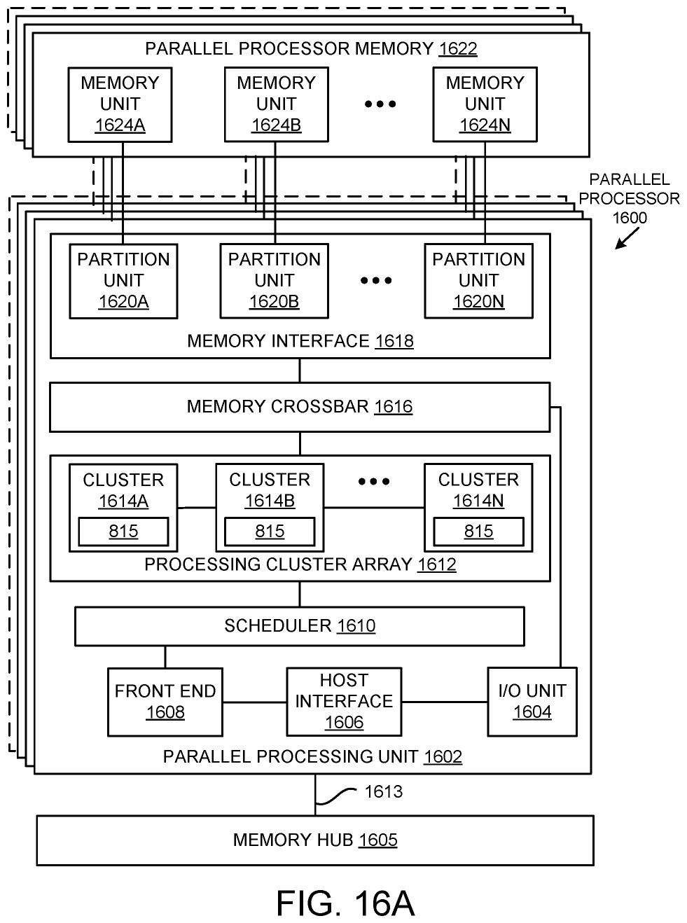

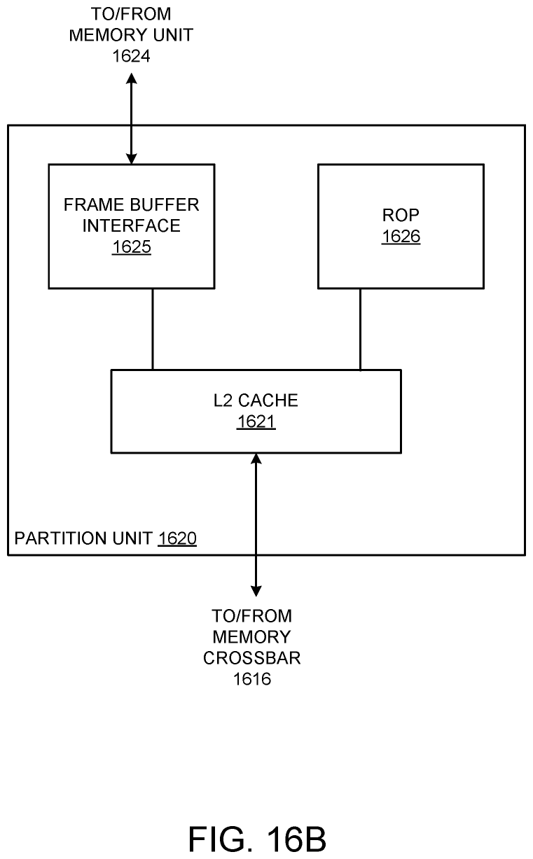

FIG. 16A illustrates a parallel processor 1600 according to at least one embodiment. In at least one embodiment, various components of parallel processor 1600 may be implemented using one or more integrated circuit devices, such as programmable processors, application specific integrated circuits (ASICs), or field programmable gate arrays (FPGA). In at least one embodiment, illustrated parallel processor 1600 is a variant of one or more parallel processor(s) 1512 shown in FIG. 15 according to an exemplary embodiment. In at least one embodiment, a parallel processor 1600 includes one or more graphics cores 1500.

In at least one embodiment, parallel processor 1600 includes a parallel processing unit 1602. In at least one embodiment, parallel processing unit 1602 includes an I/O unit 1604 that enables communication with other devices, including other instances of parallel processing unit 1602. In at least one embodiment, I/O unit 1604 may be directly connected to other devices. In at least one embodiment, I/O unit 1604 connects with other devices via use of a hub or switch interface, such as a memory hub 1605. In at least one embodiment, connections between memory hub 1605 and I/O unit 1604 form a communication link 1613. In at least one embodiment, I/O unit 1604 connects with a host interface 1606 and a memory crossbar 1616, where host interface 1606 receives commands directed to performing processing operations and memory crossbar 1616 receives commands directed to performing memory operations.

In at least one embodiment, when host interface 1606 receives a command buffer via I/O unit 1604, host interface 1606 can direct work operations to perform those commands to a front end 1608. In at least one embodiment, front end 1608 couples with a scheduler 1610 (which may be referred to as a sequencer), which is configured to distribute commands or other work items to a processing cluster array 1612. In at least one embodiment, scheduler 1610 ensures that processing cluster array 1612 is properly configured and in a valid state before tasks are distributed to a cluster of processing cluster array 1612. In at least one embodiment, scheduler 1610 is implemented via firmware logic executing on a microcontroller. In at least one embodiment, microcontroller implemented scheduler 1610 is configurable to perform complex scheduling and work distribution operations at coarse and fine granularity, enabling rapid preemption and context switching of threads executing on processing array 1612. In at least one embodiment, host software can prove workloads for scheduling on processing cluster array 1612 via one of multiple graphics processing paths. In at least one embodiment, workloads can then be automatically distributed across processing array cluster 1612 by scheduler 1610 logic within a microcontroller including scheduler 1610.

In at least one embodiment, processing cluster array 1612 can include up to “N” processing clusters (e.g., cluster 1614A, cluster 1614B, through cluster 1614N), where “N” represents a positive integer (which may be a different integer “N” than used in other figures). In at least one embodiment, each cluster 1614A-1614N of processing cluster array 1612 can execute a large number of concurrent threads. In at least one embodiment, scheduler 1610 can allocate work to clusters 1614A-1614N of processing cluster array 1612 using various scheduling and/or work distribution algorithms, which may vary depending on workload arising for each type of program or computation. In at least one embodiment, scheduling can be handled dynamically by scheduler 1610, or can be assisted in part by compiler logic during compilation of program logic configured for execution by processing cluster array 1612. In at least one embodiment, different clusters 1614A-1614N of processing cluster array 1612 can be allocated for processing different types of programs or for performing different types of computations.

In at least one embodiment, processing cluster array 1612 can be configured to perform various types of parallel processing operations. In at least one embodiment, processing cluster array 1612 is configured to perform general-purpose parallel compute operations. For example, in at least one embodiment, processing cluster array 1612 can include logic to execute processing tasks including filtering of video and/or audio data, performing modeling operations, including physics operations, and performing data transformations.

In at least one embodiment, processing cluster array 1612 is configured to perform parallel graphics processing operations. In at least one embodiment, processing cluster array 1612 can include additional logic to support execution of such graphics processing operations, including but not limited to, texture sampling logic to perform texture operations, as well as tessellation logic and other vertex processing logic. In at least one embodiment, processing cluster array 1612 can be configured to execute graphics processing related shader programs such as but not limited to, vertex shaders, tessellation shaders, geometry shaders, and pixel shaders. In at least one embodiment, parallel processing unit 1602 can transfer data from system memory via I/O unit 1604 for processing. In at least one embodiment, during processing, transferred data can be stored to on-chip memory (e.g., parallel processor memory 1622) during processing, then written back to system memory.

In at least one embodiment, when parallel processing unit 1602 is used to perform graphics processing, scheduler 1610 can be configured to divide a processing workload into approximately equal sized tasks, to better enable distribution of graphics processing operations to multiple clusters 1614A-1614N of processing cluster array 1612. In at least one embodiment, portions of processing cluster array 1612 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1614A-1614N may be stored in buffers to allow intermediate data to be transmitted between clusters 1614A-1614N for further processing.

In at least one embodiment, processing cluster array 1612 can receive processing tasks to be executed via scheduler 1610, which receives commands defining processing tasks from front end 1608. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1610 may be configured to fetch indices corresponding to tasks or may receive indices from front end 1608. In at least one embodiment, front end 1608 can be configured to ensure processing cluster array 1612 is configured to a valid state before a workload specified by incoming command buffers (e.g., batch-buffers, push buffers, etc.) is initiated.

In at least one embodiment, each of one or more instances of parallel processing unit 1602 can couple with a parallel processor memory 1622. In at least one embodiment, parallel processor memory 1622 can be accessed via memory crossbar 1616, which can receive memory requests from processing cluster array 1612 as well as I/O unit 1604. In at least one embodiment, memory crossbar 1616 can access parallel processor memory 1622 via a memory interface 1618. In at least one embodiment, memory interface 1618 can include multiple partition units (e.g., partition unit 1620A, partition unit 1620B, through partition unit 1620N) that can each couple to a portion (e.g., memory unit) of parallel processor memory 1622. In at least one embodiment, a number of partition units 1620A-1620N is configured to be equal to a number of memory units, such that a first partition unit 1620A has a corresponding first memory unit 1624A, a second partition unit 1620B has a corresponding memory unit 1624B, and an N-th partition unit 1620N has a corresponding N-th memory unit 1624N. In at least one embodiment, a number of partition units 1620A-1620N may not be equal to a number of memory units.

In at least one embodiment, memory units 1624A-1624N can include various types of memory devices, including dynamic random access memory (DRAM) or graphics random access memory, such as synchronous graphics random access memory (SGRAM), including graphics double data rate (GDDR) memory. In at least one embodiment, memory units 1624A-1624N may also include 3D stacked memory, including but not limited to high bandwidth memory (HBM), HBM2c, or HDM3. In at least one embodiment, render targets, such as frame buffers or texture maps may be stored across memory units 1624A-1624N, allowing partition units 1620A-1620N to write portions of each render target in parallel to efficiently use available bandwidth of parallel processor memory 1622. In at least one embodiment, a local instance of parallel processor memory 1622 may be excluded in favor of a unified memory design that utilizes system memory in conjunction with local cache memory.

In at least one embodiment, any one of clusters 1614A-1614N of processing cluster array 1612 can process data that will be written to any of memory units 1624A-1624N within parallel processor memory 1622. In at least one embodiment, memory crossbar 1616 can be configured to transfer an output of each cluster 1614A-1614N to any partition unit 1620A-1620N or to another cluster 1614A-1614N, which can perform additional processing operations on an output. In at least one embodiment, each cluster 1614A-1614N can communicate with memory interface 1618 through memory crossbar 1616 to read from or write to various external memory devices. In at least one embodiment, memory crossbar 1616 has a connection to memory interface 1618 to communicate with I/O unit 1604, as well as a connection to a local instance of parallel processor memory 1622, enabling processing units within different processing clusters 1614A-1614N to communicate with system memory or other memory that is not local to parallel processing unit 1602. In at least one embodiment, memory crossbar 1616 can use virtual channels to separate traffic streams between clusters 1614A-1614N and partition units 1620A-1620N.

In at least one embodiment, multiple instances of parallel processing unit 1602 can be provided on a single add-in card, or multiple add-in cards can be interconnected. In at least one embodiment, different instances of parallel processing unit 1602 can be configured to interoperate even if different instances have different numbers of processing cores, different amounts of local parallel processor memory, and/or other configuration differences. For example, in at least one embodiment, some instances of parallel processing unit 1602 can include higher precision floating point units relative to other instances. In at least one embodiment, systems incorporating one or more instances of parallel processing unit 1602 or parallel processor 1600 can be implemented in a variety of configurations and form factors, including but not limited to desktop, laptop, or handheld personal computers, servers, workstations, game consoles, and/or embedded systems.

FIG. 16B is a block diagram of a partition unit 1620 according to at least one embodiment. In at least one embodiment, partition unit 1620 is an instance of one of partition units 1620A-1620N of FIG. 16A. In at least one embodiment, partition unit 1620 includes an L2 cache 1621, a frame buffer interface 1625, and a ROP 1626 (raster operations unit). In at least one embodiment, L2 cache 1621 is a read/write cache that is configured to perform load and store operations received from memory crossbar 1616 and ROP 1626. In at least one embodiment, read misses and urgent write-back requests are output by L2 cache 1621 to frame buffer interface 1625 for processing. In at least one embodiment, updates can also be sent to a frame buffer via frame buffer interface 1625 for processing. In at least one embodiment, frame buffer interface 1625 interfaces with one of memory units in parallel processor memory, such as memory units 1624A-1624N of FIG. 16A (e.g., within parallel processor memory 1622).

In at least one embodiment, ROP 1626 is a processing unit that performs raster operations such as stencil, z test, blending, etc. In at least one embodiment, ROP 1626 then outputs processed graphics data that is stored in graphics memory. In at least one embodiment, ROP 1626 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1626 can vary based on statistical characteristics of data to be compressed. For example, in at least one embodiment, delta color compression is performed on depth and color data on a per-tile basis.

In at least one embodiment, ROP 1626 is included within each processing cluster (e.g., cluster 1614A-1614N of FIG. 16A) instead of within partition unit 1620. In at least one embodiment, read and write requests for pixel data are transmitted over memory crossbar 1616 instead of pixel fragment data. In at least one embodiment, processed graphics data may be displayed on a display device, such as one of one or more display device(s) 1510 of FIG. 15, routed for further processing by processor(s) 1602, or routed for further processing by one of processing entities within parallel processor 1600 of FIG. 16A.

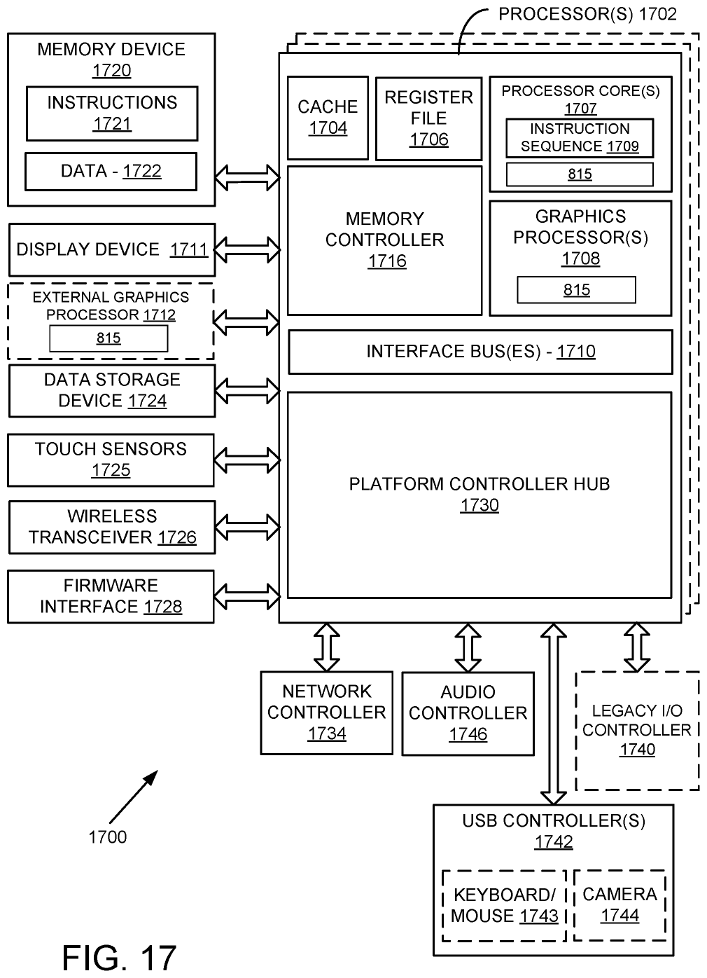

FIG. 17 is a block diagram of a processing system, according to at least one embodiment. In at least one embodiment, system 1700 includes one or more processor(s) 1702 and one or more graphics processor(s) 1708, and may be a single processor desktop system, a multiprocessor workstation system, or a server system having a large number of processor(s) 1702 or processor core(s) 1707. In at least one embodiment, system 1700 is a processing platform incorporated within a system-on-a-chip (SoC) integrated circuit for use in mobile, handheld, or embedded devices. In at least one embodiment, one or more graphics processor(s) 1708 include one or more graphics cores 1500.

In at least one embodiment, system 1700 can include, or be incorporated within a server-based gaming platform, a game console, including a game and media console, a mobile gaming console, a handheld game console, or an online game console. In at least one embodiment, system 1700 is a mobile phone, a smart phone, a tablet computing device or a mobile Internet device. In at least one embodiment, processing system 1700 can also include, couple with, or be integrated within a wearable device, such as a smart watch wearable device, a smart eyewear device, an augmented reality device, or a virtual reality device. In at least one embodiment, processing system 1700 is a television or set top box device having one or more processor(s) 1702 and a graphical interface generated by one or more graphics processor(s) 1708.

In at least one embodiment, one or more processor(s) 1702 each include one or more processor core(s) 1707 to process instructions which, when executed, perform operations for system and user software. In at least one embodiment, each of one or more processor core(s) 1707 is configured to process a specific instruction sequence 1709. In at least one embodiment, instruction sequence 1709 may facilitate Complex Instruction Set Computing (CISC), Reduced Instruction Set Computing (RISC), or computing via a Very Long Instruction Word (VLIW). In at least one embodiment, processor core(s) 1707 may each process a different instruction sequence 1709, which may include instructions to facilitate emulation of other instruction sequences. In at least one embodiment, processor core(s) 1707 may also include other processing devices, such a Digital Signal Processor (DSP).

In at least one embodiment, processor(s) 1702 includes a cache memory 1704. In at least one embodiment, processor(s) 1702 can have a single internal cache or multiple levels of internal cache. In at least one embodiment, cache memory is shared among various components of processor(s) 1702. In at least one embodiment, processor(s) 1702 also uses an external cache (e.g., a Level-3 (L3) cache or Last Level Cache (LLC)) (not shown), which may be shared among processor core(s) 1707 using known cache coherency techniques. In at least one embodiment, a register file 1706 is additionally included in processor(s) 1702, which may include different types of registers for storing different types of data (e.g., integer registers, floating point registers, status registers, and an instruction pointer register). In at least one embodiment, register file 1706 may include general-purpose registers or other registers.

In at least one embodiment, one or more processor(s) 1702 are coupled with one or more interface bus(es) 1710 to transmit communication signals such as address, data, or control signals between processor(s) 1702 and other components in system 1700. In at least one embodiment, interface bus(es) 1710 can be a processor bus, such as a version of a Direct Media Interface (DMI) bus. In at least one embodiment, interface bus(es) 1710 is not limited to a DMI bus, and may include one or more Peripheral Component Interconnect buses (e.g., PCI, PCI Express), memory busses, or other types of interface busses. In at least one embodiment processor(s) 1702 include an integrated memory controller 1716 and a platform controller hub 1730. In at least one embodiment, memory controller 1716 facilitates communication between a memory device and other components of system 1700, while platform controller hub (PCH) 1730 provides connections to I/O devices via a local I/O bus.

In at least one embodiment, a memory device 1720 can be a dynamic random access memory (DRAM) device, a static random access memory (SRAM) device, flash memory device, phase-change memory device, or some other memory device having suitable performance to serve as process memory. In at least one embodiment, memory device 1720 can operate as system memory for system 1700, to store data 1722 and instructions 1721 for use when one or more processor(s) 1702 executes an application or process. In at least one embodiment, memory controller 1716 also couples with an optional external graphics processor 1712, which may communicate with one or more graphics processor(s) 1708 in processor(s) 1702 to perform graphics and media operations. In at least one embodiment, a display device 1711 can connect to processor(s) 1702. In at least one embodiment, display device 1711 can include one or more of an internal display device, as in a mobile electronic device or a laptop device, or an external display device attached via a display interface (e.g., DisplayPort, etc.). In at least one embodiment, display device 1711 can include a head mounted display (HMD) such as a stereoscopic display device for use in virtual reality (VR) applications or augmented reality (AR) applications.

In at least one embodiment, platform controller hub 1730 enables peripherals to connect to memory device 1720 and processor(s) 1702 via a high-speed I/O bus. In at least one embodiment, I/O peripherals include, but are not limited to, an audio controller 1746, a network controller 1734, a firmware interface 1728, a wireless transceiver 1726, touch sensors 1725, a data storage device 1724 (e.g., hard disk drive, flash memory, etc.). In at least one embodiment, data storage device 1724 can connect via a storage interface (e.g., SATA) or via a peripheral bus, such as a Peripheral Component Interconnect bus (e.g., PCI, PCI Express). In at least one embodiment, touch sensors 1725 can include touch screen sensors, pressure sensors, or fingerprint sensors. In at least one embodiment, wireless transceiver 1726 can be a Wi-Fi transceiver, a Bluetooth transceiver, or a mobile network transceiver such as a 3G, 4G, or Long Term Evolution (LTE) transceiver. In at least one embodiment, firmware interface 1728 enables communication with system firmware, and can be, for example, a unified extensible firmware interface (UEFI). In at least one embodiment, network controller 1734 can enable a network connection to a wired network. In at least one embodiment, a high-performance network controller (not shown) couples with interface bus(es) 1710. In at least one embodiment, audio controller 1746 is a multi-channel high definition audio controller. In at least one embodiment, system 1700 includes an optional legacy I/O controller 1740 for coupling legacy (e.g., Personal System 2 (PS/2)) devices to system 1700. In at least one embodiment, platform controller hub 1730 can also connect to one or more Universal Serial Bus (USB) controller(s) 1742 connect input devices, such as keyboard and mouse 1743 combinations, a camera 1744, or other USB input devices.

In at least one embodiment, an instance of memory controller 1716 and platform controller hub 1730 may be integrated into a discreet external graphics processor, such as external graphics processor 1712. In at least one embodiment, platform controller hub 1730 and/or memory controller 1716 may be external to one or more processor(s) 1702. For example, in at least one embodiment, system 1700 can include an external memory controller 1716 and platform controller hub 1730, which may be configured as a memory controller hub and peripheral controller hub within a system chipset that is in communication with processor(s) 1702.

Embodiments presented herein can provide for the automated matching of landmarks in tracks of sensor data.

### Autonomous Vehicle

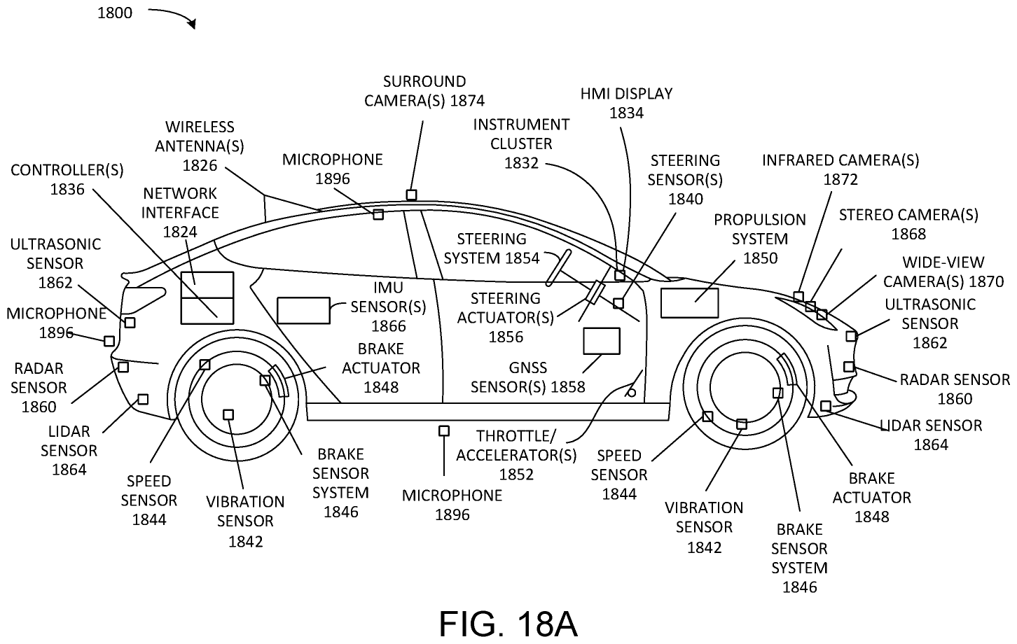

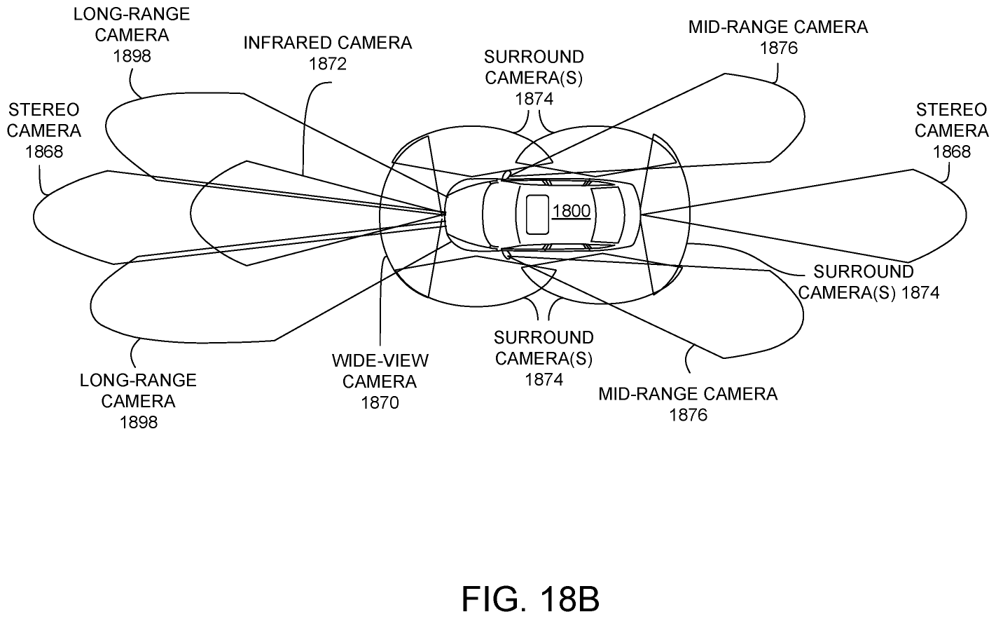

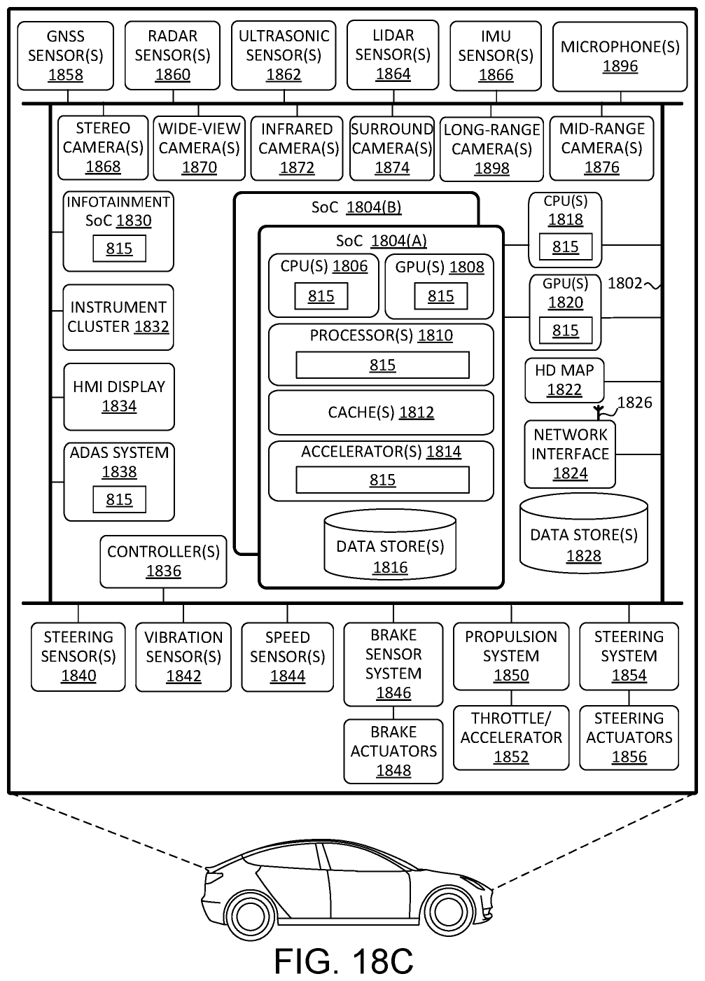

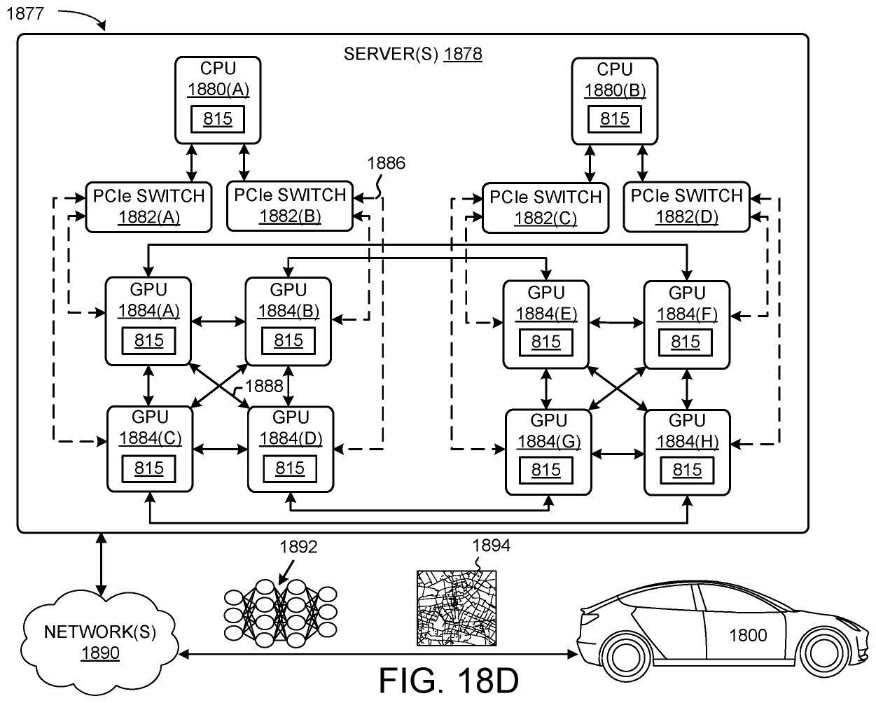

FIG. 18A illustrates an example of an autonomous vehicle 1800, according to at least one embodiment. In at least one embodiment, autonomous vehicle 1800 (alternatively referred to herein as “vehicle 1800”) may be, without limitation, a passenger vehicle, such as a car, a truck, a bus, and/or another type of vehicle that accommodates one or more passengers. In at least one embodiment, vehicle 1800 may be a semi-tractor-trailer truck used for hauling cargo. In at least one embodiment, vehicle 1800 may be an airplane, robotic vehicle, or other kind of vehicle.

Autonomous vehicles may be described in terms of automation levels, defined by National Highway Traffic Safety Administration (“NHTSA”), a division of US Department of Transportation, and Society of Automotive Engineers (“SAE”) “Taxonomy and Definitions for Terms Related to Driving Automation Systems for On-Road Motor Vehicles” (e.g., Standard No. J3016-201806, published on Jun. 15, 2018, Standard No. J3016-201609, published on Sep. 30, 2016, and previous and future versions of this standard). In at least one embodiment, vehicle 1800 may be capable of functionality in accordance with one or more of Level 1 through Level 5 of autonomous driving levels. For example, in at least one embodiment, vehicle 1800 may be capable of conditional automation (Level 3), high automation (Level 4), and/or full automation (Level 5), depending on embodiment.

In at least one embodiment, vehicle 1800 may include, without limitation, components such as a chassis, a vehicle body, wheels (e.g., 2, 4, 6, 8, 18, etc.), tires, axles, and other components of a vehicle. In at least one embodiment, vehicle 1800 may include, without limitation, a propulsion system 1850, such as an internal combustion engine, hybrid electric power plant, an all-electric engine, and/or another propulsion system type. In at least one embodiment, propulsion system 1850 may be connected to a drive train of vehicle 1800, which may include, without limitation, a transmission, to enable propulsion of vehicle 1800. In at least one embodiment, propulsion system 1850 may be controlled in response to receiving signals from a throttle/accelerator(s) 1852.

In at least one embodiment, a steering system 1854, which may include, without limitation, a steering wheel, is used to steer vehicle 1800 (e.g., along a desired path or route) when propulsion system 1850 is operating (e.g., when vehicle 1800 is in motion). In at least one embodiment, steering system 1854 may receive signals from steering actuator(s) 1856. In at least one embodiment, a steering wheel may be optional for full automation (Level 5) functionality. In at least one embodiment, a brake sensor system 1846 may be used to operate vehicle brakes in response to receiving signals from brake actuator(s) 1848 and/or brake sensors.

In at least one embodiment, controller(s) 1836, which may include, without limitation, one or more system on chips (“SoCs”) (not shown in FIG. 18A) and/or graphics processing unit(s) (“GPU(s)”), provide signals (e.g., representative of commands) to one or more components and/or systems of vehicle 1800. For instance, in at least one embodiment, controller(s) 1836 may send signals to operate vehicle brakes via brake actuator(s) 1848, to operate steering system 1854 via steering actuator(s) 1856, to operate propulsion system 1850 via throttle/accelerator(s) 1852. In at least one embodiment, controller(s) 1836 may include one or more onboard (e.g., integrated) computing devices that process sensor signals, and output operation commands (e.g., signals representing commands) to enable autonomous driving and/or to assist a human driver in driving vehicle 1800. In at least one embodiment, controller(s) 1836 may include a first controller for autonomous driving functions, a second controller for functional safety functions, a third controller for artificial intelligence functionality (e.g., computer vision), a fourth controller for infotainment functionality, a fifth controller for redundancy in emergency conditions, and/or other controllers. In at least one embodiment, a single controller may handle two or more of above functionalities, two or more controllers may handle a single functionality, and/or any combination thereof.

In at least one embodiment, controller(s) 1836 provide signals for controlling one or more components and/or systems of vehicle 1800 in response to sensor data received from one or more sensors (e.g., sensor inputs). In at least one embodiment, sensor data may be received from, for example and without limitation, global navigation satellite systems (“GNSS”) sensor(s) 1858 (e.g., Global Positioning System sensor(s)), RADAR sensor(s) 1860, ultrasonic sensor(s) 1862, LIDAR sensor(s) 1864, inertial measurement unit (“IMU”) sensor(s) 1866 (e.g., accelerometer(s), gyroscope(s), a magnetic compass or magnetic compasses, magnetometer(s), etc.), microphone(s) 1896, stereo camera(s) 1868, wide-view camera(s) 1870 (e.g., fisheye cameras), infrared camera(s) 1872, surround camera(s) 1874 (e.g., 360 degree cameras), long-range cameras (not shown in FIG. 18A), mid-range camera(s) (not shown in FIG. 18A), speed sensor(s) 1844 (e.g., for measuring speed of vehicle 1800), vibration sensor(s) 1842, steering sensor(s) 1840, brake sensor(s) (e.g., as part of brake sensor system 1846), and/or other sensor types.

In at least one embodiment, one or more of controller(s) 1836 may receive inputs (e.g., represented by input data) from an instrument cluster 1832 of vehicle 1800 and provide outputs (e.g., represented by output data, display data, etc.) via a human-machine interface (“HMI”) display 1834, an audible annunciator, a loudspeaker, and/or via other components of vehicle 1800. In at least one embodiment, outputs may include information such as vehicle velocity, speed, time, map data (e.g., a High Definition map (not shown in FIG. 18A)), location data (e.g., vehicle's 1800 location, such as on a map), direction, location of other vehicles (e.g., an occupancy grid), information about objects and status of objects as perceived by controller(s) 1836, etc. For example, in at least one embodiment, HMI display 1834 may display information about presence of one or more objects (e.g., a street sign, caution sign, traffic light changing, etc.), and/or information about driving maneuvers vehicle has made, is making, or will make (e.g., changing lanes now, taking exit 34B in two miles, etc.).

In at least one embodiment, vehicle 1800 further includes a network interface 1824 which may use wireless antenna(s) 1826 and/or modem(s) to communicate over one or more networks. For example, in at least one embodiment, network interface 1824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”) networks, etc. In at least one embodiment, wireless antenna(s) 1826 may also enable communication between objects in environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc. protocols.

Inference and/or training logic 815 are used to perform inferencing and/or training operations associated with one or more embodiments. In at least one embodiment, inference and/or training logic 815 may be used in system FIG. 18A for inferencing or predicting operations based, at least in part, on weight parameters calculated using neural network training operations, neural network functions and/or architectures, or neural network use cases described herein.

Such components can be used to generate a single, consistent tokenized description of at least a portion of a physical environment based in part on a set of observations and aligned map data.

FIG. 18B illustrates an example of camera locations and fields of view for autonomous vehicle 1800 of FIG. 18A, according to at least one embodiment. In at least one embodiment, cameras and respective fields of view are one example embodiment and are not intended to be limiting. For instance, in at least one embodiment, additional and/or alternative cameras may be included and/or cameras may be located at different locations on vehicle 1800.

In at least one embodiment, camera types for cameras may include, but are not limited to, digital cameras that may be adapted for use with components and/or systems of vehicle 1800. In at least one embodiment, camera(s) may operate at automotive safety integrity level (“ASIL”) B and/or at another ASIL. In at least one embodiment, camera types may be capable of any image capture rate, such as 60 frames per second (fps), 1220 fps, 240 fps, etc., depending on embodiment. In at least one embodiment, cameras may be capable of using rolling shutters, global shutters, another type of shutter, or a combination thereof. In at least one embodiment, color filter array may include a red clear clear clear (“RCCC”) color filter array, a red clear clear blue (“RCCB”) color filter array, a red blue green clear (“RBGC”) color filter array, a Foveon X3 color filter array, a Bayer sensors (“RGGB”) color filter array, a monochrome sensor color filter array, and/or another type of color filter array. In at least one embodiment, clear pixel cameras, such as cameras with an RCCC, an RCCB, and/or an RBGC color filter array, may be used in an effort to increase light sensitivity.

In at least one embodiment, one or more of camera(s) may be used to perform advanced driver assistance systems (“ADAS”) functions (e.g., as part of a redundant or fail-safe design). For example, in at least one embodiment, a Multi-Function Mono Camera may be installed to provide functions including lane departure warning, traffic sign assist and intelligent headlamp control. In at least one embodiment, one or more of camera(s) (e.g., all cameras) may record and provide image data (e.g., video) simultaneously.

In at least one embodiment, one or more camera may be mounted in a mounting assembly, such as a custom designed (three-dimensional (“3D”) printed) assembly, in order to cut out stray light and reflections from within vehicle 1800 (e.g., reflections from dashboard reflected in windshield mirrors) which may interfere with camera image data capture abilities. With reference to wing-mirror mounting assemblies, in at least one embodiment, wing-mirror assemblies may be custom 3D printed so that a camera mounting plate matches a shape of a wing-mirror. In at least one embodiment, camera(s) may be integrated into wing-mirrors. In at least one embodiment, for side-view cameras, camera(s) may also be integrated within four pillars at each corner of a cabin.

In at least one embodiment, cameras with a field of view that include portions of an environment in front of vehicle 1800 (e.g., front-facing cameras) may be used for surround view, to help identify forward facing paths and obstacles, as well as aid in, with help of one or more of controller(s) 1836 and/or control SoCs, providing information critical to generating an occupancy grid and/or determining preferred vehicle paths. In at least one embodiment, front-facing cameras may be used to perform many similar ADAS functions as LIDAR, including, without limitation, emergency braking, pedestrian detection, and collision avoidance. In at least one embodiment, front-facing cameras may also be used for ADAS functions and systems including, without limitation, Lane Departure Warnings (“LDW”), Autonomous Cruise Control (“ACC”), and/or other functions such as traffic sign recognition.

In at least one embodiment, a variety of cameras may be used in a front-facing configuration, including, for example, a monocular camera platform that includes a CMOS (“complementary metal oxide semiconductor”) color imager. In at least one embodiment, a wide-view camera 1870 may be used to perceive objects coming into view from a periphery (e.g., pedestrians, crossing traffic or bicycles). Although only one wide-view camera 1870 is illustrated in FIG. 18B, in other embodiments, there may be any number (including zero) wide-view cameras on vehicle 1800. In at least one embodiment, any number of long-range camera(s) 1898 (e.g., a long-view stereo camera pair) may be used for depth-based object detection, especially for objects for which a neural network has not yet been trained. In at least one embodiment, long-range camera(s) 1898 may also be used for object detection and classification, as well as basic object tracking.

In at least one embodiment, any number of stereo camera(s) 1868 may also be included in a front-facing configuration. In at least one embodiment, one or more of stereo camera(s) 1868 may include an integrated control unit comprising a scalable processing unit, which may provide a programmable logic (“FPGA”) and a multi-core micro-processor with an integrated Controller Area Network (“CAN”) or Ethernet interface on a single chip. In at least one embodiment, such a unit may be used to generate a 3D map of an environment of vehicle 1800, including a distance estimate for all points in an image. In at least one embodiment, one or more of stereo camera(s) 1868 may include, without limitation, compact stereo vision sensor(s) that may include, without limitation, two camera lenses (one each on left and right) and an image processing chip that may measure distance from vehicle 1800 to target object and use generated information (e.g., metadata) to activate autonomous emergency braking and lane departure warning functions. In at least one embodiment, other types of stereo camera(s) 1868 may be used in addition to, or alternatively from, those described herein.

In at least one embodiment, cameras with a field of view that include portions of environment to sides of vehicle 1800 (e.g., side-view cameras) may be used for surround view, providing information used to create and update an occupancy grid, as well as to generate side impact collision warnings. For example, in at least one embodiment, surround camera(s) 1874 (e.g., four surround cameras as illustrated in FIG. 18B) could be positioned on vehicle 1800. In at least one embodiment, surround camera(s) 1874 may include, without limitation, any number and combination of wide-view cameras, fisheye camera(s), 360 degree camera(s), and/or similar cameras. For instance, in at least one embodiment, four fisheye cameras may be positioned on a front, a rear, and sides of vehicle 1800. In at least one embodiment, vehicle 1800 may use three surround camera(s) 1874 (e.g., left, right, and rear), and may leverage one or more other camera(s) (e.g., a forward-facing camera) as a fourth surround-view camera.

In at least one embodiment, cameras with a field of view that include portions of an environment behind vehicle 1800 (e.g., rear-view cameras) may be used for parking assistance, surround view, rear collision warnings, and creating and updating an occupancy grid. In at least one embodiment, a wide variety of cameras may be used including, but not limited to, cameras that are also suitable as a front-facing camera(s) (e.g., long-range camera(s) 1898 and/or mid-range camera(s) 1876, stereo camera(s) 1868, infrared camera(s) 1872, etc.,) as described herein.

Inference and/or training logic 815 are used to perform inferencing and/or training operations associated with one or more embodiments. In at least one embodiment, inference and/or training logic 815 may be used in system FIG. 18B for inferencing or predicting operations based, at least in part, on weight parameters calculated using neural network training operations, neural network functions and/or architectures, or neural network use cases described herein.

Such components can be used to generate a single, consistent tokenized description of at least a portion of a physical environment based in part on a set of observations and aligned map data.

FIG. 18C is a block diagram illustrating an example system architecture for autonomous vehicle 1800 of FIG. 18A, according to at least one embodiment. In at least one embodiment, each of components, features, and systems of vehicle 1800 in FIG. 18C is illustrated as being connected via a bus 1802. In at least one embodiment, bus 1802 may include, without limitation, a CAN data interface (alternatively referred to herein as a “CAN bus”). In at least one embodiment, a CAN may be a network inside vehicle 1800 used to aid in control of various features and functionality of vehicle 1800, such as actuation of brakes, acceleration, braking, steering, windshield wipers, etc. In at least one embodiment, bus 1802 may be configured to have dozens or even hundreds of nodes, each with its own unique identifier (e.g., a CAN ID). In at least one embodiment, bus 1802 may be read to find steering wheel angle, ground speed, engine revolutions per minute (“RPMs”), button positions, and/or other vehicle status indicators. In at least one embodiment, bus 1802 may be a CAN bus that is ASIL B compliant.

In at least one embodiment, in addition to, or alternatively from CAN, FlexRay and/or Ethernet protocols may be used. In at least one embodiment, there may be any number of busses forming bus 1802, which may include, without limitation, zero or more CAN busses, zero or more FlexRay busses, zero or more Ethernet busses, and/or zero or more other types of busses using different protocols. In at least one embodiment, two or more busses may be used to perform different functions, and/or may be used for redundancy. For example, a first bus may be used for collision avoidance functionality and a second bus may be used for actuation control. In at least one embodiment, each bus of bus 1802 may communicate with any of components of vehicle 1800, and two or more busses of bus 1802 may communicate with corresponding components. In at least one embodiment, each of any number of system(s) on chip(s) (“SoC(s)”) 1804 (such as SoC 1804(A) and SoC 1804(B)), each of controller(s) 1836, and/or each computer within vehicle may have access to same input data (e.g., inputs from sensors of vehicle 1800), and may be connected to a common bus, such CAN bus.

In at least one embodiment, vehicle 1800 may include one or more controller(s) 1836, such as those described herein with respect to FIG. 18A. In at least one embodiment, controller(s) 1836 may be used for a variety of functions. In at least one embodiment, controller(s) 1836 may be coupled to any of various other components and systems of vehicle 1800, and may be used for control of vehicle 1800, artificial intelligence of vehicle 1800, infotainment for vehicle 1800, and/or other functions.

In at least one embodiment, vehicle 1800 may include any number of SoCs 1804. In at least one embodiment, each of SoCs 1804 may include, without limitation, central processing units (“CPU(s)”) 1806, graphics processing units (“GPU(s)”) 1808, processor(s) 1810, cache(s) 1812, accelerator(s) 1814, data store(s) 1816, and/or other components and features not illustrated. In at least one embodiment, SoC(s) 1804 may be used to control vehicle 1800 in a variety of platforms and systems. For example, in at least one embodiment, SoC(s) 1804 may be combined in a system (e.g., system of vehicle 1800) with a High Definition (“HD”) map 1822 which may obtain map refreshes and/or updates via network interface 1824 from one or more servers (not shown in FIG. 18C).

In at least one embodiment, CPU(s) 1806 may include a CPU cluster or CPU complex (alternatively referred to herein as a “CCPLEX”). In at least one embodiment, CPU(s) 1806 may include multiple cores and/or level two (“L₂”) caches. For instance, in at least one embodiment, CPU(s) 1806 may include eight cores in a coherent multi-processor configuration. In at least one embodiment, CPU(s) 1806 may include four dual-core clusters where each cluster has a dedicated L₂ cache (e.g., a 2 megabyte (MB) L₂ cache). In at least one embodiment, CPU(s) 1806 (e.g., CCPLEX) may be configured to support simultaneous cluster operations enabling any combination of clusters of CPU(s) 1806 to be active at any given time.

In at least one embodiment, one or more of CPU(s) 1806 may implement power management capabilities that include, without limitation, one or more of following features: individual hardware blocks may be clock-gated automatically when idle to save dynamic power; each core clock may be gated when such core is not actively executing instructions due to execution of Wait for Interrupt (“WFI”)/Wait for Event (“WFE”) instructions; each core may be independently power-gated; each core cluster may be independently clock-gated when all cores are clock-gated or power-gated; and/or each core cluster may be independently power-gated when all cores are power-gated. In at least one embodiment, CPU(s) 1806 may further implement an enhanced algorithm for managing power states, where allowed power states and expected wakeup times are specified, and hardware/microcode determines which best power state to enter for core, cluster, and CCPLEX. In at least one embodiment, processing cores may support simplified power state entry sequences in software with work offloaded to microcode.

In at least one embodiment, GPU(s) 1808 may include an integrated GPU (alternatively referred to herein as an “iGPU”). In at least one embodiment, GPU(s) 1808 may be programmable and may be efficient for parallel workloads. In at least one embodiment, GPU(s) 1808 may use an enhanced tensor instruction set. In at least one embodiment, GPU(s) 1808 may include one or more streaming microprocessors, where each streaming microprocessor may include a level one (“L₁”) cache (e.g., an L₁ cache with at least 96 KB storage capacity), and two or more streaming microprocessors may share an L₂ cache (e.g., an L₂ cache with a 512 KB storage capacity). In at least one embodiment, GPU(s) 1808 may include at least eight streaming microprocessors. In at least one embodiment, GPU(s) 1808 may use compute application programming interface(s) (API(s)). In at least one embodiment, GPU(s) 1808 may use one or more parallel computing platforms and/or programming models (e.g., NVIDIA's CUDA model).

In at least one embodiment, one or more of GPU(s) 1808 may be power-optimized for best performance in automotive and embedded use cases. For example, in at least one embodiment, GPU(s) 1808 could be fabricated on Fin field-effect transistor (“FinFET”) circuitry. In at least one embodiment, each streaming microprocessor may incorporate a number of mixed-precision processing cores partitioned into multiple blocks. For example, and without limitation, 64 PF32 cores and 32 PF64 cores could be partitioned into four processing blocks. In at least one embodiment, each processing block could be allocated 16 FP32 cores, 8 FP64 cores, 16 INT32 cores, two mixed-precision NVIDIA Tensor cores for deep learning matrix arithmetic, a level zero (“L0”) instruction cache, a scheduler (e.g., warp scheduler) or sequencer, a dispatch unit, and/or a 64 KB register file. In at least one embodiment, streaming microprocessors may include independent parallel integer and floating-point data paths to provide for efficient execution of workloads with a mix of computation and addressing calculations. In at least one embodiment, streaming microprocessors may include independent thread scheduling capability to enable finer-grain synchronization and cooperation between parallel threads. In at least one embodiment, streaming microprocessors may include a combined L₁ data cache and shared memory unit in order to improve performance while simplifying programming.

In at least one embodiment, one or more of GPU(s) 1808 may include a high bandwidth memory (“HBM”) and/or a 16 GB HBM2 memory subsystem to provide, in some examples, about 900 GB/second peak memory bandwidth. In at least one embodiment, in addition to, or alternatively from, HBM memory, a synchronous graphics random-access memory (“SGRAM”) may be used, such as a graphics double data rate type five synchronous random-access memory (“GDDR5”).

In at least one embodiment, GPU(s) 1808 may include unified memory technology. In at least one embodiment, address translation services (“ATS”) support may be used to allow GPU(s) 1808 to access CPU(s) 1806 page tables directly. In at least one embodiment, embodiment, when a GPU of GPU(s) 1808 memory management unit (“MMU”) experiences a miss, an address translation request may be transmitted to CPU(s) 1806. In response, 2 CPU of CPU(s) 1806 may look in its page tables for a virtual-to-physical mapping for an address and transmit translation back to GPU(s) 1808, in at least one embodiment. In at least one embodiment, unified memory technology may allow a single unified virtual address space for memory of both CPU(s) 1806 and GPU(s) 1808, thereby simplifying GPU(s) 1808 programming and porting of applications to GPU(s) 1808.

In at least one embodiment, GPU(s) 1808 may include any number of access counters that may keep track of frequency of access of GPU(s) 1808 to memory of other processors. In at least one embodiment, access counter(s) may help ensure that memory pages are moved to physical memory of a processor that is accessing pages most frequently, thereby improving efficiency for memory ranges shared between processors.

In at least one embodiment, one or more of SoC(s) 1804 may include any number of cache(s) 1812, including those described herein. For example, in at least one embodiment, cache(s) 1812 could include a level three (“L₃”) cache that is available to both CPU(s) 1806 and GPU(s) 1808 (e.g., that is connected to CPU(s) 1806 and GPU(s) 1808). In at least one embodiment, cache(s) 1812 may include a write-back cache that may keep track of states of lines, such as by using a cache coherence protocol (e.g., MEI, MESI, MSI, etc.). In at least one embodiment, a L₃ cache may include 4 MB of memory or more, depending on embodiment, although smaller cache sizes may be used.

In at least one embodiment, one or more of SoC(s) 1804 may include one or more accelerator(s) 1814 (e.g., hardware accelerators, software accelerators, or a combination thereof). In at least one embodiment, SoC(s) 1804 may include a hardware acceleration cluster that may include optimized hardware accelerators and/or large on-chip memory. In at least one embodiment, large on-chip memory (e.g., 4 MB of SRAM), may enable a hardware acceleration cluster to accelerate neural networks and other calculations. In at least one embodiment, a hardware acceleration cluster may be used to complement GPU(s) 1808 and to off-load some of tasks of GPU(s) 1808 (e.g., to free up more cycles of GPU(s) 1808 for performing other tasks). In at least one embodiment, accelerator(s) 1814 could be used for targeted workloads (e.g., perception, convolutional neural networks (“CNNs”), recurrent neural networks (“RNNs”), etc.) that are stable enough to be amenable to acceleration. In at least one embodiment, a CNN may include a region-based or regional convolutional neural networks (“RCNNs”) and Fast RCNNs (e.g., as used for object detection) or other type of CNN.

In at least one embodiment, accelerator(s) 1814 (e.g., hardware acceleration cluster) may include one or more deep learning accelerator (“DLA”). In at least one embodiment, DLA(s) may include, without limitation, one or more Tensor processing units (“TPUs”) that may be configured to provide an additional ten trillion operations per second for deep learning applications and inferencing. In at least one embodiment, TPUs may be accelerators configured to, and optimized for, performing image processing functions (e.g., for CNNs, RCNNs, etc.). In at least one embodiment, DLA(s) may further be optimized for a specific set of neural network types and floating point operations, as well as inferencing. In at least one embodiment, design of DLA(s) may provide more performance per millimeter than a typical general-purpose GPU, and typically vastly exceeds performance of a CPU. In at least one embodiment, TPU(s) may perform several functions, including a single-instance convolution function, supporting, for example, INT8, INT16, and FP16 data types for both features and weights, as well as post-processor functions. In at least one embodiment, DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

In at least one embodiment, DLA(s) may perform any function of GPU(s) 1808, and by using an inference accelerator, for example, a designer may target either DLA(s) or GPU(s) 1808 for any function. For example, in at least one embodiment, a designer may focus processing of CNNs and floating point operations on DLA(s) and leave other functions to GPU(s) 1808 and/or accelerator(s) 1814.

In at least one embodiment, accelerator(s) 1814 may include programmable vision accelerator (“PVA”), which may alternatively be referred to herein as a computer vision accelerator. In at least one embodiment, PVA may be designed and configured to accelerate computer vision algorithms for advanced driver assistance system (“ADAS”) 1838, autonomous driving, augmented reality (“AR”) applications, and/or virtual reality (“VR”) applications. In at least one embodiment, PVA may provide a balance between performance and flexibility. For example, in at least one embodiment, each PVA may include, for example and without limitation, any number of reduced instruction set computer (“RISC”) cores, direct memory access (“DMA”), and/or any number of vector processors.

In at least one embodiment, RISC cores may interact with image sensors (e.g., image sensors of any cameras described herein), image signal processor(s), etc. In at least one embodiment, each RISC core may include any amount of memory. In at least one embodiment, RISC cores may use any of a number of protocols, depending on embodiment. In at least one embodiment, RISC cores may execute a real-time operating system (“RTOS”). In at least one embodiment, RISC cores may be implemented using one or more integrated circuit devices, application specific integrated circuits (“ASICs”), and/or memory devices. For example, in at least one embodiment, RISC cores could include an instruction cache and/or a tightly coupled RAM.

In at least one embodiment, DMA may enable components of PVA to access system memory independently of CPU(s) 1806. In at least one embodiment, DMA may support any number of features used to provide optimization to a PVA including, but not limited to, supporting multi-dimensional addressing and/or circular addressing. In at least one embodiment, DMA may support up to six or more dimensions of addressing, which may include, without limitation, block width, block height, block depth, horizontal block stepping, vertical block stepping, and/or depth stepping.

In at least one embodiment, vector processors may be programmable processors that may be designed to efficiently and flexibly execute programming for computer vision algorithms and provide signal processing capabilities. In at least one embodiment, a PVA may include a PVA core and two vector processing subsystem partitions. In at least one embodiment, a PVA core may include a processor subsystem, DMA engine(s) (e.g., two DMA engines), and/or other peripherals. In at least one embodiment, a vector processing subsystem may operate as a primary processing engine of a PVA, and may include a vector processing unit (“VPU”), an instruction cache, and/or vector memory (e.g., “VMEM”). In at least one embodiment, VPU core may include a digital signal processor such as, for example, a single instruction, multiple data (“SIMD”), very long instruction word (“VLIW”) digital signal processor. In at least one embodiment, a combination of SIMD and VLIW may enhance throughput and speed.

In at least one embodiment, each of vector processors may include an instruction cache and may be coupled to dedicated memory. As a result, in at least one embodiment, each of vector processors may be configured to execute independently of other vector processors. In at least one embodiment, vector processors that are included in a particular PVA may be configured to employ data parallelism. For instance, in at least one embodiment, plurality of vector processors included in a single PVA may execute a common computer vision algorithm, but on different regions of an image. In at least one embodiment, vector processors included in a particular PVA may simultaneously execute different computer vision algorithms, on one image, or even execute different algorithms on sequential images or portions of an image. In at least one embodiment, among other things, any number of PVAs may be included in hardware acceleration cluster and any number of vector processors may be included in each PVA. In at least one embodiment, PVA may include additional error correcting code (“ECC”) memory, to enhance overall system safety.

In at least one embodiment, accelerator(s) 1814 may include a computer vision network on-chip and static random-access memory (“SRAM”), for providing a high-bandwidth, low latency SRAM for accelerator(s) 1814. In at least one embodiment, on-chip memory may include at least 4 MB SRAM, comprising, for example and without limitation, eight field-configurable memory blocks, that may be accessible by both a PVA and a DLA. In at least one embodiment, each pair of memory blocks may include an advanced peripheral bus (“APB”) interface, configuration circuitry, a controller, and a multiplexer. In at least one embodiment, any type of memory may be used. In at least one embodiment, a PVA and a DLA may access memory via a backbone that provides a PVA and a DLA with high-speed access to memory. In at least one embodiment, a backbone may include a computer vision network on-chip that interconnects a PVA and a DLA to memory (e.g., using APB).

In at least one embodiment, a computer vision network on-chip may include an interface that determines, before transmission of any control signal/address/data, that both a PVA and a DLA provide ready and valid signals. In at least one embodiment, an interface may provide for separate phases and separate channels for transmitting control signals/addresses/data, as well as burst-type communications for continuous data transfer. In at least one embodiment, an interface may comply with International Organization for Standardization (“ISO”) 26262 or International Electrotechnical Commission (“IEC”) 61508 standards, although other standards and protocols may be used.

In at least one embodiment, one or more of SoC(s) 1804 may include a real-time ray-tracing hardware accelerator. In at least one embodiment, real-time ray-tracing hardware accelerator may be used to quickly and efficiently determine positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses.

In at least one embodiment, accelerator(s) 1814 can have a wide array of uses for autonomous driving. In at least one embodiment, a PVA may be used for key processing stages in ADAS and autonomous vehicles. In at least one embodiment, a PVA's capabilities are a good match for algorithmic domains needing predictable processing, at low power and low latency. In other words, a PVA performs well on semi-dense or dense regular computation, even on small data sets, which might require predictable run-times with low latency and low power. In at least one embodiment, such as in vehicle 1800, PVAs might be designed to run classic computer vision algorithms, as they can be efficient at object detection and operating on integer math.

For example, according to at least one embodiment of technology, a PVA is used to perform computer stereo vision. In at least one embodiment, a semi-global matching-based algorithm may be used in some examples, although this is not intended to be limiting. In at least one embodiment, applications for Level 3-5 autonomous driving use motion estimation/stereo matching on-the-fly (e.g., structure from motion, pedestrian recognition, lane detection, etc.). In at least one embodiment, a PVA may perform computer stereo vision functions on inputs from two monocular cameras.

In at least one embodiment, a PVA may be used to perform dense optical flow. For example, in at least one embodiment, a PVA could process raw RADAR data (e.g., using a 4D Fast Fourier Transform) to provide processed RADAR data. In at least one embodiment, a PVA is used for time of flight depth processing, by processing raw time of flight data to provide processed time of flight data, for example.

In at least one embodiment, a DLA may be used to run any type of network to enhance control and driving safety, including for example and without limitation, a neural network that outputs a measure of confidence for each object detection. In at least one embodiment, confidence may be represented or interpreted as a probability, or as providing a relative “weight” of each detection compared to other detections. In at least one embodiment, a confidence measure enables a system to make further decisions regarding which detections should be considered as true positive detections rather than false positive detections. In at least one embodiment, a system may set a threshold value for confidence and consider only detections exceeding threshold value as true positive detections. In an embodiment in which an automatic emergency braking (“AEB”) system is used, false positive detections would cause vehicle to automatically perform emergency braking, which is obviously undesirable. In at least one embodiment, highly confident detections may be considered as triggers for AEB. In at least one embodiment, a DLA may run a neural network for regressing confidence value. In at least one embodiment, neural network may take as its input at least some subset of parameters, such as bounding box dimensions, ground plane estimate obtained (e.g., from another subsystem), output from IMU sensor(s) 1866 that correlates with vehicle 1800 orientation, distance, 3D location estimates of object obtained from neural network and/or other sensors (e.g., LIDAR sensor(s) 1864 or RADAR sensor(s) 1860), among others.

In at least one embodiment, one or more of SoC(s) 1804 may include data store(s) 1816 (e.g., memory). In at least one embodiment, data store(s) 1816 may be on-chip memory of SoC(s) 1804, which may store neural networks to be executed on GPU(s) 1808 and/or a DLA. In at least one embodiment, data store(s) 1816 may be large enough in capacity to store multiple instances of neural networks for redundancy and safety. In at least one embodiment, data store(s) 1816 may comprise L2 or L3 cache(s).

In at least one embodiment, one or more of SoC(s) 1804 may include any number of processor(s) 1810 (e.g., embedded processors). In at least one embodiment, processor(s) 1810 may include a boot and power management processor that may be a dedicated processor and subsystem to handle boot power and management functions and related security enforcement. In at least one embodiment, a boot and power management processor may be a part of a boot sequence of SoC(s) 1804 and may provide runtime power management services. In at least one embodiment, a boot power and management processor may provide clock and voltage programming, assistance in system low power state transitions, management of SoC(s) 1804 thermals and temperature sensors, and/or management of SoC(s) 1804 power states. In at least one embodiment, each temperature sensor may be implemented as a ring-oscillator whose output frequency is proportional to temperature, and SoC(s) 1804 may use ring-oscillators to detect temperatures of CPU(s) 1806, GPU(s) 1808, and/or accelerator(s) 1814. In at least one embodiment, if temperatures are determined to exceed a threshold, then a boot and power management processor may enter a temperature fault routine and put SoC(s) 1804 into a lower power state and/or put vehicle 1800 into a chauffeur to safe stop mode (e.g., bring vehicle 1800 to a safe stop).

In at least one embodiment, processor(s) 1810 may further include a set of embedded processors that may serve as an audio processing engine which may be an audio subsystem that enables full hardware support for multi-channel audio over multiple interfaces, and a broad and flexible range of audio I/O interfaces. In at least one embodiment, an audio processing engine is a dedicated processor core with a digital signal processor with dedicated RAM.

In at least one embodiment, processor(s) 1810 may further include an alwayson processor engine that may provide necessary hardware features to support low power sensor management and wake use cases. In at least one embodiment, an alwayson processor engine may include, without limitation, a processor core, a tightly coupled RAM, supporting peripherals (e.g., timers and interrupt controllers), various I/O controller peripherals, and routing logic.

In at least one embodiment, processor(s) 1810 may further include a safety cluster engine that includes, without limitation, a dedicated processor subsystem to handle safety management for automotive applications. In at least one embodiment, a safety cluster engine may include, without limitation, two or more processor cores, a tightly coupled RAM, support peripherals (e.g., timers, an interrupt controller, etc.), and/or routing logic. In a safety mode, two or more cores may operate, in at least one embodiment, in a lockstep mode and function as a single core with comparison logic to detect any differences between their operations. In at least one embodiment, processor(s) 1810 may further include a real-time camera engine that may include, without limitation, a dedicated processor subsystem for handling real-time camera management. In at least one embodiment, processor(s) 1810 may further include a high-dynamic range signal processor that may include, without limitation, an image signal processor that is a hardware engine that is part of a camera processing pipeline.

In at least one embodiment, processor(s) 1810 may include a video image compositor that may be a processing block (e.g., implemented on a microprocessor) that implements video post-processing functions needed by a video playback application to produce a final image for a player window. In at least one embodiment, a video image compositor may perform lens distortion correction on wide-view camera(s) 1870, surround camera(s) 1874, and/or on in-cabin monitoring camera sensor(s). In at least one embodiment, in-cabin monitoring camera sensor(s) are preferably monitored by a neural network running on another instance of SoC 1804, configured to identify in cabin events and respond accordingly. In at least one embodiment, an in-cabin system may perform, without limitation, lip reading to activate cellular service and place a phone call, dictate emails, change a vehicle's destination, activate or change a vehicle's infotainment system and settings, or provide voice-activated web surfing. In at least one embodiment, certain functions are available to a driver when a vehicle is operating in an autonomous mode and are disabled otherwise.

In at least one embodiment, a video image compositor may include enhanced temporal noise reduction for both spatial and temporal noise reduction. For example, in at least one embodiment, where motion occurs in a video, noise reduction weights spatial information appropriately, decreasing weights of information provided by adjacent frames. In at least one embodiment, where an image or portion of an image does not include motion, temporal noise reduction performed by video image compositor may use information from a previous image to reduce noise in a current image.

In at least one embodiment, a video image compositor may also be configured to perform stereo rectification on input stereo lens frames. In at least one embodiment, a video image compositor may further be used for user interface composition when an operating system desktop is in use, and GPU(s) 1808 are not required to continuously render new surfaces. In at least one embodiment, when GPU(s) 1808 are powered on and active doing 3D rendering, a video image compositor may be used to offload GPU(s) 1808 to improve performance and responsiveness.

In at least one embodiment, one or more SoC of SoC(s) 1804 may further include a mobile industry processor interface (“MIPI”) camera serial interface for receiving video and input from cameras, a high-speed interface, and/or a video input block that may be used for a camera and related pixel input functions. In at least one embodiment, one or more of SoC(s) 1804 may further include an input/output controller(s) that may be controlled by software and may be used for receiving I/O signals that are uncommitted to a specific role.

In at least one embodiment, one or more Soc of SoC(s) 1804 may further include a broad range of peripheral interfaces to enable communication with peripherals, audio encoders/decoders (“codecs”), power management, and/or other devices. In at least one embodiment, SoC(s) 1804 may be used to process data from cameras (e.g., connected over Gigabit Multimedia Serial Link and Ethernet channels), sensors (e.g., LIDAR sensor(s) 1864, RADAR sensor(s) 1860, etc. that may be connected over Ethernet channels), data from bus 1802 (e.g., speed of vehicle 1800, steering wheel position, etc.), data from GNSS sensor(s) 1858 (e.g., connected over a Ethernet bus or a CAN bus), etc. In at least one embodiment, one or more SoC of SoC(s) 1804 may further include dedicated high-performance mass storage controllers that may include their own DMA engines, and that may be used to free CPU(s) 1806 from routine data management tasks.

In at least one embodiment, SoC(s) 1804 may be an end-to-end platform with a flexible architecture that spans automation Levels 3-5, thereby providing a comprehensive functional safety architecture that leverages and makes efficient use of computer vision and ADAS techniques for diversity and redundancy, and provides a platform for a flexible, reliable driving software stack, along with deep learning tools. In at least one embodiment, SoC(s) 1804 may be faster, more reliable, and even more energy-efficient and space-efficient than conventional systems. For example, in at least one embodiment, accelerator(s) 1814, when combined with CPU(s) 1806, GPU(s) 1808, and data store(s) 1816, may provide for a fast, efficient platform for Level 3-5 autonomous vehicles.

In at least one embodiment, computer vision algorithms may be executed on CPUs, which may be configured using a high-level programming language, such as C, to execute a wide variety of processing algorithms across a wide variety of visual data. However, in at least one embodiment, CPUs are oftentimes unable to meet performance requirements of many computer vision applications, such as those related to execution time and power consumption, for example. In at least one embodiment, many CPUs are unable to execute complex object detection algorithms in real-time, which is used in in-vehicle ADAS applications and in practical Level 3-5 autonomous vehicles.

Embodiments described herein allow for multiple neural networks to be performed simultaneously and/or sequentially, and for results to be combined together to enable Level 3-5 autonomous driving functionality. For example, in at least one embodiment, a CNN executing on a DLA or a discrete GPU (e.g., GPU(s) 1820) may include text and word recognition, allowing reading and understanding of traffic signs, including signs for which a neural network has not been specifically trained. In at least one embodiment, a DLA may further include a

neural network that is able to identify, interpret, and provide semantic understanding of a sign, and to pass that semantic understanding to path planning modules running on a CPU Complex.

In at least one embodiment, multiple neural networks may be run simultaneously, as for Level 3, 4, or 5 driving. For example, in at least one embodiment, a warning sign stating “Caution: flashing lights indicate icy conditions,” along with an electric light, may be independently or collectively interpreted by several neural networks. In at least one embodiment, such warning sign itself may be identified as a traffic sign by a first deployed neural network (e.g., a neural network that has been trained), text “flashing lights indicate icy conditions” may be interpreted by a second deployed neural network, which informs a vehicle's path planning software (preferably executing on a CPU Complex) that when flashing lights are detected, icy conditions exist. In at least one embodiment, a flashing light may be identified by operating a third deployed neural network over multiple frames, informing a vehicle's path-planning software of a presence (or an absence) of flashing lights. In at least one embodiment, all three neural networks may run simultaneously, such as within a DLA and/or on GPU(s) 1808.

In at least one embodiment, a CNN for facial recognition and vehicle owner identification may use data from camera sensors to identify presence of an authorized driver and/or owner of vehicle 1800. In at least one embodiment, an alwayson sensor processing engine may be used to unlock a vehicle when an owner approaches a driver door and turns on lights, and, in a security mode, to disable such vehicle when an owner leaves such vehicle. In this way, SoC(s) 1804 provide for security against theft and/or carjacking.

In at least one embodiment, a CNN for emergency vehicle detection and identification may use data from microphones 1896 to detect and identify emergency vehicle sirens. In at least one embodiment, SoC(s) 1804 use a CNN for classifying environmental and urban sounds, as well as classifying visual data. In at least one embodiment, a CNN running on a DLA is trained to identify a relative closing speed of an emergency vehicle (e.g., by using a Doppler effect). In at least one embodiment, a CNN may also be trained to identify emergency vehicles specific to a local area in which a vehicle is operating, as identified by GNSS sensor(s) 1858. In at least one embodiment, when operating in Europe, a CNN will seek to detect European sirens, and when in North America, a CNN will seek to identify only North American sirens. In at least one embodiment, once an emergency vehicle is detected, a control program may be used to execute an emergency vehicle safety routine, slowing a vehicle, pulling over to a side of a road, parking a vehicle, and/or idling a vehicle, with assistance of ultrasonic sensor(s) 1862, until emergency vehicles pass.

In at least one embodiment, vehicle 1800 may include CPU(s) 1818 (e.g., discrete CPU(s), or dCPU(s)), that may be coupled to SoC(s) 1804 via a high-speed interconnect (e.g., PCIe). In at least one embodiment, CPU(s) 1818 may include an X86 processor, for example. CPU(s) 1818 may be used to perform any of a variety of functions, including arbitrating potentially inconsistent results between ADAS sensors and SoC(s) 1804, and/or monitoring status and health of controller(s) 1836 and/or an infotainment system on a chip (“infotainment SoC”) 1830, for example. In at least one embodiment, SoC(s) 1804 includes one or more interconnects, and an interconnect can include a peripheral component interconnect express (PCIc).

In at least one embodiment, vehicle 1800 may include GPU(s) 1820 (e.g., discrete GPU(s), or dGPU(s)), that may be coupled to SoC(s) 1804 via a high-speed interconnect (e.g., NVIDIA's NVLINK channel). In at least one embodiment, GPU(s) 1820 may provide additional artificial intelligence functionality, such as by executing redundant and/or different neural networks, and may be used to train and/or update neural networks based at least in part on input (e.g., sensor data) from sensors of a vehicle 1800.

In at least one embodiment, vehicle 1800 may further include network interface 1824 which may include, without limitation, wireless antenna(s) 1826 (e.g., one or more wireless antennas for different communication protocols, such as a cellular antenna, a Bluetooth antenna, etc.). In at least one embodiment, network interface 1824 may be used to enable wireless connectivity to Internet cloud services (e.g., with server(s) and/or other network devices), with other vehicles, and/or with computing devices (e.g., client devices of passengers). In at least one embodiment, to communicate with other vehicles, a direct link may be established between vehicle 1800 and another vehicle and/or an indirect link may be established (e.g., across networks and over the Internet). In at least one embodiment, direct links may be provided using a vehicle-to-vehicle communication link. In at least one embodiment, a vehicle-to-vehicle communication link may provide vehicle 1800 information about vehicles in proximity to vehicle 1800 (e.g., vehicles in front of, on a side of, and/or behind vehicle 1800). In at least one embodiment, such aforementioned functionality may be part of a cooperative adaptive cruise control functionality of vehicle 1800.

In at least one embodiment, network interface 1824 may include an SoC that provides modulation and demodulation functionality and enables controller(s) 1836 to communicate over wireless networks. In at least one embodiment, network interface 1824 may include a radio frequency front-end for up-conversion from baseband to radio frequency, and down conversion from radio frequency to baseband. In at least one embodiment, frequency conversions may be performed in any technically feasible fashion. For example, frequency conversions could be performed through well-known processes, and/or using super-heterodyne processes. In at least one embodiment, radio frequency front end functionality may be provided by a separate chip. In at least one embodiment, network interfaces may include wireless functionality for communicating over LTE, WCDMA, UMTS, GSM, CDMA2000, Bluetooth, Bluetooth LE, Wi-Fi, Z-Wave, ZigBec, LoRaWAN, and/or other wireless protocols.

In at least one embodiment, vehicle 1800 may further include data store(s) 1828 which may include, without limitation, off-chip (e.g., off SoC(s) 1804) storage. In at least one embodiment, data store(s) 1828 may include, without limitation, one or more storage elements including RAM, SRAM, dynamic random-access memory (“DRAM”), video random-access memory (“VRAM”), flash memory, hard disks, and/or other components and/or devices that may store at least one bit of data.

In at least one embodiment, vehicle 1800 may further include GNSS sensor(s) 1858 (e.g., GPS and/or assisted GPS sensors), to assist in mapping, perception, occupancy grid generation, and/or path planning functions. In at least one embodiment, any number of GNSS sensor(s) 1858 may be used, including, for example and without limitation, a GPS using a USB connector with an Ethernet-to-Serial (e.g., RS-232) bridge.

In at least one embodiment, vehicle 1800 may further include RADAR sensor(s) 1860. In at least one embodiment, RADAR sensor(s) 1860 may be used by vehicle 1800 for long-range vehicle detection, even in darkness and/or severe weather conditions. In at least one embodiment, RADAR functional safety levels may be ASIL B. In at least one embodiment, RADAR sensor(s) 1860 may use a CAN bus and/or bus 1802 (e.g., to transmit data generated by RADAR sensor(s) 1860) for control and to access object tracking data, with access to Ethernet channels to access raw data in some examples. In at least one embodiment, a wide variety of RADAR sensor types may be used. For example, and without limitation, RADAR sensor(s) 1860 may be suitable for front, rear, and side RADAR use. In at least one embodiment, one or more sensor of RADAR sensors(s) 1860 is a Pulse Doppler RADAR sensor.

In at least one embodiment, RADAR sensor(s) 1860 may include different configurations, such as long-range with narrow field of view, short-range with wide field of view, short-range side coverage, etc. In at least one embodiment, long-range RADAR may be used for adaptive cruise control functionality. In at least one embodiment, long-range RADAR systems may provide a broad field of view realized by two or more independent scans, such as within a 250 m (meter) range. In at least one embodiment, RADAR sensor(s) 1860 may help in distinguishing between static and moving objects, and may be used by ADAS system 1838 for emergency brake assist and forward collision warning. In at least one embodiment, sensors 1860 (s) included in a long-range RADAR system may include, without limitation, monostatic multimodal RADAR with multiple (e.g., six or more) fixed RADAR antennae and a high-speed CAN and FlexRay interface. In at least one embodiment, with six antennae, a central four antennae may create a focused beam pattern, designed to record vehicle's 1800 surroundings at higher speeds with minimal interference from traffic in adjacent lanes. In at least one embodiment, another two antennae may expand field of view, making it possible to quickly detect vehicles entering or leaving a lane of vehicle 1800.

In at least one embodiment, mid-range RADAR systems may include, as an example, a range of up to 160 m (front) or 80 m (rear), and a field of view of up to 42 degrees (front) or 150 degrees (rear). In at least one embodiment, short-range RADAR systems may include, without limitation, any number of RADAR sensor(s) 1860 designed to be installed at both ends of a rear bumper. When installed at both ends of a rear bumper, in at least one embodiment, a RADAR sensor system may create two beams that constantly monitor blind spots in a rear direction and next to a vehicle. In at least one embodiment, short-range RADAR systems may be used in ADAS system 1838 for blind spot detection and/or lane change assist.

In at least one embodiment, vehicle 1800 may further include ultrasonic sensor(s) 1862. In at least one embodiment, ultrasonic sensor(s) 1862, which may be positioned at a front, a back, and/or side location of vehicle 1800, may be used for parking assist and/or to create and update an occupancy grid. In at least one embodiment, a wide variety of ultrasonic sensor(s) 1862 may be used, and different ultrasonic sensor(s) 1862 may be used for different ranges of detection (e.g., 2.5 m, 4 m). In at least one embodiment, ultrasonic sensor(s) 1862 may operate at functional safety levels of ASIL B.

In at least one embodiment, vehicle 1800 may include LIDAR sensor(s) 1864. In at least one embodiment, LIDAR sensor(s) 1864 may be used for object and pedestrian detection, emergency braking, collision avoidance, and/or other functions. In at least one embodiment, LIDAR sensor(s) 1864 may operate at functional safety level ASIL B. In at least one embodiment, vehicle 1800 may include multiple LIDAR sensors 1864 (e.g., two, four, six, etc.) that may use an Ethernet channel (e.g., to provide data to a Gigabit Ethernet switch).

In at least one embodiment, LIDAR sensor(s) 1864 may be capable of providing a list of objects and their distances for a 360-degree field of view. In at least one embodiment, commercially available LIDAR sensor(s) 1864 may have an advertised range of approximately 100 m, with an accuracy of 2 cm to 3 cm, and with support for a 100 Mbps Ethernet connection, for example. In at least one embodiment, one or more non-protruding LIDAR sensors may be used. In such an embodiment, LIDAR sensor(s) 1864 may include a small device that may be embedded into a front, a rear, a side, and/or a corner location of vehicle 1800. In at least one embodiment, LIDAR sensor(s) 1864, in such an embodiment, may provide up to a 120-degree horizontal and 35-degree vertical field-of-view, with a 200 m range even for low-reflectivity objects. In at least one embodiment, front-mounted LIDAR sensor(s) 1864 may be configured for a horizontal field of view between 45 degrees and 135 degrees.

In at least one embodiment, LIDAR technologies, such as 3D flash LIDAR, may also be used. In at least one embodiment, 3D flash LIDAR uses a flash of a laser as a transmission source, to illuminate surroundings of vehicle 1800 up to approximately 200 m. In at least one embodiment, a flash LIDAR unit includes, without limitation, a receptor, which records laser pulse transit time and reflected light on each pixel, which in turn corresponds to a range from vehicle 1800 to objects. In at least one embodiment, flash LIDAR may allow for highly accurate and distortion-free images of surroundings to be generated with every laser flash. In at least one embodiment, four flash LIDAR sensors may be deployed, one at each side of vehicle 1800. In at least one embodiment, 3D flash LIDAR systems include, without limitation, a solid-state 3D staring array LIDAR camera with no moving parts other than a fan (e.g., a non-scanning LIDAR device). In at least one embodiment, flash LIDAR device may use a 5 nanosecond class I (eye-safe) laser pulse per frame and may capture reflected laser light as a 3D range point cloud and co-registered intensity data.

In at least one embodiment, vehicle 1800 may further include IMU sensor(s) 1866. In at least one embodiment, IMU sensor(s) 1866 may be located at a center of a rear axle of vehicle 1800. In at least one embodiment, IMU sensor(s) 1866 may include, for example and without limitation, accelerometer(s), magnetometer(s), gyroscope(s), a magnetic compass, magnetic compasses, and/or other sensor types. In at least one embodiment, such as in six-axis applications, IMU sensor(s) 1866 may include, without limitation, accelerometers and gyroscopes. In at least one embodiment, such as in nine-axis applications, IMU sensor(s) 1866 may include, without limitation, accelerometers, gyroscopes, and magnetometers.

In at least one embodiment, IMU sensor(s) 1866 may be implemented as a miniature, high performance GPS-Aided Inertial Navigation System (“GPS/INS”) that combines micro-electro-mechanical systems (“MEMS”) inertial sensors, a high-sensitivity GPS receiver, and advanced Kalman filtering algorithms to provide estimates of position, velocity, and attitude. In at least one embodiment, IMU sensor(s) 1866 may enable vehicle 1800 to estimate its heading without requiring input from a magnetic sensor by directly observing and correlating changes in velocity from a GPS to IMU sensor(s) 1866. In at least one embodiment, IMU sensor(s) 1866 and GNSS sensor(s) 1858 may be combined in a single integrated unit.

In at least one embodiment, vehicle 1800 may include microphone(s) 1896 placed in and/or around vehicle 1800. In at least one embodiment, microphone(s) 1896 may be used for emergency vehicle detection and identification, among other things.

In at least one embodiment, vehicle 1800 may further include any number of camera types, including stereo camera(s) 1868, wide-view camera(s) 1870, infrared camera(s) 1872, surround camera(s) 1874, long-range camera(s) 1898, mid-range camera(s) 1876, and/or other camera types. In at least one embodiment, cameras may be used to capture image data around an entire periphery of vehicle 1800. In at least one embodiment, which types of cameras used depends on vehicle 1800. In at least one embodiment, any combination of camera types may be used to provide necessary coverage around vehicle 1800. In at least one embodiment, a number of cameras deployed may differ depending on embodiment. For example, in at least one embodiment, vehicle 1800 could include six cameras, seven cameras, ten cameras, twelve cameras, or another number of cameras. In at least one embodiment, cameras may support, as an example and without limitation, Gigabit Multimedia Serial Link (“GMSL”) and/or Gigabit Ethernet communications. In at least one embodiment, each camera might be as described with more detail previously herein with respect to FIG. 18A and FIG. 18B.

In at least one embodiment, vehicle 1800 may further include vibration sensor(s) 1842. In at least one embodiment, vibration sensor(s) 1842 may measure vibrations of components of vehicle 1800, such as axle(s). For example, in at least one embodiment, changes in vibrations may indicate a change in road surfaces. In at least one embodiment, when two or more vibration sensors 1842 are used, differences between vibrations may be used to determine friction or slippage of road surface (e.g., when a difference in vibration is between a power-driven axle and a freely rotating axle).

In at least one embodiment, vehicle 1800 may include ADAS system 1838. In at least one embodiment, ADAS system 1838 may include, without limitation, an SoC, in some examples. In at least one embodiment, ADAS system 1838 may include, without limitation, any number and combination of an autonomous/adaptive/automatic cruise control (“ACC”) system, a cooperative adaptive cruise control (“CACC”) system, a forward crash warning (“FCW”) system, an automatic emergency braking (“AEB”) system, a lane departure warning (“LDW)” system, a lane keep assist (“LKA”) system, a blind spot warning (“BSW”) system, a rear cross-traffic warning (“RCTW”) system, a collision warning (“CW”) system, a lane centering (“LC”) system, and/or other systems, features, and/or functionality.

In at least one embodiment, ACC system may use RADAR sensor(s) 1860, LIDAR sensor(s) 1864, and/or any number of camera(s). In at least one embodiment, ACC system may include a longitudinal ACC system and/or a lateral ACC system. In at least one embodiment, a longitudinal ACC system monitors and controls distance to another vehicle immediately ahead of vehicle 1800 and automatically adjusts speed of vehicle 1800 to maintain a safe distance from vehicles ahead. In at least one embodiment, a lateral ACC system performs distance keeping, and advises vehicle 1800 to change lanes when necessary. In at least one embodiment, a lateral ACC is related to other ADAS applications, such as LC and CW.

In at least one embodiment, a CACC system uses information from other vehicles that may be received via network interface 1824 and/or wireless antenna(s) 1826 from other vehicles via a wireless link, or indirectly, over a network connection (e.g., over the Internet). In at least one embodiment, direct links may be provided by a vehicle-to-vehicle (“V2V”) communication link, while indirect links may be provided by an infrastructure-to-vehicle (“I2V”) communication link. In general, V2V communication provides information about immediately preceding vehicles (e.g., vehicles immediately ahead of and in same lane as vehicle 1800), while I2V communication provides information about traffic further ahead. In at least one embodiment, a CACC system may include either or both I2V and V2V information sources. In at least one embodiment, given information of vehicles ahead of vehicle 1800, a CACC system may be more reliable and it has potential to improve traffic flow smoothness and reduce congestion on road.

In at least one embodiment, an FCW system is designed to alert a driver to a hazard, so that such driver may take corrective action. In at least one embodiment, an FCW system uses a front-facing camera and/or RADAR sensor(s) 1860, coupled to a dedicated processor, DSP, FPGA, and/or ASIC, that is electrically coupled to provide driver feedback, such as a display, speaker, and/or vibrating component. In at least one embodiment, an FCW system may provide a warning, such as in form of a sound, visual warning, vibration and/or a quick brake pulse.

In at least one embodiment, an AEB system detects an impending forward collision with another vehicle or other object, and may automatically apply brakes if a driver does not take corrective action within a specified time or distance parameter. In at least one embodiment, AEB system may use front-facing camera(s) and/or RADAR sensor(s) 1860, coupled to a dedicated processor, DSP, FPGA, and/or ASIC. In at least one embodiment, when an AEB system detects a hazard, it will typically first alert a driver to take corrective action to avoid collision and, if that driver does not take corrective action, that AEB system may automatically apply brakes in an effort to prevent, or at least mitigate, an impact of a predicted collision. In at least one embodiment, an AEB system may include techniques such as dynamic brake support and/or crash imminent braking.

In at least one embodiment, an LDW system provides visual, audible, and/or tactile warnings, such as steering wheel or seat vibrations, to alert driver when vehicle 1800 crosses lane markings. In at least one embodiment, an LDW system does not activate when a driver indicates an intentional lane departure, such as by activating a turn signal. In at least one embodiment, an LDW system may use front-side facing cameras, coupled to a dedicated processor, DSP, FPGA, and/or ASIC, that is electrically coupled to provide driver feedback, such as a display, speaker, and/or vibrating component. In at least one embodiment, an LKA system is a variation of an LDW system. In at least one embodiment, an LKA system provides steering input or braking to correct vehicle 1800 if vehicle 1800 starts to exit its lane.

In at least one embodiment, a BSW system detects and warns a driver of vehicles in an automobile's blind spot. In at least one embodiment, a BSW system may provide a visual, audible, and/or tactile alert to indicate that merging or changing lanes is unsafe. In at least one embodiment, a BSW system may provide an additional warning when a driver uses a turn signal. In at least one embodiment, a BSW system may use rear-side facing camera(s) and/or RADAR sensor(s) 1860, coupled to a dedicated processor, DSP, FPGA, and/or ASIC, that is electrically coupled to driver feedback, such as a display, speaker, and/or vibrating component.

In at least one embodiment, an RCTW system may provide visual, audible, and/or tactile notification when an object is detected outside a rear-camera range when vehicle 1800 is backing up. In at least one embodiment, an RCTW system includes an AEB system to ensure that vehicle brakes are applied to avoid a crash. In at least one embodiment, an RCTW system may use one or more rear-facing RADAR sensor(s) 1860, coupled to a dedicated processor, DSP, FPGA, and/or ASIC, that is electrically coupled to provide driver feedback, such as a display, speaker, and/or vibrating component.

In at least one embodiment, conventional ADAS systems may be prone to false positive results which may be annoying and distracting to a driver, but typically are not catastrophic, because conventional ADAS systems alert a driver and allow that driver to decide whether a safety condition truly exists and act accordingly. In at least one embodiment, vehicle 1800 itself decides, in case of conflicting results, whether to heed result from a primary computer or a secondary computer (e.g., a first controller or a second controller of controllers 1836). For example, in at least one embodiment, ADAS system 1838 may be a backup and/or secondary computer for providing perception information to a backup computer rationality module. In at least one embodiment, a backup computer rationality monitor may run redundant diverse software on hardware components to detect faults in perception and dynamic driving tasks. In at least one embodiment, outputs from ADAS system 1838 may be provided to a supervisory MCU. In at least one embodiment, if outputs from a primary computer and outputs from a secondary computer conflict, a supervisory MCU determines how to reconcile conflict to ensure safe operation.

In at least one embodiment, a primary computer may be configured to provide a supervisory MCU with a confidence score, indicating that primary computer's confidence in a chosen result. In at least one embodiment, if that confidence score exceeds a threshold, that supervisory MCU may follow that primary computer's direction, regardless of whether that secondary computer provides a conflicting or inconsistent result. In at least one embodiment, where a confidence score does not meet a threshold, and where primary and secondary computers indicate different results (e.g., a conflict), a supervisory MCU may arbitrate between computers to determine an appropriate outcome.

In at least one embodiment, a supervisory MCU may be configured to run a neural network(s) that is trained and configured to determine, based at least in part on outputs from a primary computer and outputs from a secondary computer, conditions under which that secondary computer provides false alarms. In at least one embodiment, neural network(s) in a supervisory MCU may learn when a secondary computer's output may be trusted, and when it cannot. For example, in at least one embodiment, when that secondary computer is a RADAR-based FCW system, a neural network(s) in that supervisory MCU may learn when an FCW system is identifying metallic objects that are not, in fact, hazards, such as a drainage grate or manhole cover that triggers an alarm. In at least one embodiment, when a secondary computer is a camera-based LDW system, a neural network in a supervisory MCU may learn to override LDW when bicyclists or pedestrians are present and a lane departure is, in fact, a safest maneuver. In at least one embodiment, a supervisory MCU may include at least one of a DLA or a GPU suitable for running neural network(s) with associated memory. In at least one embodiment, a supervisory MCU may comprise and/or be included as a component of SoC(s) 1804.

In at least one embodiment, ADAS system 1838 may include a secondary computer that performs ADAS functionality using traditional rules of computer vision. In at least one embodiment, that secondary computer may use classic computer vision rules (if-then), and presence of a neural network(s) in a supervisory MCU may improve reliability, safety and performance. For example, in at least one embodiment, diverse implementation and intentional non-identity makes an overall system more fault-tolerant, especially to faults caused by software (or software-hardware interface) functionality. For example, in at least one embodiment, if there is a software bug or error in software running on a primary computer, and non-identical software code running on a secondary computer provides a consistent overall result, then a supervisory MCU may have greater confidence that an overall result is correct, and a bug in software or hardware on that primary computer is not causing a material error.

In at least one embodiment, an output of ADAS system 1838 may be fed into a primary computer's perception block and/or a primary computer's dynamic driving task block. For example, in at least one embodiment, if ADAS system 1838 indicates a forward crash warning due to an object immediately ahead, a perception block may use this information when identifying objects. In at least one embodiment, a secondary computer may have its own neural network that is trained and thus reduces a risk of false positives, as described herein.

In at least one embodiment, vehicle 1800 may further include infotainment SoC 1830 (e.g., an in-vehicle infotainment system (IVI)). Although illustrated and described as an SoC, infotainment system SoC 1830, in at least one embodiment, may not be an SoC, and may include, without limitation, two or more discrete components. In at least one embodiment, infotainment SoC 1830 may include, without limitation, a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, WiFi, etc.), and/or information services (e.g., navigation systems, rear-parking assistance, a radio data system, vehicle related information such as fuel level, total distance covered, brake fuel level, oil level, door open/close, air filter information, etc.) to vehicle 1800. For example, infotainment SoC 1830 could include radios, disk players, navigation systems, video players, USB and Bluetooth connectivity, carputers, in-car entertainment, WiFi, steering wheel audio controls, hands free voice control, a heads-up display (“HUD”), HMI display 1834, a telematics device, a control panel (e.g., for controlling and/or interacting with various components, features, and/or systems), and/or other components. In at least one embodiment, infotainment SoC 1830 may further be used to provide information (e.g., visual and/or audible) to user(s) of vehicle 1800, such as information from ADAS system 1838, autonomous driving information such as planned vehicle maneuvers, trajectories, surrounding environment information (e.g., intersection information, vehicle information, road information, etc.), and/or other information.

In at least one embodiment, infotainment SoC 1830 may include any amount and type of GPU functionality. In at least one embodiment, infotainment SoC 1830 may communicate over bus 1802 with other devices, systems, and/or components of vehicle 1800. In at least one embodiment, infotainment SoC 1830 may be coupled to a supervisory MCU such that a GPU of an infotainment system may perform some self-driving functions in event that primary controller(s) 1836 (e.g., primary and/or backup computers of vehicle 1800) fail. In at least one embodiment, infotainment SoC 1830 may put vehicle 1800 into a chauffeur to safe stop mode, as described herein.

In at least one embodiment, vehicle 1800 may further include instrument cluster 1832 (e.g., a digital dash, an electronic instrument cluster, a digital instrument panel, etc.). In at least one embodiment, instrument cluster 1832 may include, without limitation, a controller and/or supercomputer (e.g., a discrete controller or supercomputer). In at least one embodiment, instrument cluster 1832 may include, without limitation, any number and combination of a set of instrumentation such as a speedometer, fuel level, oil pressure, tachometer, odometer, turn indicators, gearshift position indicator, seat belt warning light(s), parking-brake warning light(s), engine-malfunction light(s), supplemental restraint system (e.g., airbag) information, lighting controls, safety system controls, navigation information, etc. In some examples, information may be displayed and/or shared among infotainment SoC 1830 and instrument cluster 1832. In at least one embodiment, instrument cluster 1832 may be included as part of infotainment SoC 1830, or vice versa.

Inference and/or training logic 815 are used to perform inferencing and/or training operations associated with one or more embodiments. In at least one embodiment, inference and/or training logic 815 may be used in system FIG. 18C for inferencing or predicting operations based, at least in part, on weight parameters calculated using neural network training operations, neural network functions and/or architectures, or neural network use cases described herein.

Such components can be used to generate a single, consistent tokenized description of at least a portion of a physical environment based in part on a set of observations and aligned map data.

FIG. 18D is a diagram of a system 1877 for communication between cloud-based server(s) and autonomous vehicle 1800 of FIG. 18A, according to at least one embodiment. In at least one embodiment, system may include, without limitation, server(s) 1878, network(s) 1890, and any number and type of vehicles, including vehicle 1800. In at least one embodiment, server(s) 1878 may include, without limitation, a plurality of GPUs 1884(A)-1884(H) (collectively referred to herein as GPUs 1884), PCIe switches 1882(A)-1882(D) (collectively referred to herein as PCIe switches 1882), and/or CPUs 1880(A)-1880(B) (collectively referred to herein as CPUs 1880). In at least one embodiment, GPUs 1884, CPUs 1880, and PCIe switches 1882 may be interconnected with high-speed interconnects such as, for example and without limitation, NVLink interfaces 1888 developed by NVIDIA and/or PCIe connections 1886. In at least one embodiment, GPUs 1884 are connected via an NVLink and/or NVSwitch SoC and GPUs 1884 and PCIe switches 1882 are connected via PCIe interconnects. Although eight GPUs 1884, two CPUs 1880, and four PCIe switches 1882 are illustrated, this is not intended to be limiting. In at least one embodiment, each of server(s) 1878 may include, without limitation, any number of GPUs 1884, CPUs 1880, and/or PCIe switches 1882, in any combination. For example, in at least one embodiment, server(s) 1878 could each include eight, sixteen, thirty-two, and/or more GPUs 1884.

In at least one embodiment, server(s) 1878 may receive, over network(s) 1890 and from vehicles, image data representative of images showing unexpected or changed road conditions, such as recently commenced road-work. In at least one embodiment, server(s) 1878 may transmit, over network(s) 1890 and to vehicles, neural networks 1892, updated or otherwise, and/or map information 1894, including, without limitation, information regarding traffic and road conditions. In at least one embodiment, updates to map information 1894 may include, without limitation, updates for HD map 1822, such as information regarding construction sites, potholes, detours, flooding, and/or other obstructions. In at least one embodiment, neural networks 1892, and/or map information 1894 may have resulted from new training and/or experiences represented in data received from any number of vehicles in an environment, and/or based at least in part on training performed at a data center (e.g., using server(s) 1878 and/or other servers).

In at least one embodiment, server(s) 1878 may be used to train machine learning models (e.g., neural networks) based at least in part on training data. In at least one embodiment, training data may be generated by vehicles, and/or may be generated in a simulation (e.g., using a game engine). In at least one embodiment, any amount of training data is tagged (e.g., where associated neural network benefits from supervised learning) and/or undergoes other pre-processing. In at least one embodiment, any amount of training data is not tagged and/or pre-processed (e.g., where associated neural network does not require supervised learning). In at least one embodiment, once machine learning models are trained, machine learning models may be used by vehicles (e.g., transmitted to vehicles over network(s) 1890), and/or machine learning models may be used by server(s) 1878 to remotely monitor vehicles.

In at least one embodiment, server(s) 1878 may receive data from vehicles and apply data to up-to-date real-time neural networks for real-time intelligent inferencing. In at least one embodiment, server(s) 1878 may include deep-learning supercomputers and/or dedicated AI computers powered by GPU(s) 1884, such as a DGX and DGX Station machines developed by NVIDIA. However, in at least one embodiment, server(s) 1878 may include deep learning infrastructure that uses CPU-powered data centers.

In at least one embodiment, deep-learning infrastructure of server(s) 1878 may be capable of fast, real-time inferencing, and may use that capability to evaluate and verify health of processors, software, and/or associated hardware in vehicle 1800. For example, in at least one embodiment, deep-learning infrastructure may receive periodic updates from vehicle 1800, such as a sequence of images and/or objects that vehicle 1800 has located in that sequence of images (e.g., via computer vision and/or other machine learning object classification techniques). In at least one embodiment, deep-learning infrastructure may run its own neural network to identify objects and compare them with objects identified by vehicle 1800 and, if results do not match and deep-learning infrastructure concludes that AI in vehicle 1800 is malfunctioning, then server(s) 1878 may transmit a signal to vehicle 1800 instructing a fail-safe computer of vehicle 1800 to assume control, notify passengers, and complete a safe parking maneuver.

In at least one embodiment, server(s) 1878 may include GPU(s) 1884 and one or more programmable inference accelerators (e.g., NVIDIA's TensorRT 3 devices). In at least one embodiment, a combination of GPU-powered servers and inference acceleration may make real-time responsiveness possible. In at least one embodiment, such as where performance is less critical, servers powered by CPUs, FPGAs, and other processors may be used for inferencing.

Various embodiments can be described by the following clauses:

1. A computer-implemented method, comprising:
comparing, using an initial transform and for a road segment, a first set of lane dividers within a set of first track data to a second set of lane dividers within a set of second track data;
determining an updated transform using at least the initial transform, the first set of lane dividers, and the second set of lane dividers;
selecting the updated transform as a seed transform based at least on a determination that a difference in one or more parameters between the initial transform and the updated transform is below one or more thresholds;
using the updated transform to verify lane divider matches between the set of first track data and the set of second track data; and
providing the updated transform to aid in determining a third set of lane dividers in an adjacent road segment.

2. The computer-implemented method of clause 1, wherein the one or more thresholds correspond to at least one of a translation distance or an amount of rotation.

3. The computer-implemented method of clause 1, further comprising:
determining an adjacent segment transform using the updated transform and at least the third set of lane dividers associated with the adjacent segment;
comparing the updated transform and the adjacent segment transform against the one or more thresholds;
determining that a difference in one or more parameters between the updated transform and the adjacent segment transform is below the one or more thresholds; and
using the adjacent segment transform for matching the lane dividers in the adjacent segment.

4. The computer-implemented method of clause 1, comprising:
selecting the road segment based at least on a number or a density of landmark matches within the road segment for the set of first track data.

5. The computer-implemented method of clause 1, wherein the initial transform is determined based at least on a set of landmark matches or a set of road boundary matches.

6. The computer-implemented method of clause 1, wherein the initial transform is based at least on geo-location data accuracies associated with one or more poses in a sliding window corresponding to the road segment.

7. The computer-implemented method of clause 1, further comprising:
designating the updated transform as an updated initial transform;
determining an updated second transform based in part on the updated initial transform and at least the first set of land dividers and the second set of lane dividers;
comparing the updated initial transform and the updated second transform against one or more thresholds; and
selecting the updated second transform as a seed transform based at least on a determination that one or more parameters of the updated second transform are below the one or more thresholds.

8. The computer-implemented method of clause 1, further comprising:
determining that the adjacent segment includes an intersection; and
extending a sliding window for lane divider matching in the adjacent segment, along a track direction, if the sliding window does not include at least a minimum area on another side of the intersection.

9. The computer-implemented method of clause 1, further comprising:

using the updated transform for lane matching of one or more additional road segments until an end of a roadway is reached or one or more parameters of the updated transform exceed one or more thresholds.

10. At least one processor comprising:
one or more logic units to:
   generate a first transform based at least on a segment of road data with a threshold level of feature correspondence;
   identify a first set of landmark matches and a first set of lane divider matches for an adjacent segment;
   determine a second transform for the adjacent segment of road data using the first transform, the first set of landmark matches, and the first set of land divider matches; and
   identify a second set of lane divider matches within the adjacent segment of road data based at least on the second transform.

11. The at least one processor of clause 10, wherein the one or more logic units are further to:
determine an adjacent segment transform using the updated transform and at least a third set of lane dividers associated with the adjacent segment;
compare the updated transform and the adjacent segment transform against the one or more thresholds;
determine one or more parameters of the adjacent segment transform are below the one or more thresholds with respect to the updated transform; and
provide the adjacent segment transform to match the lane dividers in the adjacent segment.

12. The at least one processor of clause 10, wherein the second set of lane divider matches is identified based at least on the second transform falling within at least one of a translation distance threshold or a rotation threshold.

13. The at least one processor of clause 10, wherein the one or more logic units are further to:

select the road segment based at least on a number or a density of landmark matches within the road segment for the set of first track data.

14. The at least one processor of clause 10, wherein the initial transform is determined based at least on a set of landmark matches or a set of road boundary matches.

15. The at least one processor of clause 10, wherein the at least one processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or a system implemented at least partially using cloud computing resources.

16. A system comprising:
one or more processors to determine a set of lane divider matches within a road segment based in part on an initial transform, the initial transform determined using an adjacent road segment having at least a threshold match correspondence.

17. The system of clause 16, wherein the threshold match correspondence includes at least a minimum number or a minimum density of landmark matches or road boundary matches.

18. The system of clause 16, wherein the one or more processors are further to:
generate the initial transform based at least on an initial set of landmark matches and an initial set of lane divider matches for the adjacent road segment.

19. The system of clause 16, wherein the set of lane divider matches for the road segment is identified based at least on a second transform for the road segment falling within at least one of a translation distance threshold or a rotation threshold of the initial transform from the adjacent road segment.

20. The system of clause 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over utilizing a conventional central processing unit (“CPU”) and bus implementation. In at least one embodiment, various modules may also be situated separately or in various combinations of semiconductor platforms per desires of user.

In at least one embodiment, referring back to FIG. 11, computer programs in form of machine-readable executable code or computer control logic algorithms are stored in main memory 1104 and/or secondary storage. Computer programs, if executed by one or more processors, enable computer system 1100 to perform various functions in accordance with at least one embodiment. In at least one embodiment, main memory 1104, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous FIGS. 1-7C are implemented in context of CPU 1102, parallel processing system 1112, an integrated circuit capable of at least a portion of capabilities of both CPU 1102, parallel processing system 1112, a chipset (e.g., a group of integrated circuits designed to work and sold as a unit for performing related functions, etc.), and/or any suitable combination of integrated circuit(s).

In at least one embodiment, architecture and/or functionality of various previous FIGS. 1-7C are implemented in context of a general computer system, a circuit board system, a game console system dedicated for entertainment purposes, an application-specific system, and more. In at least one embodiment, computer system 1100 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 1112 includes, without limitation, a plurality of parallel processing units (“PPUs”) 1114 and associated memories 1116. In at least one embodiment, PPUs 1114 are connected to a host processor or other peripheral devices via an interconnect 1118 and a switch 1120 or multiplexer. In at least one embodiment, parallel processing system 1112 distributes computational tasks across PPUs 1114 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 1114, although such shared memory may incur performance penalties relative to use of local memory and registers resident to a PPU 1114. In at least one embodiment, operation of PPUs 1114 is synchronized through use of a command such as _syncthreads( ) wherein all threads in a block (e.g., executed across multiple PPUs 1114) to reach a certain point of execution of code before proceeding.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oncAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oncAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, one VPL implements various video decoding, encoding, and processing functions. In at least one embodiment, one VPL implements various functions for media pipelines on CPUs, GPUs, and other accelerators. In at least one embodiment, one VPL implements device discovery and selection in media centric and video analytics workloads. In at least one embodiment, one VPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation comprises generating one or more machine-executable instructions, operations, or other signals from source code. In at least one embodiment, an API compiled into one or more instructions, operations, or other signals, when performed, causes one or more processors such as graphics processor 1410, graphics processor 1440, graphics core 1500, parallel processor 1700, graphics processor 1900, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
comparing, using an initial transform and for a road segment, a first set of lane dividers within a set of first track data to a second set of lane dividers within a set of second track data;
determining an updated transform using at least the initial transform, the first set of lane 4 dividers, and the second set of lane dividers;
selecting the updated transform as a seed transform based at least on a determination that a difference in one or more parameters between the initial transform and the updated transform is below one or more thresholds;
using the updated transform to verify lane divider matches between the set of first track data and the set of second track data; and
providing the updated transform to aid in determining a third set of lane dividers in an adjacent road segment.

2. The computer-implemented method of claim 1, wherein the one or more thresholds correspond to at least one of a translation distance or an amount of rotation.

3. The computer-implemented method of claim 1, further comprising:
determining an adjacent segment transform using the updated transform and at least the third set of lane dividers associated with the adjacent segment;
comparing the updated transform and the adjacent segment transform against the one or more thresholds;
determining that a difference in one or more parameters between the updated transform and the adjacent segment transform is below the one or more thresholds; and
using the adjacent segment transform for matching the lane dividers in the adjacent segment.

4. The computer-implemented method of claim 1, comprising:
selecting the road segment based at least on a number or a density of landmark matches within the road segment for the set of first track data.

5. The computer-implemented method of claim 1, wherein the initial transform is determined based at least on a set of landmark matches or a set of road boundary matches.

6. The computer-implemented method of claim 1, wherein the initial transform is based at least on geo-location data accuracies associated with one or more poses in a sliding 2 window corresponding to the road segment.

7. The computer-implemented method of claim 1, further comprising:
designating the updated transform as an updated initial transform;
determining an updated second transform based in part on the updated initial transform and at least the first set of land dividers and the second set of lane dividers;
comparing the updated initial transform and the updated second transform against one or more thresholds; and
selecting the updated second transform as a seed transform based at least on a determination that one or more parameters of the updated second transform are below the one or more thresholds.

8. The computer-implemented method of claim 1, further comprising:
determining that the adjacent segment includes an intersection; and
extending a sliding window for lane divider matching in the adjacent segment, along a track direction, if the sliding window does not include at least a minimum area on another side of the intersection.

9. The computer-implemented method of claim 1, further comprising:
using the updated transform for lane matching of one or more additional road segments until an end of a roadway is reached or one or more parameters of the updated transform exceed one or more thresholds.

10. At least one processor comprising:
one or more logic units to:
generate a first transform based at least on a segment of road data with a threshold level of feature correspondence;
identify a first set of landmark matches and a first set of lane divider matches for an adjacent segment;
determine a second transform for the adjacent segment of road data using the first transform, the first set of landmark matches, and the first set of land divider matches; and
identify a second set of lane divider matches within the adjacent segment of road data based at least on the second transform.

11. The at least one processor of claim 10, wherein the one or more logic units are further to:
determine an adjacent segment transform using the updated transform and at least a third set of lane dividers associated with the adjacent segment;
compare the updated transform and the adjacent segment transform against the one or more thresholds;
determine one or more parameters of the adjacent segment transform are below the one or more thresholds with respect to the updated transform; and
provide the adjacent segment transform to match the lane dividers in the adjacent segment.

12. The at least one processor of claim 10, wherein the second set of lane divider matches is identified based at least on the second transform falling within at least one of a translation distance threshold or a rotation threshold.

13. The at least one processor of claim 10, wherein the one or more logic units are further to:
select the road segment based at least on a number or a density of landmark matches within the road segment for the set of first track data.

14. The at least one processor of claim 10, wherein the initial transform is determined based at least on a set of landmark matches or a set of road boundary matches.

15. The at least one processor of claim 10, wherein the at least one processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

16. A system comprising:
one or more processors to determine a set of lane divider matches within a road segment based in part on an initial transform, the initial transform determined using an adjacent road segment having at least a threshold match correspondence.

17. The system of claim 16, wherein the threshold match correspondence includes at least a minimum number or a minimum density of landmark matches or road boundary matches.

18. The system of claim 16, wherein the one or more processors are further to:
generate the initial transform based at least on an initial set of landmark matches and an initial set of lane divider matches for the adjacent road segment.

19. The system of claim 16, wherein the set of lane divider matches for the road segment is identified based at least on a second transform for the road segment falling within at least one of a translation distance threshold or a rotation threshold of the initial transform from the adjacent road segment.

20. The system of claim 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.
